(19) United States
(12) Patent Application Publication
(10) Pub. No.: US 2025/0023272 A1
(43) Pub. Date: Jan. 16, 2025

(54) ELECTRICAL CONNECTOR SYSTEM WITH A MALE TERMINAL ASSEMBLY HAVING A COMPRESSION LIMITING MEANS

(71) Applicant: EATON INTELLIGENT POWER LIMITED, Dublin 4 (IE)

(72) Inventors: James Dawson, West Chicago, IL (US); Brantley Natter, Brightom, MI (US); Mohamad Zeidan, Bloomfield Hills, MI (US); Slobodan Pavlovic, ETOBICOKE (CA); Nathan Hollin, West Chicago, IL (US); Steve Krass, Saint Charles, IL (US)

(21) Appl. No.: 18/709,857

(22) PCT Filed: Dec. 5, 2022
(86) PCT No.: PCT/IB2022/061786

§ 371 Date: May 14, 2024

Related U.S. Application Data
(60) Provisional application No. 63/286,072, filed on Dec. 5, 2021.
(60) Provisional application No. 63/286,080, filed on Dec. 5, 2021.

(51) Int. Cl. H01R 13/17

(52) U.S. Cl. CPC H01R 13/17

(57) ABSTRACT

The present disclosure relates to an electrical connector system having a male connector assembly and a female connector assembly. The male connector assembly includes a male housing assembly and a male terminal assembly having a male terminal, a spring member with at least one contact arm with a significantly bent configuration and an openable jacket that encloses a substantial extent of the male terminal and the spring member. The male terminal assembly also includes a compression limiting means that prevents an external force from overly deforming the contact arm inward. Preventing excessive depression of the contact arm is desirable because it can damage the contact arm and/or the spring member thereby introducing a failure mode to the male connector assembly that can cause the overall connector system to become inoperable and unusable. The female connector assembly includes a female housing assembly and a female terminal assembly. The female housing assembly is designed to receive the female terminal assembly as well as an extent of the male terminal assembly in a connected state during operation of the electrical connector system.

### RELATED APPLICATIONS

This application claims the benefit from U.S. provisional patent application Nos. 63/286,072 and 63/286,080, both of which were filed on Dec. 5, 2021, and are incorporated herein by this reference.

### FIELD OF DISCLOSURE

The present disclosure relates to an electrical connector system, more specifically a relatively small connector system having a male connector assembly and a female connector assembly. The male connector assembly includes a male housing assembly and a male terminal assembly having a male terminal, a spring member with at least one contact arm with a bent segment and an openable enclosure jacket. The male terminal assembly also includes a compression limiting means that prevents an external force from overly deforming the contact arm inward. Preventing excessive depression of the contact arm is desirable because it can damage the contact arm and/or the spring member thereby introducing a failure mode to the male connector assembly that can cause the overall connector system to become inoperable and unusable.

### BACKGROUND

Over the past several decades, the number of electrical components used in automobiles, and other on-road and off-road vehicles such as pick-up trucks, commercial vans and trucks, semi-trucks, motorcycles, all-terrain vehicles, and sports utility vehicles (collectively “motor vehicles”) has increased dramatically. Electrical components are used in motor vehicles for a variety of reasons, including but not limited to, monitoring, improving and/or controlling vehicle performance, emissions, safety and creates comforts to the occupants of the motor vehicles. Considerable time, resources, and energy have been expended to develop power distribution components that meet the varied needs and complexities of the motor vehicle market; however, conventional power distribution components suffer from a variety of shortcomings.

Motor vehicles are challenging electrical environments for both the electrical components and the connector assemblies due to several conditions, including but not limited to, space constraints that make initial installation difficult, harsh operating conditions, large ambient temperature ranges, prolonged vibration, heat loads, and longevity, all of which can lead to component and/or connector failure. For example, incorrectly installed connectors, which typically occur in the assembly plant, and dislodged connectors, which typically occur in the field, are two significant failure modes for the electrical components and motor vehicles. Each of these failure modes leads to significant repair and warranty costs. For example, the combined annual accrual for warranty by all of the automotive manufacturers and their direct suppliers is estimated to be between $50 billion and $150 billion, worldwide. In light of these challenging electrical environments, considerable time, money, and energy have been expended to find power distribution components that meet the needs of the markets. This disclosure addresses the shortcomings of conventional power distribution components. A full discussion of the features and advantages of the present disclosure is deferred to the following detailed description, which proceeds with reference to the accompanying drawings.

### SUMMARY OF THE INVENTION

The present disclosure relates to an electrical connector system having a male connector assembly and a female connector assembly. The male connector assembly includes a male housing assembly and a male terminal assembly having a male terminal, a spring member with at least one contact arm with a significantly bent configuration and an openable jacket that encloses a substantial extent of the male terminal and the spring member. The male terminal assembly also includes a compression limiting means that prevents an external force from overly deforming the contact arm inward. Preventing excessive depression of the contact arm is desirable because it can damage the contact arm and/or the spring member thereby introducing a failure mode to the male connector assembly that can cause the overall connector system to become inoperable and unusable.

According to another aspect, the female connector assembly includes a female housing assembly and a female terminal assembly. The female housing assembly includes a side wall arrangement that is designed to receive the female terminal assembly and thereby facilitate coupling of the male terminal assembly with the female terminal assembly. Also, the female housing assembly minimizes the chance that a foreign object accidentally makes contact with the female terminal assembly and provide a failure mode that can cause the overall connector system to become inoperable and unusable.

Other aspects and advantages of the present disclosure will become apparent upon consideration of the following detailed description and the attached drawings wherein like numerals designate like structures throughout the specification.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1A is a perspective view of a first embodiment of a connector system in a connected state S_{C}, showing a male connector assembly connected to a female connector assembly;

FIG. 1B is a perspective view of the connector system of FIG. 1A in a disconnected state S_{DC}, showing the male connector assembly disconnected from the female connector assembly;

FIG. 2 is an exploded view of the connector system of FIGS. 1A and 1B, showing the male connector assembly with a male terminal assembly and the female connector assembly with a female terminal assembly;

FIG. 3 is an exploded view of the male terminal assembly of FIG. 2, showing a male terminal, a spring member, and a jacket;

FIG. 4 is a perspective view of the steps in the process of forming the male terminal of FIG. 3 from a blank;

FIGS. 5A-5D are zoomed-in views of steps shon in FIG. 4;

FIG. 6A is a side view of the male terminal of FIG. 3;

FIG. 6B is a prospective view of the male terminal of FIG. 3;

FIG. 7A is a front view of the male terminal of FIG. 3, showing a male terminal body with a plurality of contact arms;

FIG. 7B is a zoomed-in view of one contact arm shown in FIG. 7A;

FIG. 8 is a cross-sectional view of the male terminal taken along line 8-8 of FIG. 7A;

FIG. 9 is a top view of the male terminal of FIG. 6A;

FIG. 10 is a cross-sectional view of the male terminal taken along line 10-10 of FIG. 9;

FIG. 11 is a perspective view of the steps in the process of forming the spring member of FIG. 3 from a blank;

FIGS. 12A-12B are zoomed-in views of steps in the forming process shown in FIG. 11;

FIG. 13A is a perspective view of the spring member of FIG. 3;

FIG. 13B is a front view of the spring member of FIG. 3;

FIG. 14 is a top view of the spring member of FIG. 3;

FIG. 15 is a cross-sectional view of the spring member taken along line 15-15 of FIG. 14;

FIG. 16 is a perspective view of the spring member and the male terminal of FIG. 3 in a disassembled state, S_{DA};

FIG. 17 is a perspective view of the spring member and the male terminal of FIG. 3 in a first partially assembled state, S_{1PA};

FIG. 18 is a perspective view of the spring member and the male terminal of FIG. 3 in a second partially assembled state, S_{2PA};

FIG. 19 is a perspective view of the steps in the process of forming the jacket of FIG. 3;

FIGS. 20A-20B are zoomed-in views of steps in the forming process shown in FIG. 19;

FIG. 21 is a side view of the jacket of FIG. 3 shown in an open position P_{O};

FIG. 22 is a rear perspective view of the jacket of FIG. 3;

FIG. 23 is a side view of the jacket of FIG. 3 shown in a closed position P_{C};

FIG. 24 is a cross-sectional view of the jacket taken along line 24-24 of FIG. 23;

FIG. 25 is a perspective view of the male terminal assembly of FIG. 3 in a third partially assembled state, S_{3PA};

FIG. 26 is a perspective view of the male terminal assembly of FIG. 3 in a fourth partially assembled state, S_{4PA};

FIG. 27 is a front perspective view of the male terminal assembly of FIG. 3 in a fully assembled state, S_{FA};

FIG. 28 is a rear perspective view of the male terminal assembly of FIG. 27;

FIG. 29A is a zoomed in view of a first portion of a jacket coupling means shown in the fully assembled state S_{FA} of FIG. 27;

FIG. 29B is a zoomed in view of a second portion of the jacket coupling means shown in the fully assembled state S_{FA} of FIG. 27;

FIG. 29C is a zoomed in view of a third portion of the jacket coupling means shown in the fully assembled state S_{FA} of FIG. 28;

FIG. 30 is a rear view of the male terminal assembly in the fully assembled state S_{FA} of FIG. 27;

FIG. 31 is a perspective cross-sectional view of the male terminal assembly taken along line 31-31 of FIG. 30;

FIG. 32 is a zoomed in view of a frontal portion of the male terminal assembly shown in FIG. 31;

FIG. 33 is a zoomed in view of a rear portion of the male terminal assembly shown in FIG. 31;

FIG. 34 is a front view of the male terminal assembly in the fully assembled state S_{FA} of FIG. 27;

FIG. 35 is a cross-sectional view of the male terminal assembly taken along line 35-35 of FIG. 34;

FIG. 36 is a side view of the male connector assembly of FIG. 2 shown in a decoupled state, S_{DC};

FIG. 37 is a cross-sectional view of the male connector assembly taken along line 37-37 of FIG. 36;

FIG. 38 is a side view of the male connector assembly of FIG. 2 shown in a partially coupled state, S_{PC};

FIG. 39 is a cross-sectional view of the male connector assembly taken along line 39-39 of FIG. 38;

FIG. 40 is a zoomed in view of the male connector assembly shown in the decoupled state S_{DC} of FIG. 37;

FIG. 41 is a zoomed in view of the male connector assembly shown in the partially coupled state S_{PC} of FIG. 39;

FIG. 42 is a top view of the male connector assembly of FIG. 2 shown in a fully coupled state, S_{FC};

FIG. 43 is a cross-sectional view of the male connector assembly taken along line 43-43 of FIG. 42;

FIG. 44 is a zoomed in view of the male connector assembly shown in FIG. 43;

FIG. 45 is a side view of the male connector assembly in the fully coupled state S_{FC} of FIG. 42;

FIG. 46 is a cross-sectional view of the male connector assembly taken along line 46-46 of FIG. 45;

FIG. 47 is a front view of the male connector assembly in the fully coupled state S_{FC} of FIG. 42;

FIG. 48 is a perspective view of the male connector assembly of FIG. 42;

FIG. 49 is a zoomed in view of the first portion of the jacket coupling means and a first portion of a male terminal retaining means in the fully coupled state S_{FC} of FIG. 43;

FIG. 50 is a zoomed in view of the first portion of the male terminal retaining means of FIG. 49;

FIG. 51 is a zoomed in view of a second portion of the male terminal retaining means of FIG. 49;

FIG. 52 is a perspective view of the female terminal assembly of FIG. 2;

FIG. 53 is a front view of the female terminal assembly of FIG. 52;

FIG. 54 is a top view of the female connector assembly of FIG. 1B;

FIG. 55 is a cross-sectional view of the female connector assembly taken along line 55-55 of FIG. 54;

FIG. 56 is a zoomed in view of a first portion of a female terminal retaining means of FIG. 55;

FIG. 57 is a zoomed in view of a second portion of the female terminal retaining means of FIG. 55;

FIG. 58 is a side view of the connector system of FIGS. 1A and 1B shown in a partially connected state S_{PC};

FIG. 59 is a cross-sectional view of the connector system taken along line 59-59 of FIG. 58;

FIG. 60 is a side view of the connector system of FIGS. 1A and 1B shown in a connected state S_{C};

FIG. 61 is a cross-sectional view of the connector system taken along line 61-61 of FIG. 60;

FIG. 62 is a side view of the connector system of FIGS. 1A and 1B shown in the connected state S_{C};

FIG. 63 is a cross-sectional view of the connector system taken along line 63-63 of FIG. 62;

FIG. 64A is a perspective view of a second embodiment of a male terminal assembly, showing a male terminal, spring member, and a jacket in a fully assembled state, S_{FA};

FIG. 64B is an exploded view of the male terminal assembly of FIG. 64A;

FIG. 65A is a perspective view of the spring member of the male terminal assembly of FIG. 64A;

FIG. 65B is a front view of the spring member of FIG. 65A;

FIG. 65C is a top view of the spring member of FIG. 65A;

FIG. 66 is a perspective view of a third embodiment of a male terminal assembly, showing a male terminal, spring member, and a jacket in a fully assembled state, S_{FA};

FIG. 67 is an exploded view of the male terminal assembly of FIG. 66;

FIG. 68 is a perspective view of the steps in the process of forming the spring member of FIG. 67;

FIG. 69A-69C are zoomed-in views of the steps in the process of forming the spring member shown in FIG. 68;

FIG. 70A is a front perspective view of the spring member of FIG. 66;

FIG. 70B is a rear perspective view of the spring member of FIG. 66;

FIG. 70C is a side view of the spring member of FIG. 66;

FIG. 71A is a cross-sectional view of the spring member taken along line 71A-71A of FIG. 70C;

FIG. 71B is a cross-sectional view of the spring member taken along line 71B-71B of FIG. 70C;

FIG. 72A is a perspective view of the spring member and the male terminal of FIG. 67 in a first partially assembled state, S_{1PA};

FIG. 72B is a perspective view of the spring member and the male terminal of FIG. 67 in a second partially assembled state, S_{2PA};

FIG. 73 is a side view of the male terminal assembly of FIG. 66 shown in the fully assembled state, S_{FA};

FIG. 74 is a cross-sectional view of the male terminal assembly taken along line 74-74 of FIG. 73;

FIG. 75A is a perspective view of a fourth embodiment of a male terminal assembly in a fully assembled state, S_{FA};

FIG. 75B is an exploded view of the male terminal assembly of FIG. 75A, showing a male terminal, spring member, and a jacket;

FIG. 76 is a front view of the male terminal of FIG. 75B, showing a male terminal body with a plurality of contact arms;

FIG. 77 is a perspective view of the male terminal of FIG. 76;

FIG. 78 is a side view of the male terminal of FIG. 76, showing the male terminal body;

FIG. 79 is a cross-sectional view of a portion of the male terminal taken along line 79-79 of FIG. 78;

FIG. 80 is a zoomed-in side view of the contact arm of the male terminal of FIG. 78;

FIG. 81 is a zoomed-in front view of the contact arm of the male terminal of FIG. 76;

FIG. 82 is a perspective view of the spring member of the male terminal assembly of FIG. 75B;

FIG. 83 is a top view of the spring member of FIG. 82;

FIG. 84 is a side view of the spring member of FIG. 82;

FIG. 85 is a cross-sectional view of the spring member taken along line 85-85 of FIG. 84;

FIG. 86 is a perspective view of the spring member and the male terminal of FIG. 75B in a disassembled state, S_{DA};

FIG. 87 is a front view of the spring member and the male terminal of FIG. 75B in a first partially assembled state, S_{1PA};

FIG. 88 is a cross-sectional view of the spring member and the male terminal taken along line 88-88 of FIG. 87;

FIG. 89 is a perspective view of the male terminal assembly of FIG. 75B in a second partially assembled state, S_{2PA};

FIG. 90 is a top view of the male terminal assembly of FIG. 75B in a fully assembled state, S_{FA};

FIG. 91 is a cross-sectional view of the male terminal assembly taken along line 91-91 of FIG. 90;

FIG. 92 is a side view of the male terminal assembly of FIG. 75B in a fully assembled state, S_{FA};

FIG. 93 is a cross-sectional view of the male terminal assembly taken along line 93-93 of FIG. 92;

FIG. 94 is a zoomed-in view of the male terminal assembly shown in FIG. 91;

FIG. 95 is a zoomed-in view of a first portion of a jacket coupling means of the male terminal assembly shown in FIG. 91;

FIG. 96 is a zoomed-in view of the male terminal assembly shown in FIG. 93;

FIG. 97 is a top view of the male terminal assembly shown in FIG. 90;

FIG. 98 is a cross-sectional view of the male terminal assembly taken along line 98-98 of FIG. 97;

FIG. 99 is a front view of the male terminal assembly shown in FIG. 90;

FIG. 100 is a cross-sectional view the male terminal assembly taken along line 100-100 of FIG. 99;

FIG. 101 is a perspective view of a fifth embodiment of a male terminal assembly, showing a male terminal, spring member, and a jacket in a fully assembled state, S_{FA};

FIG. 102 is a front view of the male terminal assembly of FIG. 101;

FIG. 103 is a cross-sectional view the male terminal assembly taken along line 103-103 of FIG. 102;

FIG. 104 is a perspective view of a sixth embodiment of a male terminal assembly, showing a male terminal, spring member, and a jacket in a fully assembled state, S_{FA};

FIG. 105 is a perspective view of a seventh embodiment of a male terminal assembly in a fully assembled state, S_{FA};

FIG. 106 is an exploded view of the male terminal assembly of FIG. 105, showing a male terminal, spring member, and a jacket;

FIG. 107 is a perspective view of the spring member shown in FIG. 106;

FIG. 108 is a front view of the spring member of FIG. 107;

FIG. 109 is a side view of the spring member of FIG. 107;

FIG. 110 is a front view of the male terminal assembly of FIG. 105;

FIG. 111 is a cross-sectional view of the male terminal assembly taken along line 111-111 of FIG. 110; and

FIG. 112 is a zoomed in view of a frontal portion of the male terminal assembly shown in FIG. 111.

FIG. 113 is a diagram showing a vehicle, an AC charging system, and a DC charging system, wherein the AC charging system and DC charging system have at least one charge coupler and at least one socket;

FIG. 114 is perspective view of the charging system of FIG. 113, where the charge coupler is disconnected from the socket, where each includes at least one male terminal assembly and at least one female terminal assembly;

FIG. 115 is a perspective view of a battery pack having a plurality of the connector systems to electrically connect components of the battery pack;

FIG. 116 is a perspective view of a vehicle skateboard chassis with the battery pack of FIG. 115, as well as wheels and tires;

FIG. 117 is a perspective view of a motor vehicle having the skateboard chassis and battery pack of FIG. 116.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present teachings.

While this disclosure includes several embodiments in many different forms, it should be understood that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified without departing from the scope of the disclosed methods and systems. For example, one or more of the following embodiments, in part or whole, may be combined consistently with other disclosed methods and systems. Accordingly, the drawings and detailed descriptions are to be regarded as illustrative in nature, not restrictive or limiting.

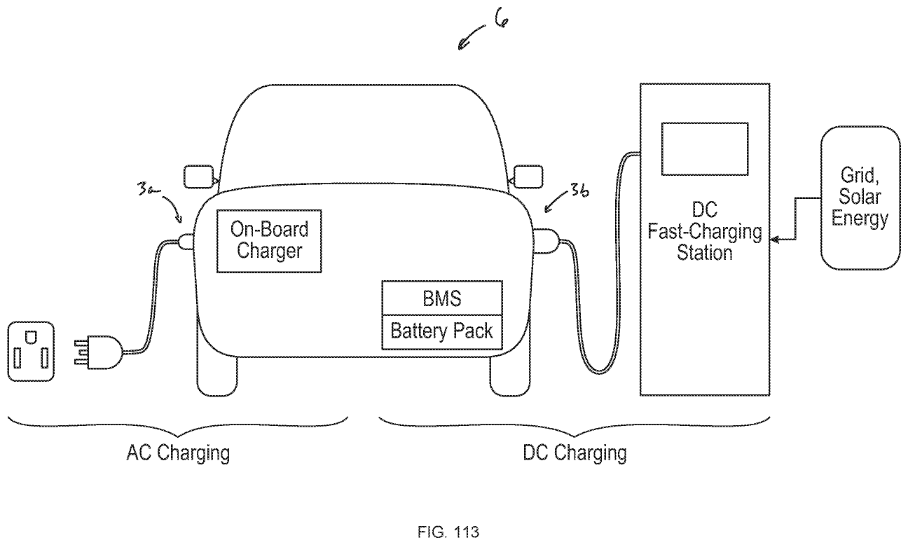

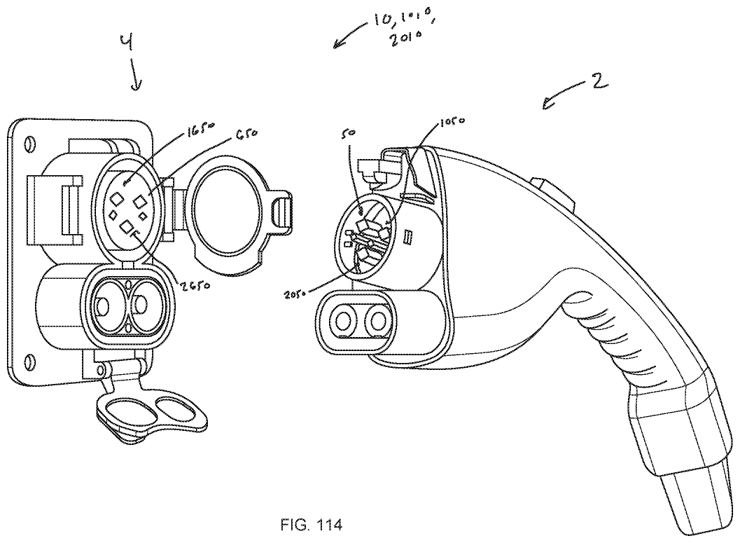

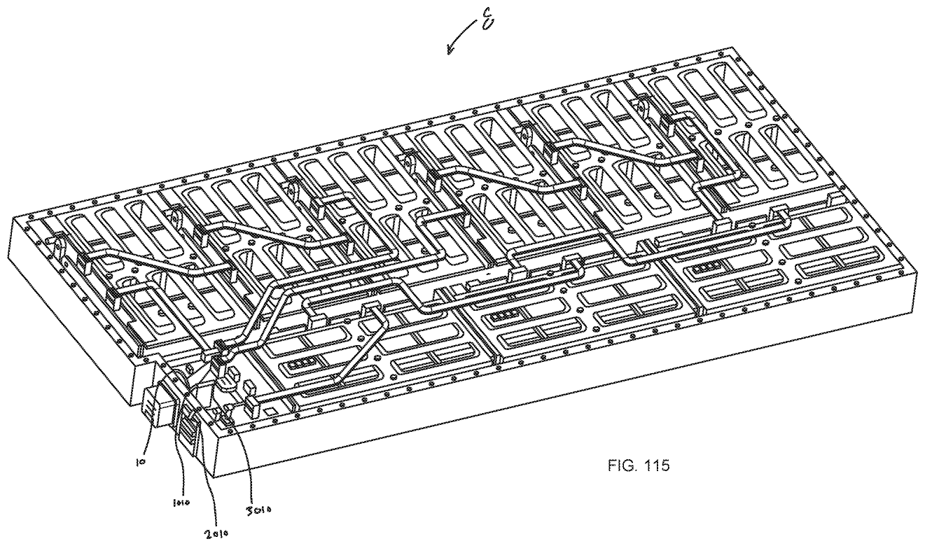

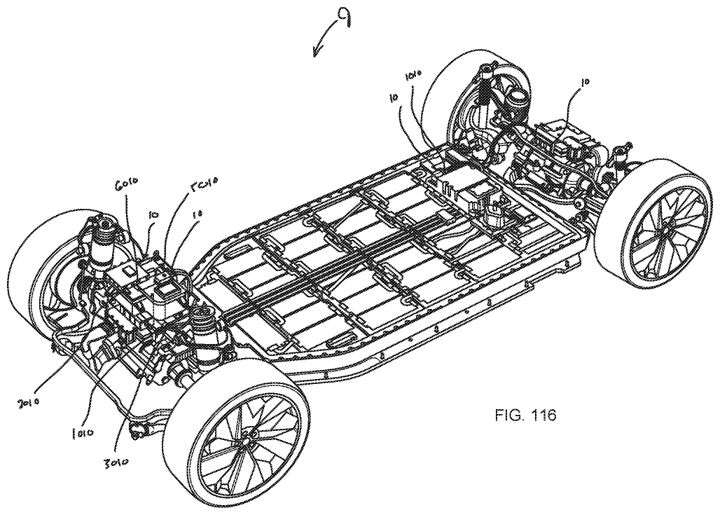

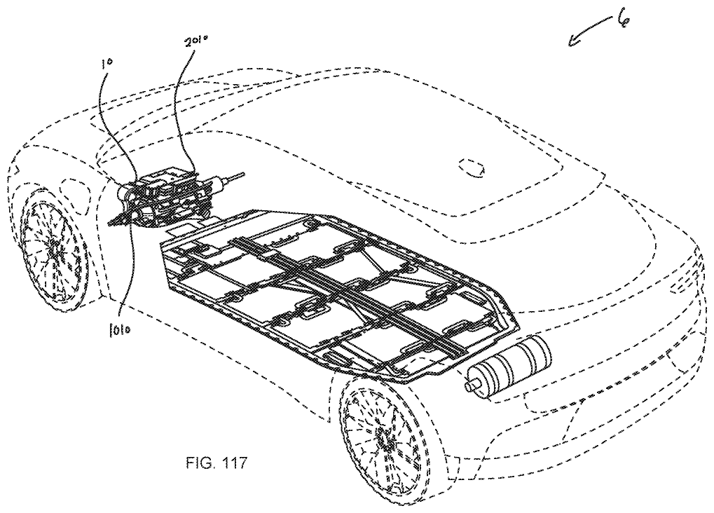

The Figures show seven embodiments of a connector system 10, 1010, 2010, 3010, 4010, 5010, 6010 or components thereof designed to mechanically and electrically couple one device or component to another device or component within a power distribution system or environment. For example, a first device or component can be removable coupled to a second device or component via the connector system 10. The first device or component may be a current supplying device or component—such as charge coupler 2 (see FIGS. 113-114), alternator, battery, or another power source—while the second device or component may be a current drawing device or component—such as socket 4 (see FIGS. 113-114), radiator fan, heated seat, power distribution component, or another current drawing component. In an exemplary embodiment, the FIG. 113 discloses a diagram showing a vehicle 6, an AC charging system 3a, and a DC charging system 3b, wherein the AC and DC charging systems 3a, 3b have at least one charge coupler 2 and at least one socket 4. The charge couplers 2 and the sockets 4 are matched to one another such that an extent of the charge coupler 2 can be received by the socket 4. In FIG. 114, the charge coupler 2 may include three male connector assemblies 50. Additionally, the charge coupler 2 may also include two male connector assemblies that are disclosed in PCT/US18/19787, PCT/US19/36010, or PCT/US21/43788. Meanwhile, the socket 4 may include three female connector assemblies 650. Additionally, the socket 4 may also include two female connector assemblies that are disclosed in PCT/US18/19787, PCT/US19/36010, or PCT/US21/43788. When charge coupler 2 is connected to the socket 4: (i) AC power can flow between the male and female connector assemblies 50, 650, and (ii) DC power can flow between the male and female connector assemblies disclosed in PCT/US18/19787, PCT/US19/36010, or PCT/US21/43788. Alternatively, one or more connector systems 10, 1010, 2010, 3010, 4010, 5010, 6010 may be utilized within a single device or component. A power distribution system or environment that includes the connector system 10, 1010, 2010, 3010, 4010, 5010, 6010 may be installed within an airplane, vehicle skateboard 9, motor vehicle 6, a military vehicle (e.g., tank, personnel carrier, heavy-duty truck, and troop transporter), a bus, a locomotive, a tractor, a boat, a submarine, a battery pack 8, a 24-48 volt system, for a high-power application, for a high-current application, for a high-voltage application.

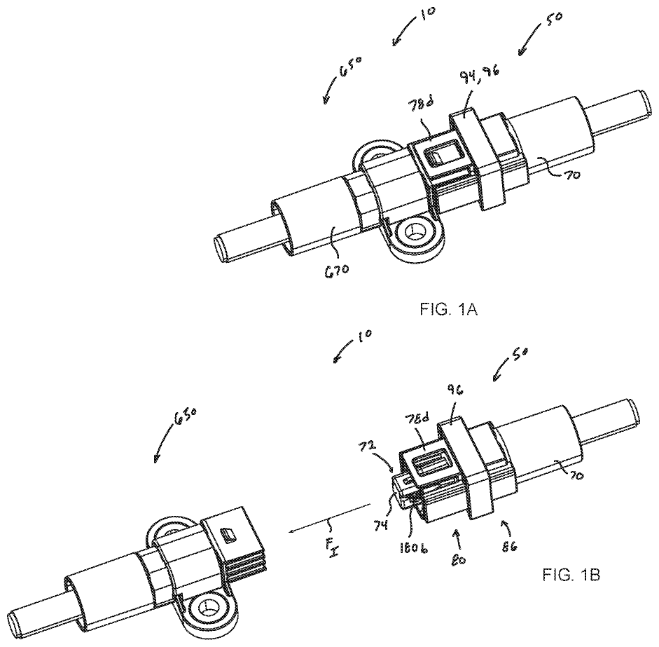

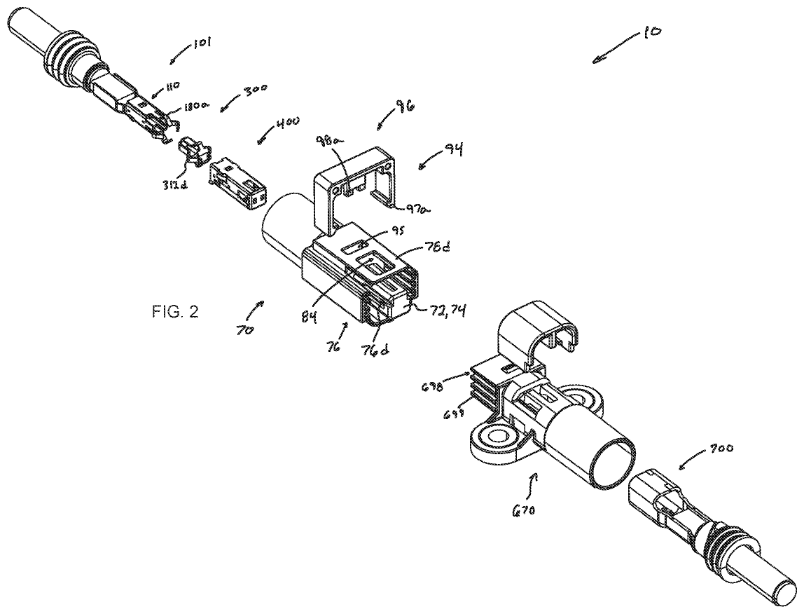

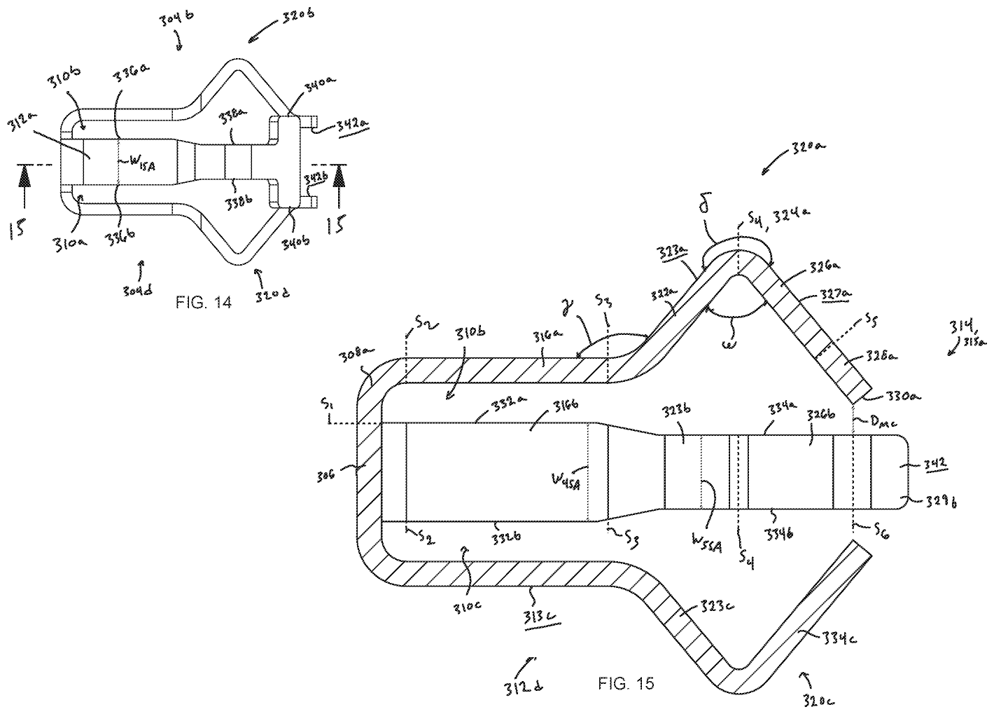

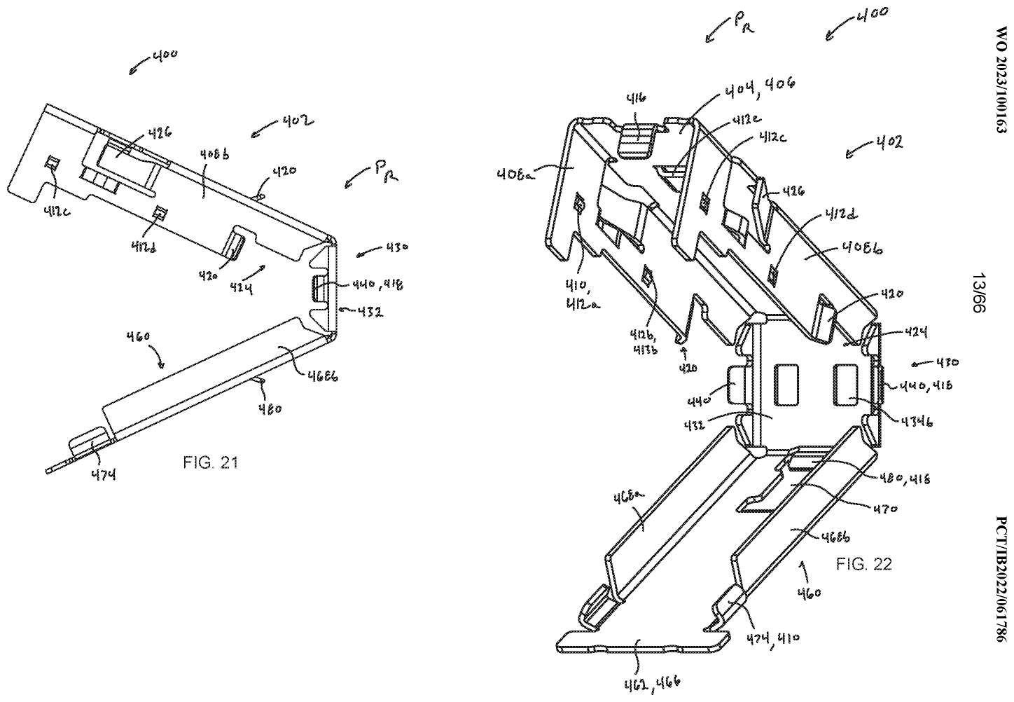

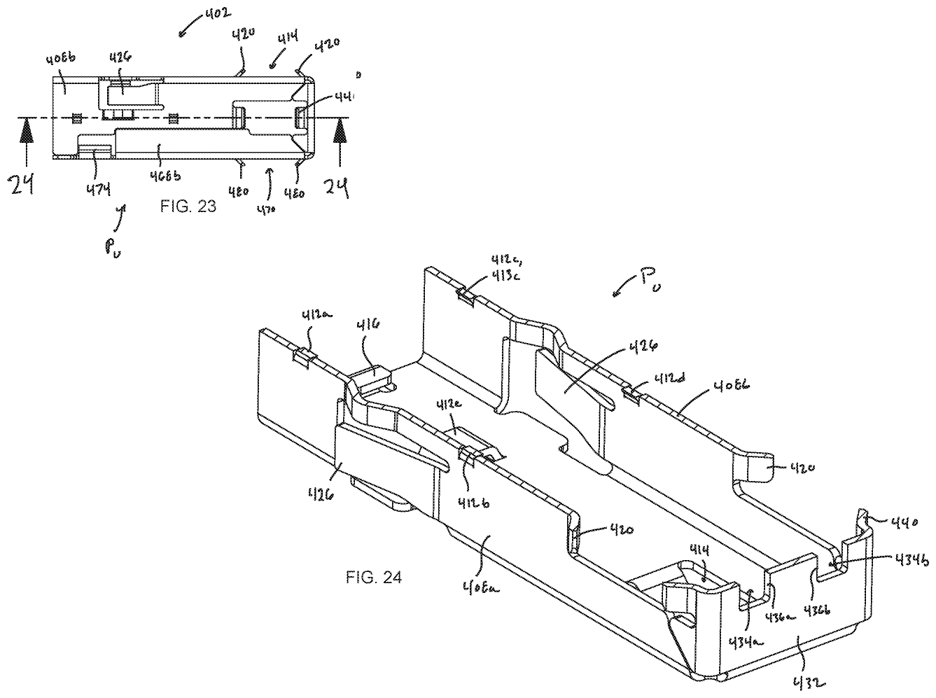

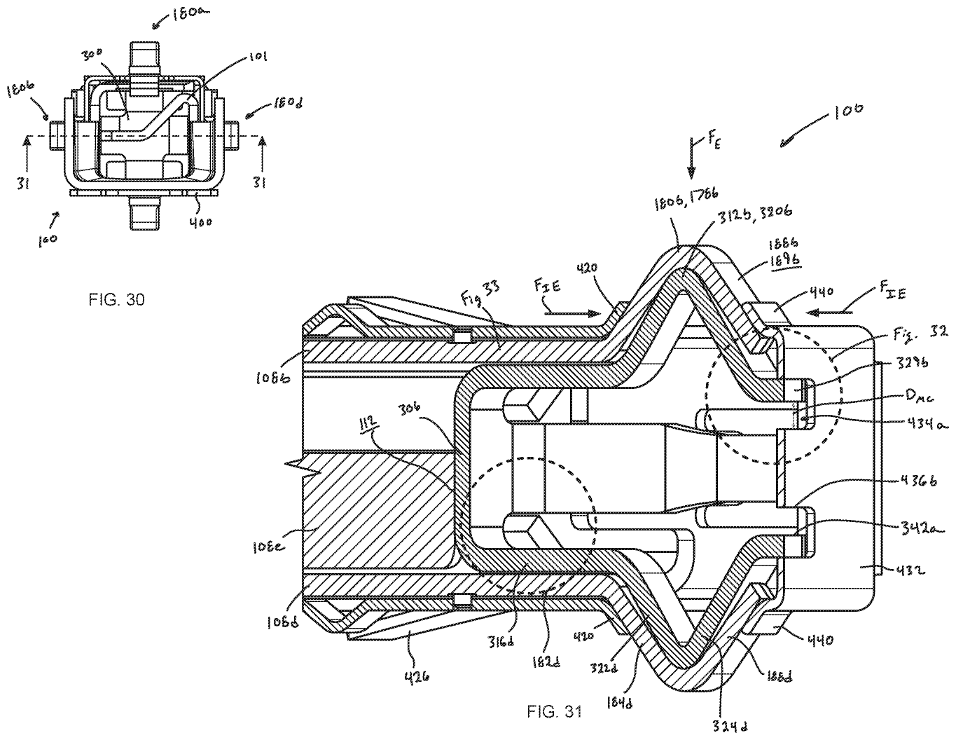

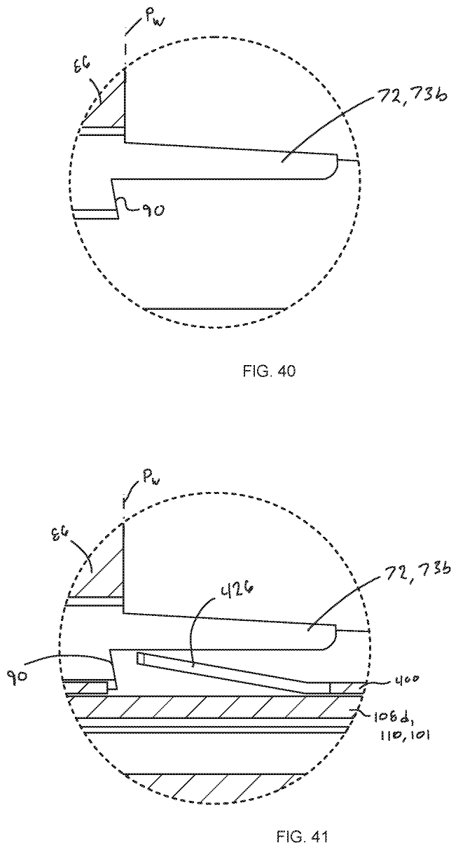

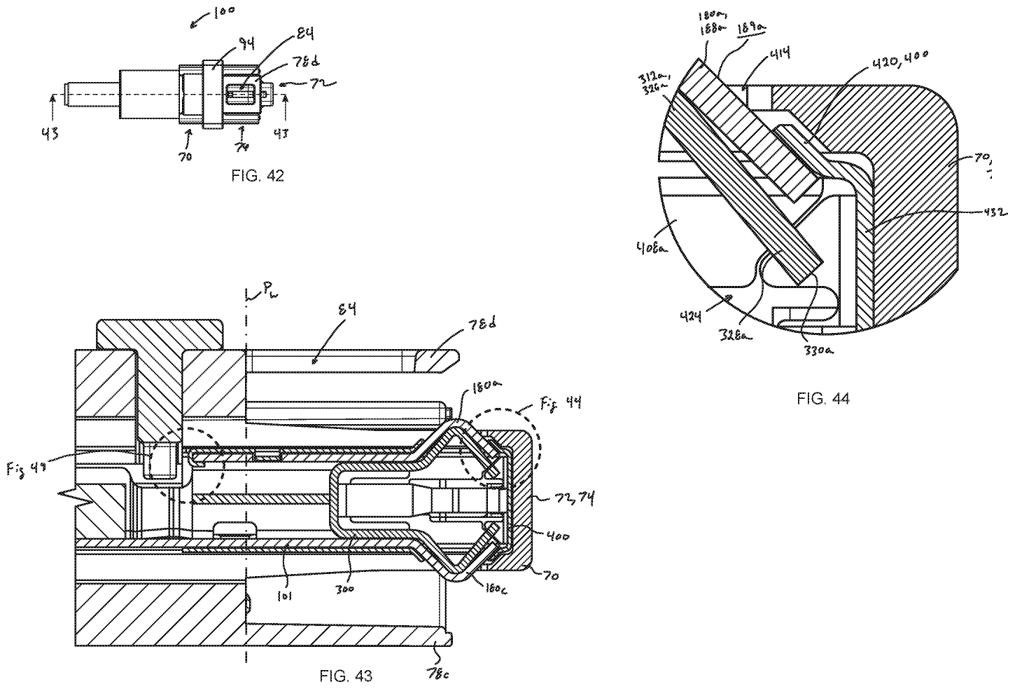

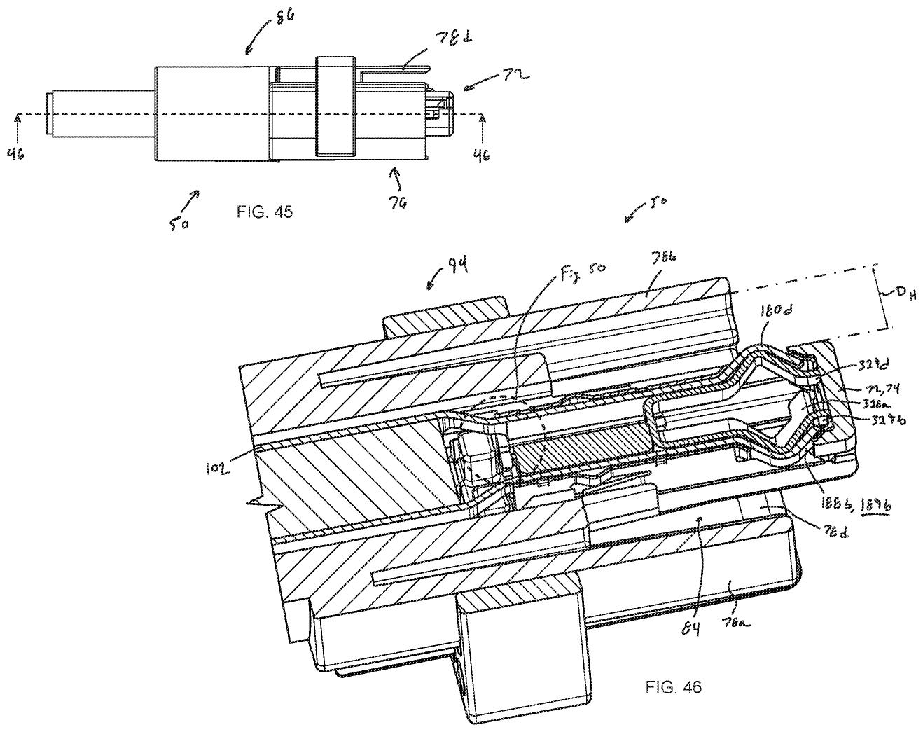

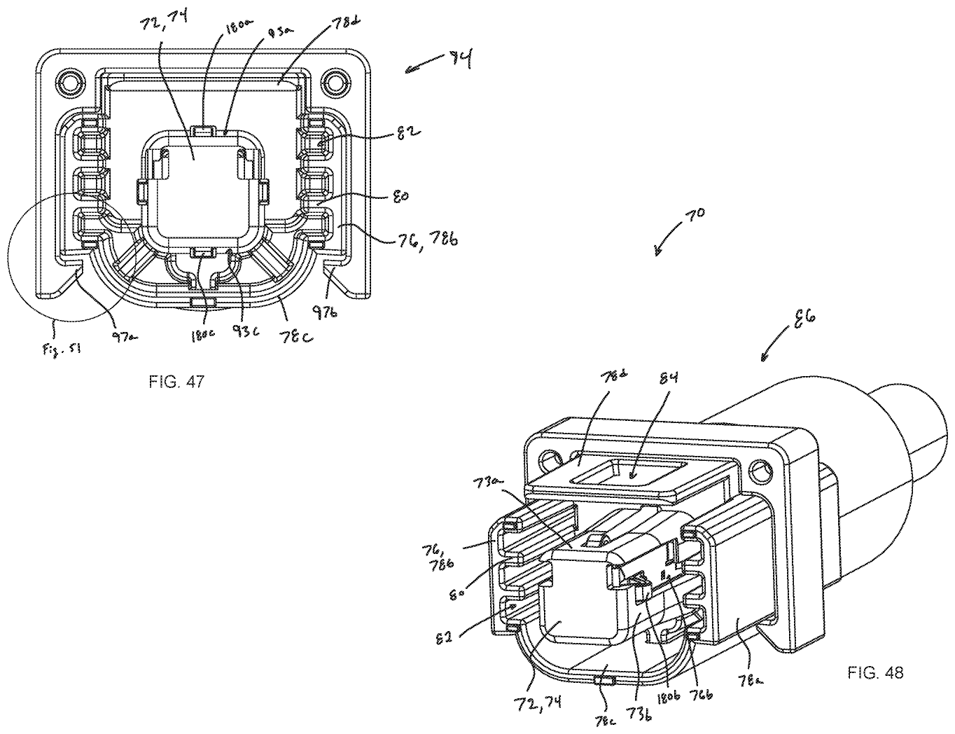

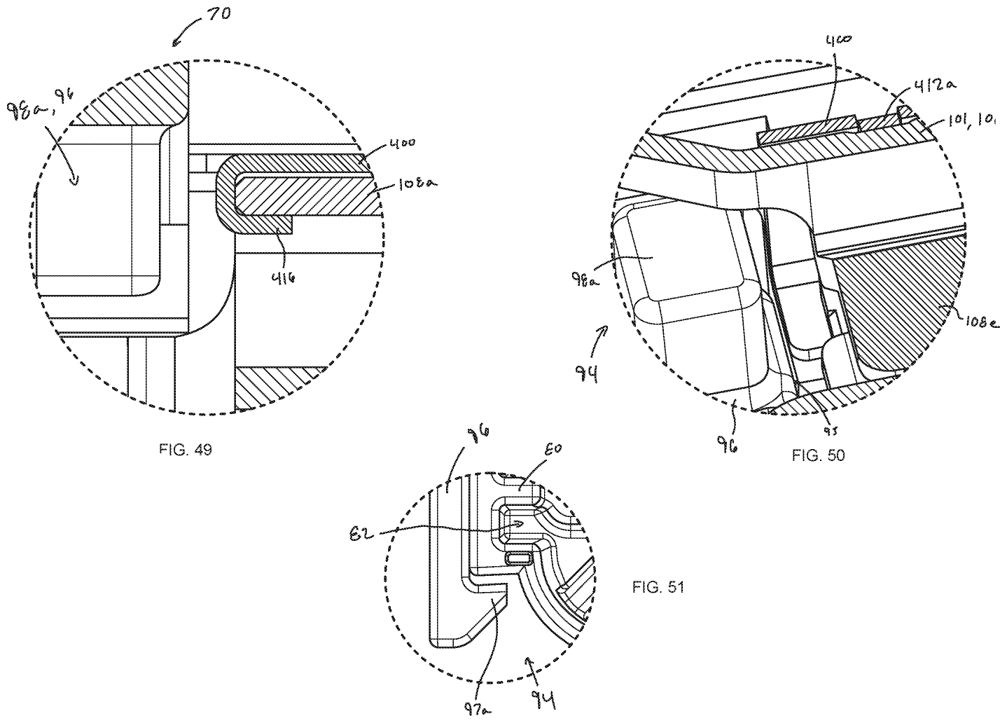

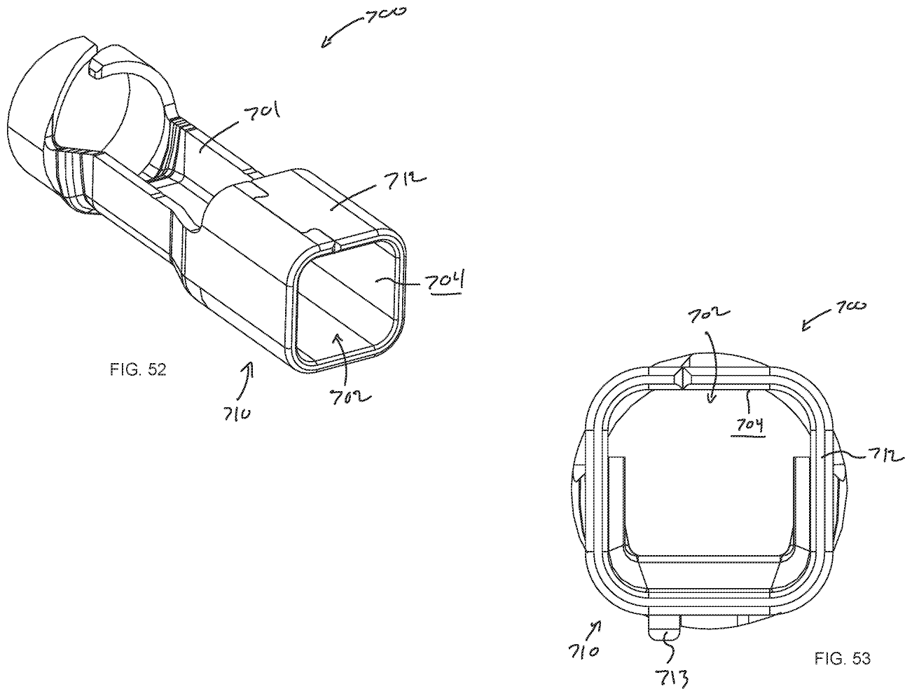

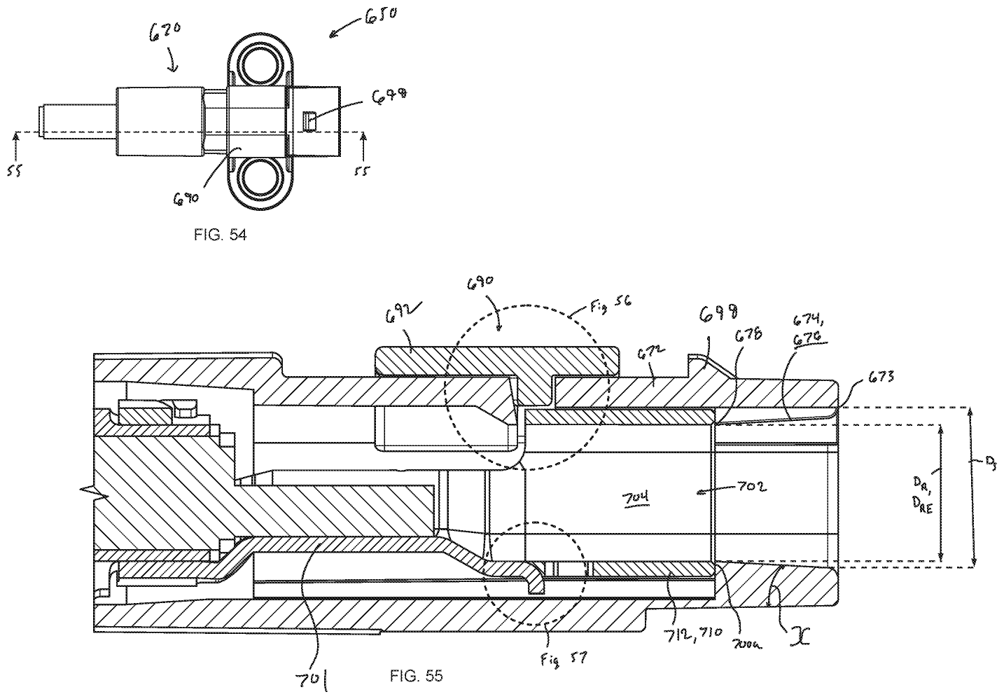

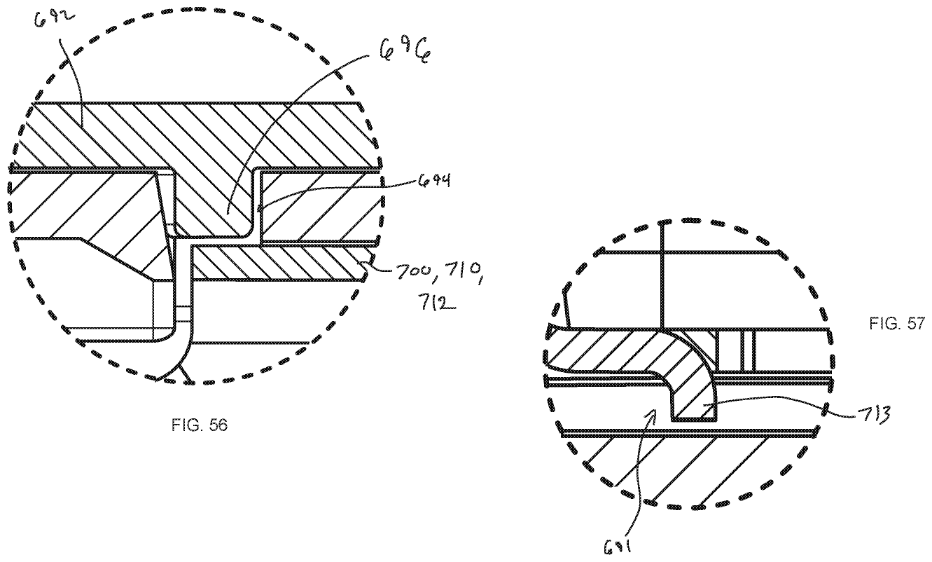

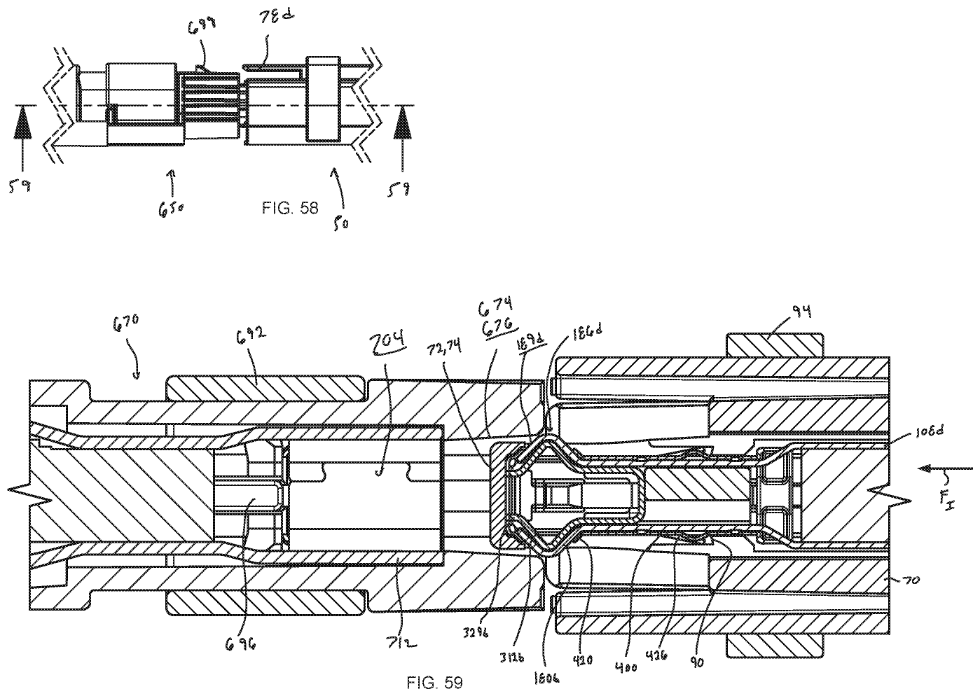

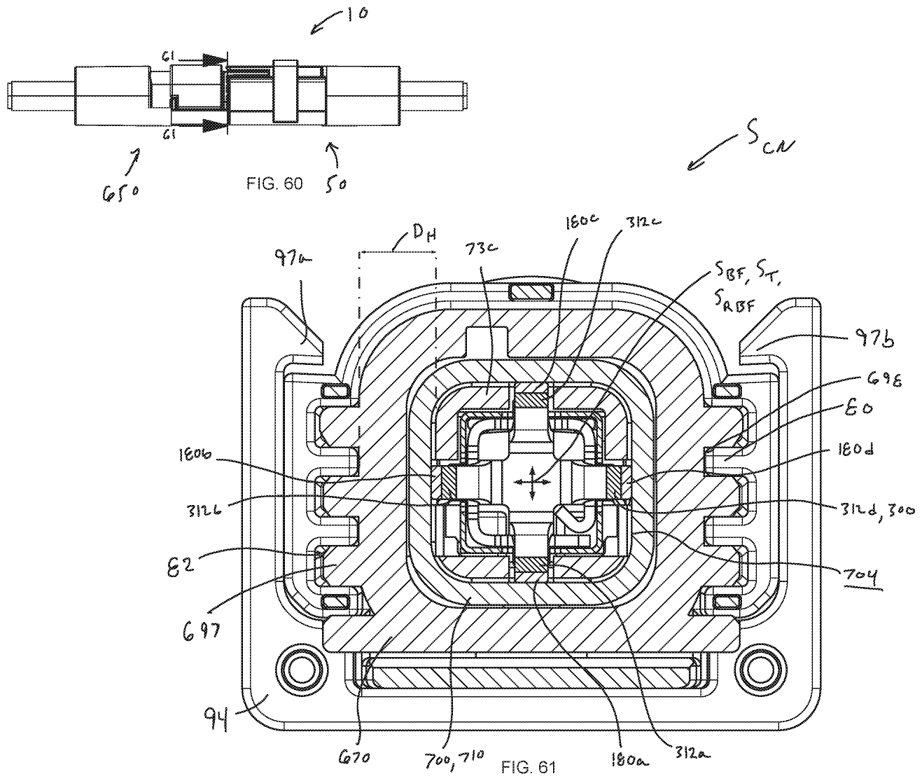

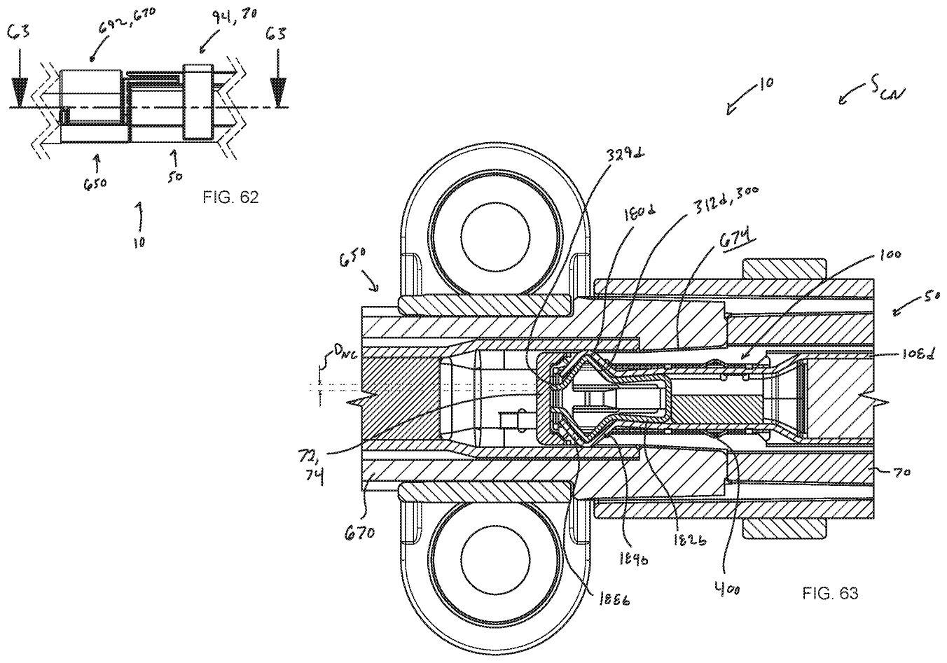

Various aspects of a first embodiment of the connector system 10 are explained in greater detail below. In general terms, the connector system 10 comprises: (i) a male connector assembly 50, and (ii) a female connector assembly 650. FIGS. 1-51 show various views and components of the male connector assembly 50. The first embodiment of the male connector assembly 50 is primarily comprised of: (i) a male housing assembly 70 and (ii) a male terminal assembly 100 having a male terminal 101, a spring member 300, and a jacket 400. FIGS. 52-57 show various views of the first embodiment of the female connector assembly 650, which primarily comprises: (i) a female housing assembly 670 and (ii) a female terminal assembly 700. Finally, FIGS. 58-63 show the positional relationship of and the interactions between the male connector assembly 100 and the female connector assembly 650.

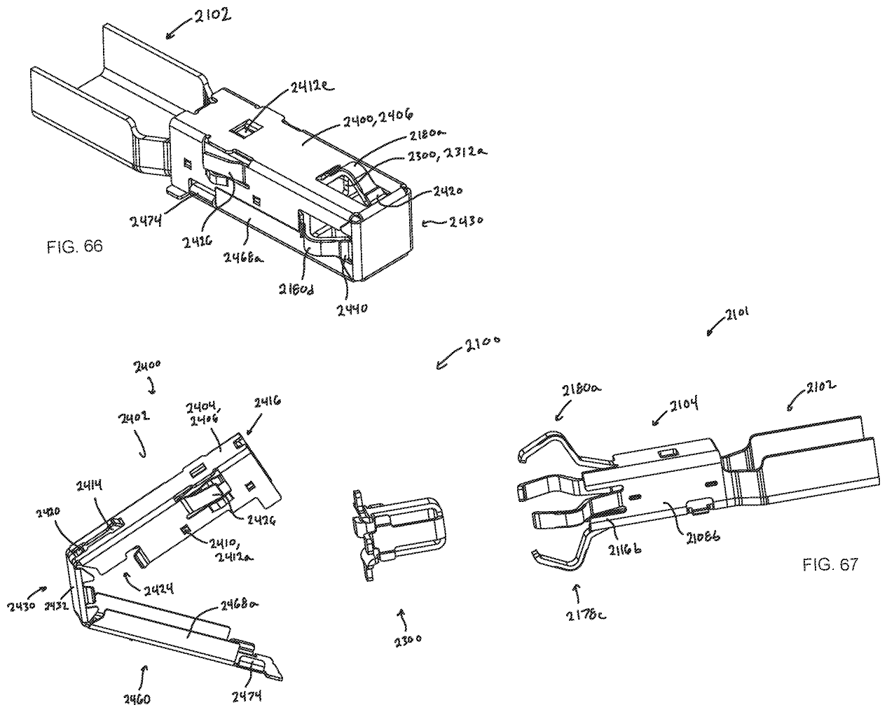

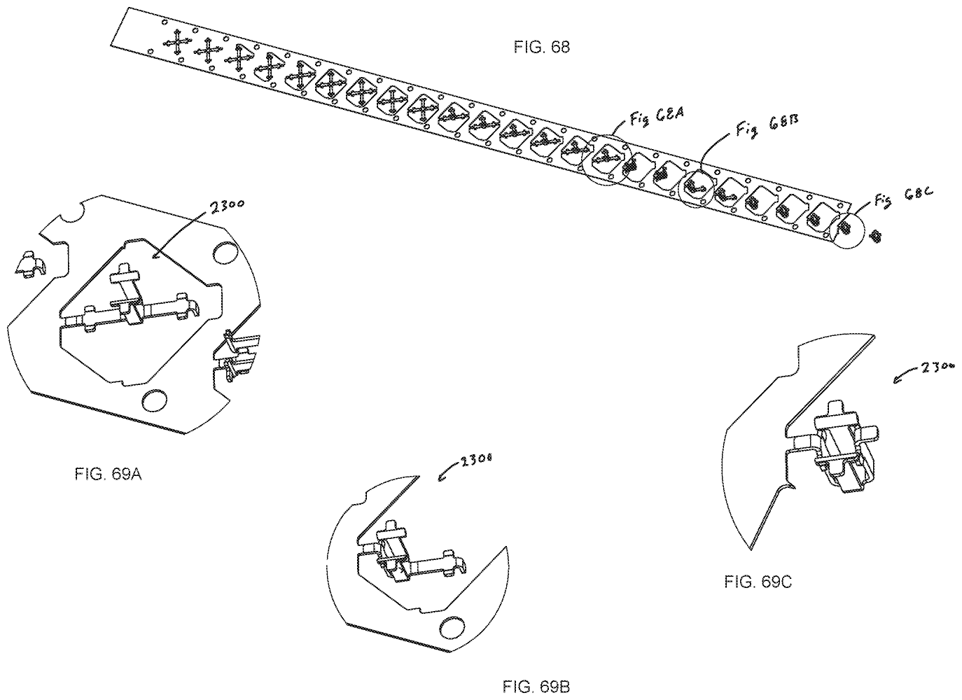

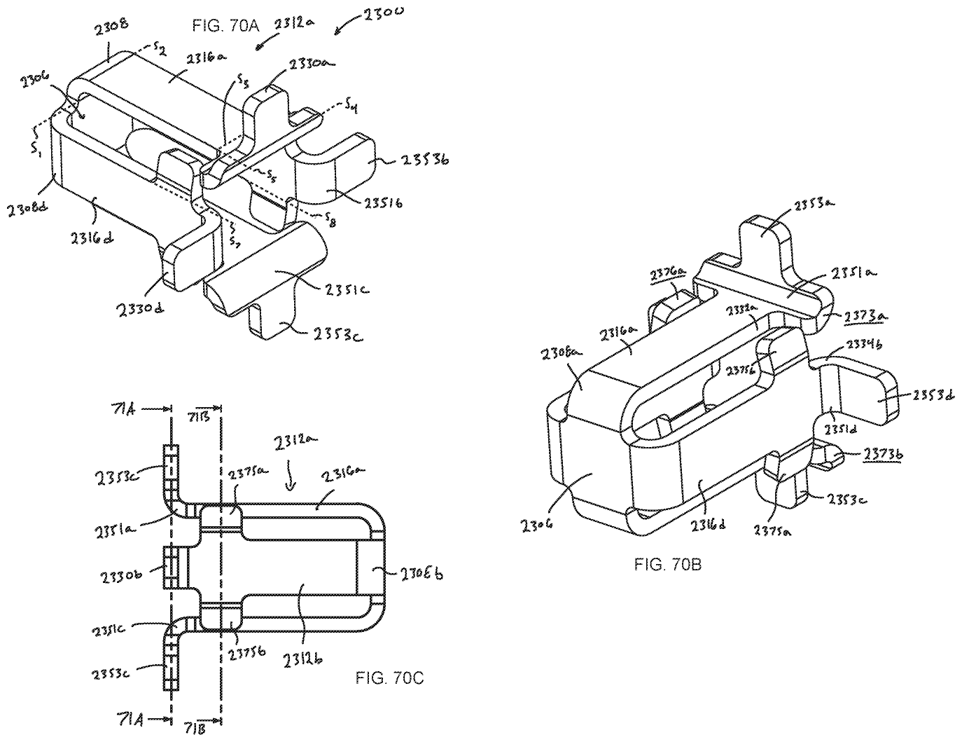

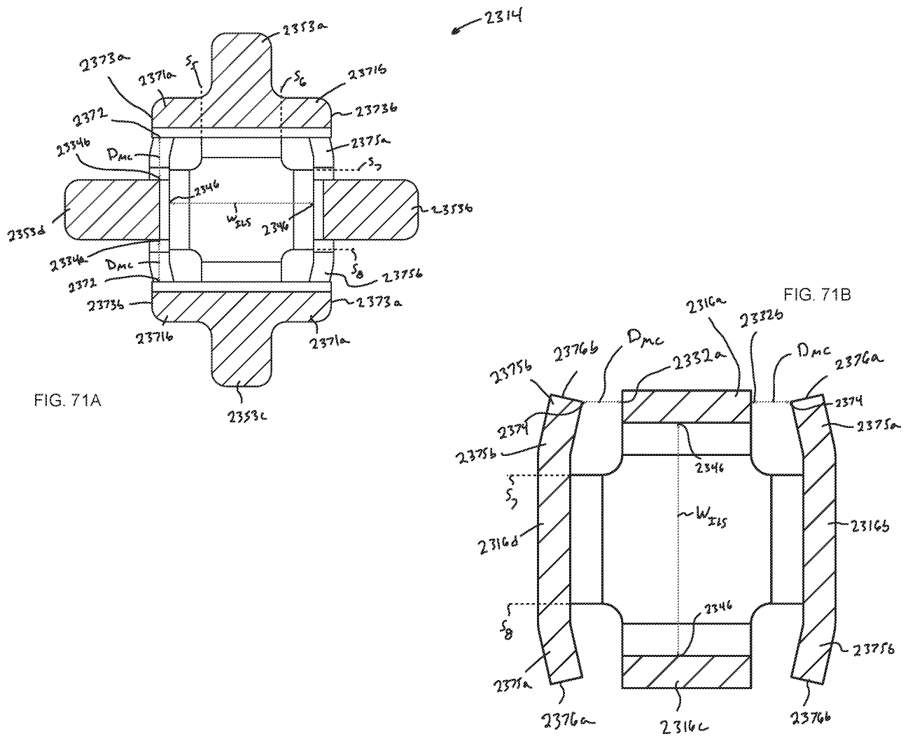

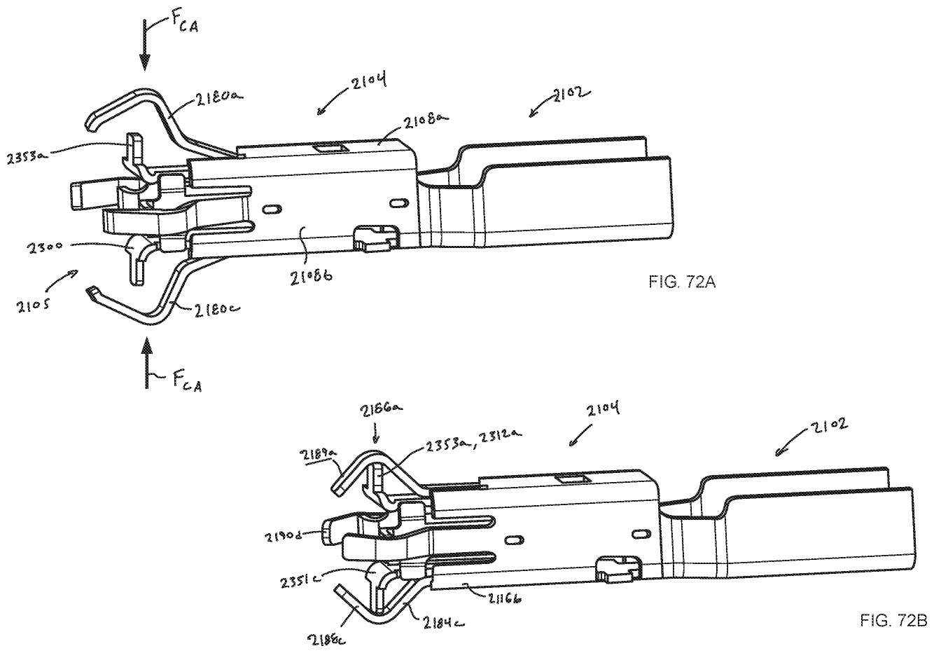

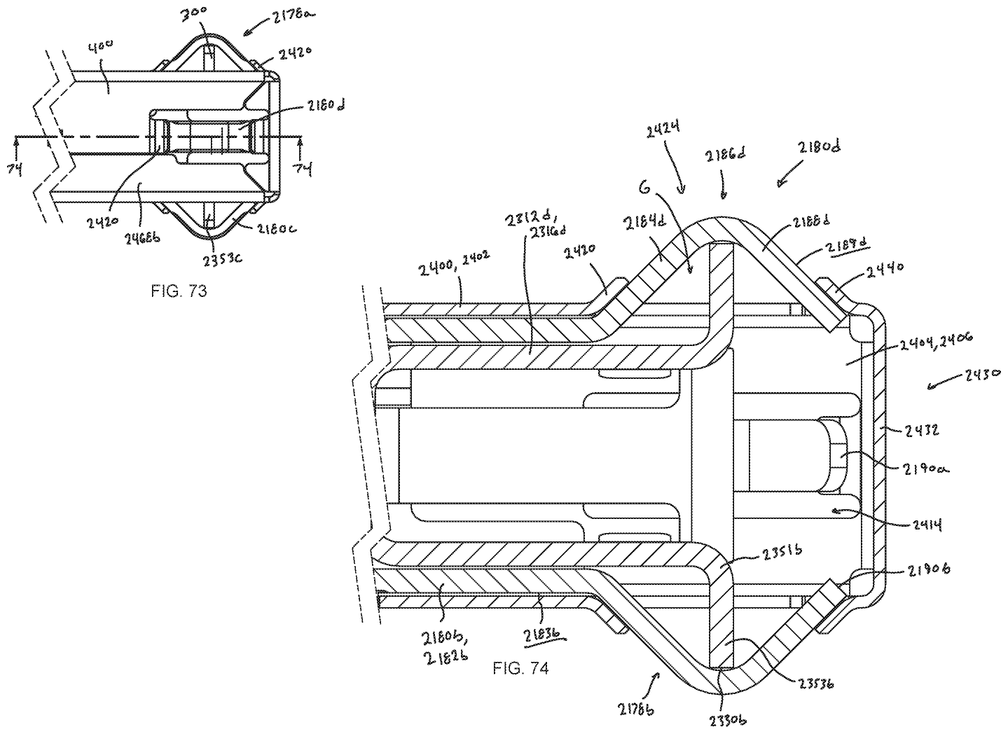

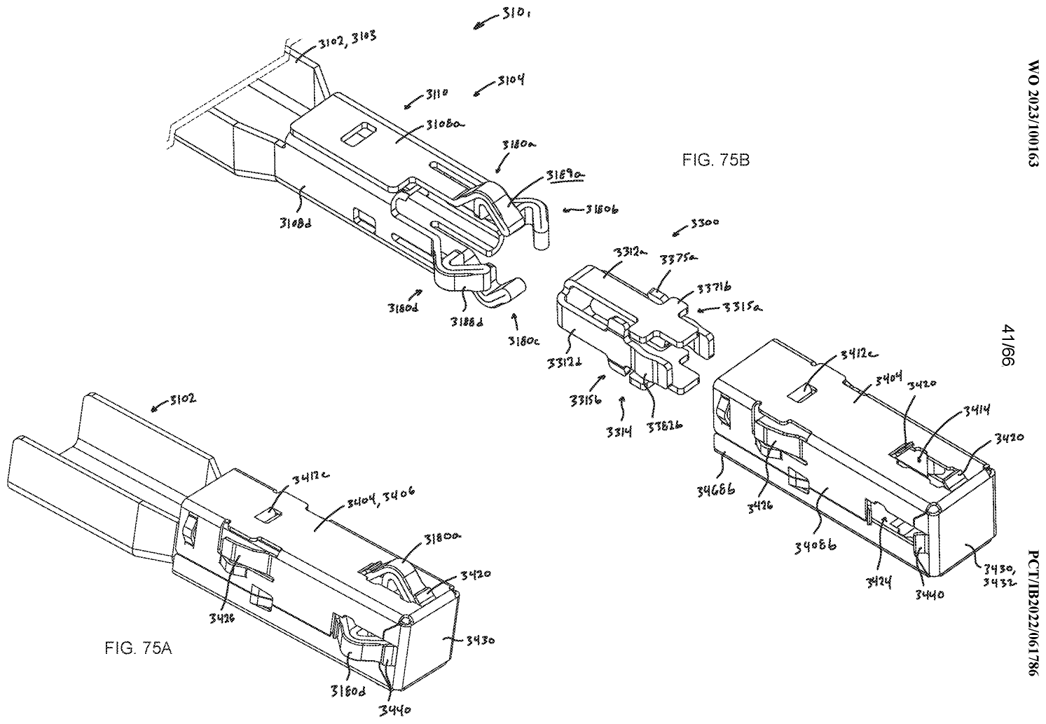

The various seven embodiments of the connector system 10 provide numerous improvements over conventional connectors. With regard to the first embodiment, these improvements include: (i) a male terminal body 104 that includes a base portion 110 and at least one contact arm 180a-180d with a portion 182a-182d that is substantially co-planar with said base portion 110, (ii) a male terminal body 104 with an anti-rotation projection 114, which is configured to help prevent the spring member 300 from rotating within the receptacle 105, (iii) the contact arms 180a-180d have a geometric bent or creased portion 178a-178d with a free end 190a-190d that does not abut a planar outer surface of the spring arms 312a-312d, when the spring member 300 is positioned in the receptacle 105, (iv) the male terminal body 104 and the spring member 300 are configured in a manner that prevents the spring member 300 from being inserted into the receptacle 105 when the contact arms 180a-180d are in the ready to use position P_{U} because the bent or creased portion 320a-320d of the spring member 300 would contact and engage (e.g., get snagged on) the free ends 190a-190d of the contact arms 180a-180d, (v) a separate spring member 300 with a geometric bent or creased portion 320a-320d of the spring arms 312a, 312b, (vi) a male terminal assembly 100 with means for limiting compression 314 of the contact arms 180a-180d that could lead to damage of the male terminal assembly 100, (vii) a spring member 300 with two spring arms 312a-312d, wherein the width of one spring arm 312a increases, between two points, such as along its length while the width of the second spring arm 312b decreases, between two points, such as along its length, (viii) a jacket 400 that includes spring openings 434a,434b formed in a frontal jacket segment 430, which are configured to receive an extent of the spring member 300, (ix) the jacket 400 including an arrangement of deflecting projections 418 that are configured to engage the contact arm 180a-d, as discussed below. While the foregoing list includes some of the numerous improvements that are included in the first embodiment of the connector system 10, it should be understood that other improvements are disclosed herein and that each and every improvement disclosed herein is not necessary or essential to the configuration, operation, or functionality of the disclosed connector system 10. Other similar embodiments of the connector system 10 are disclosed in FIGS. 64A-74, wherein said other embodiments show alternative configurations of the spring member 1300 and 2300.

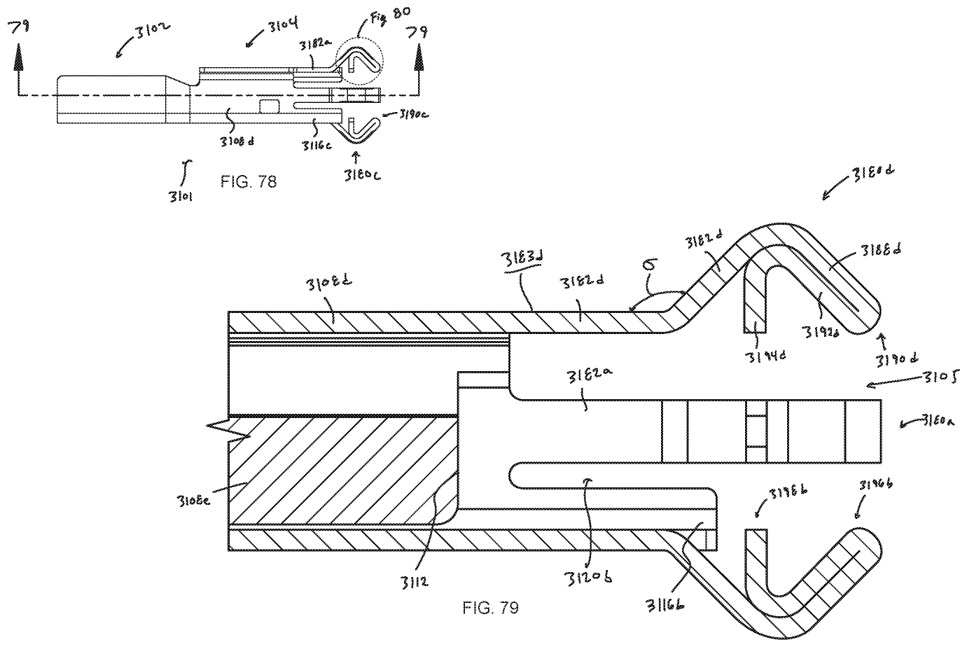

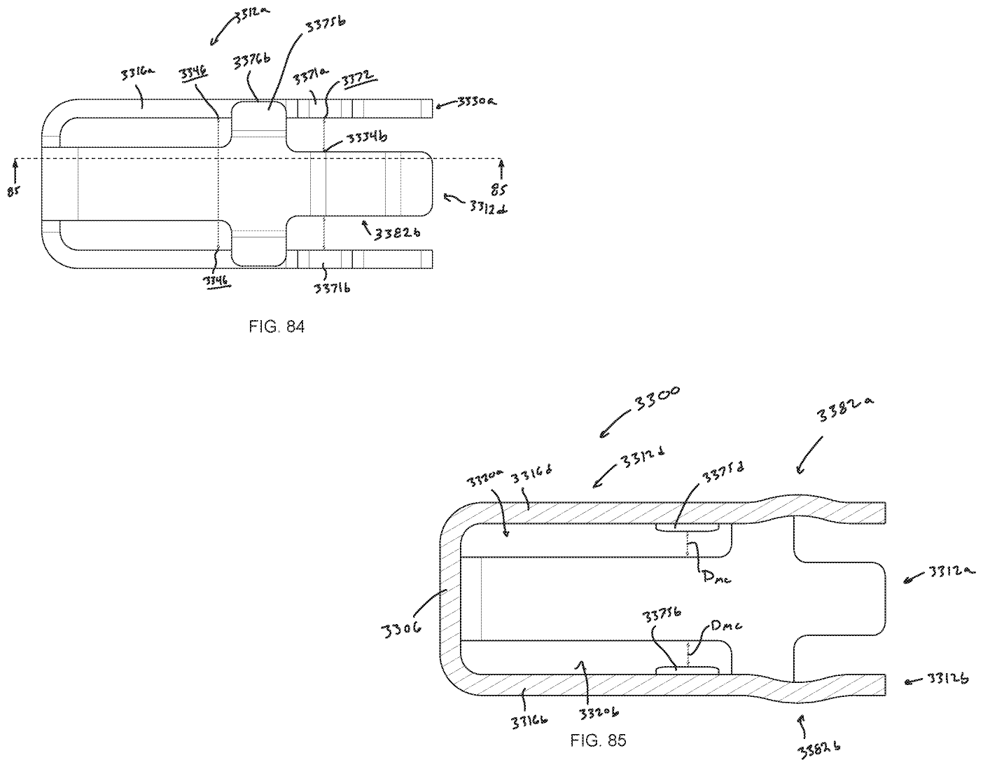

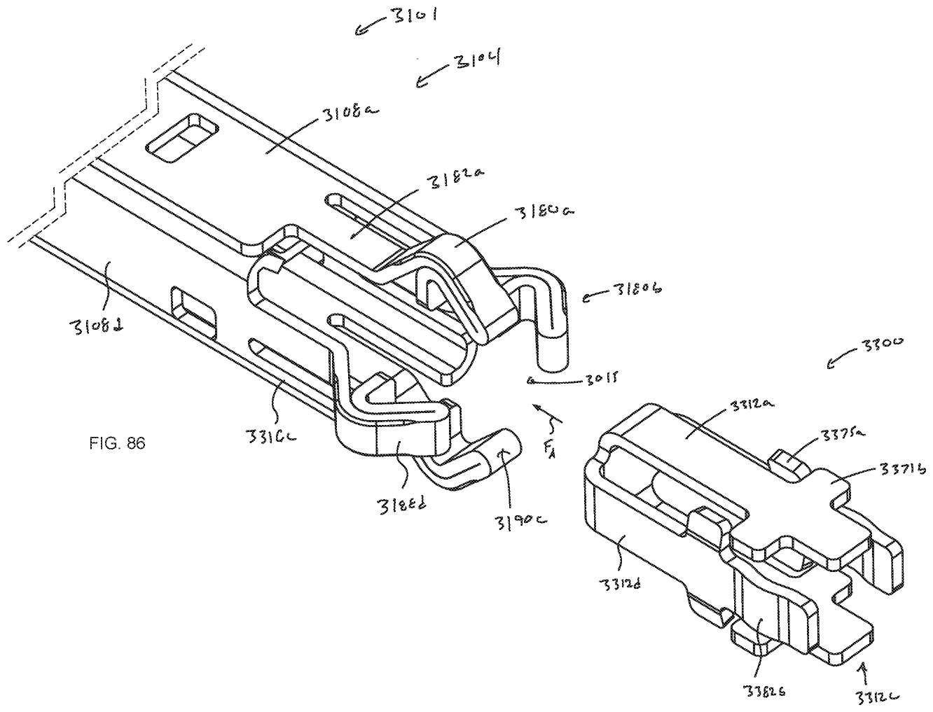

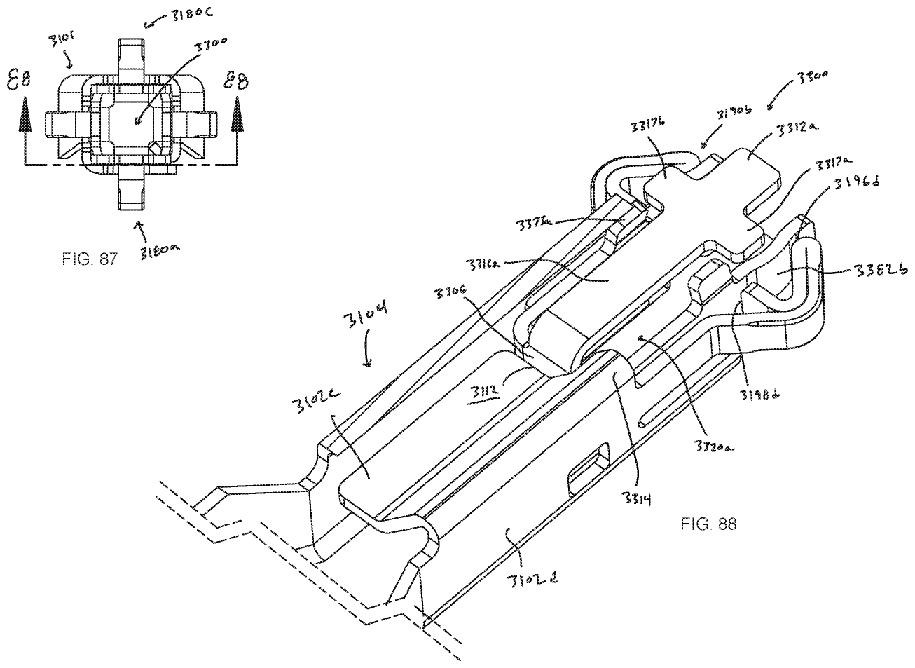

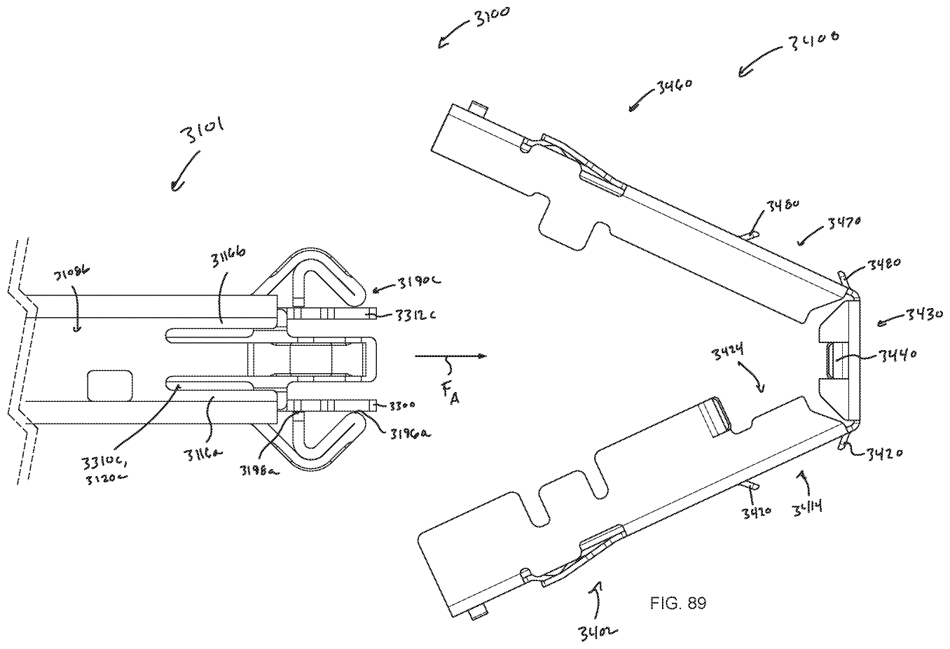

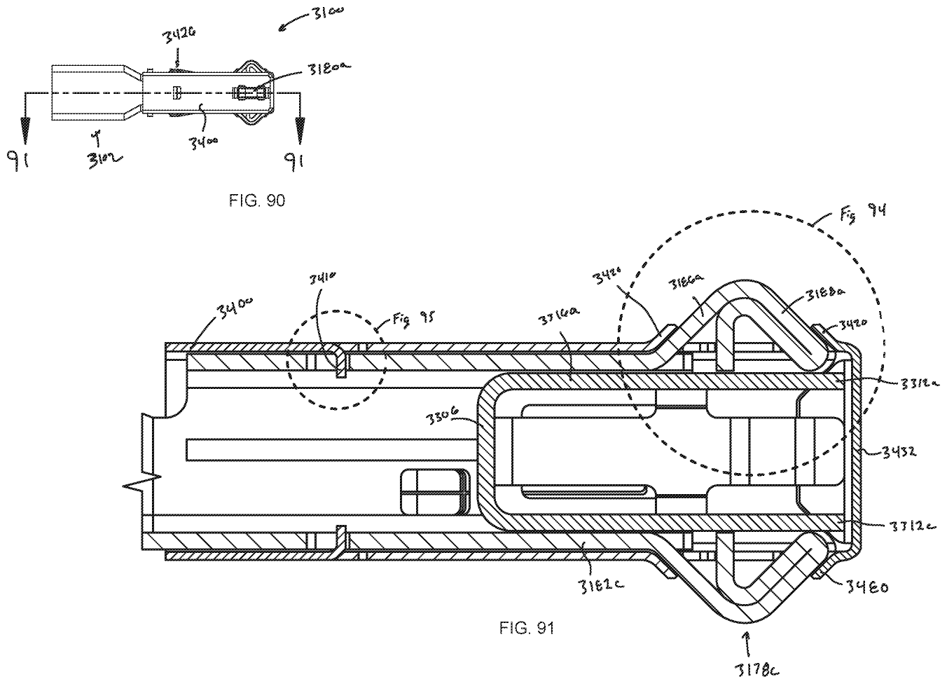

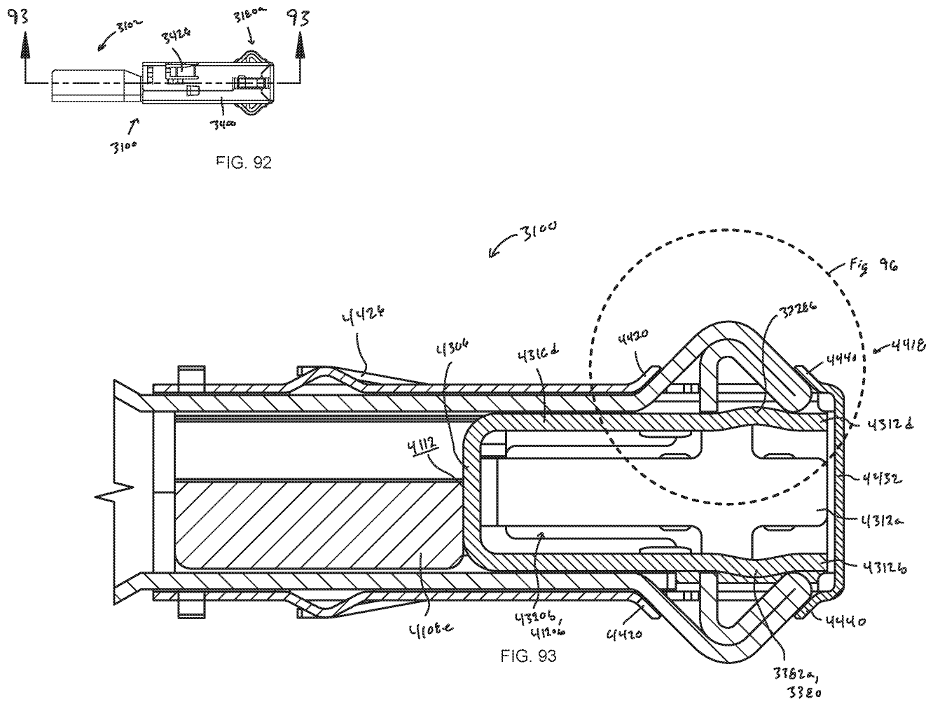

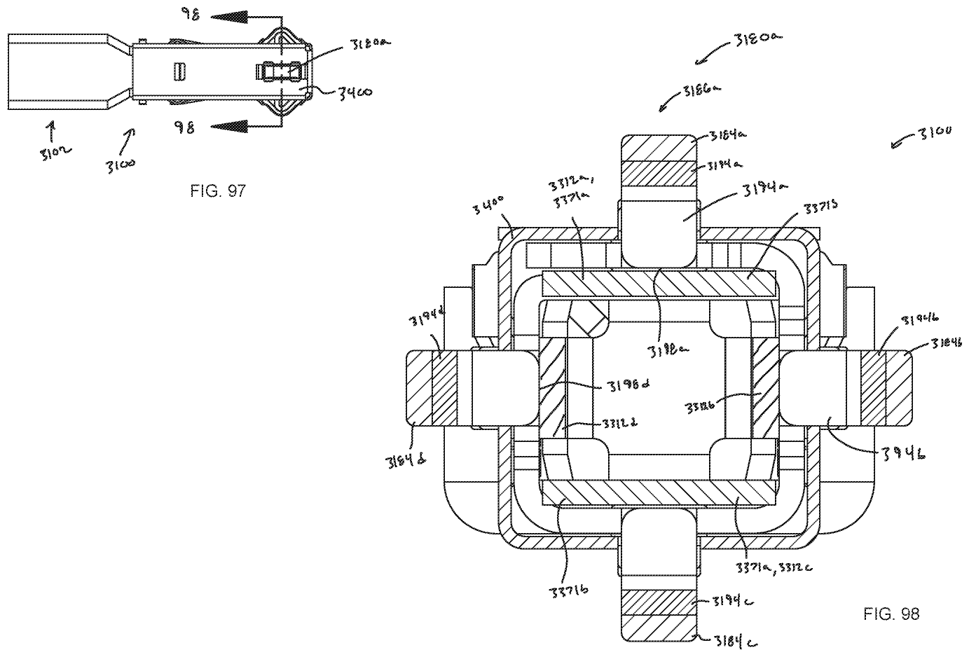

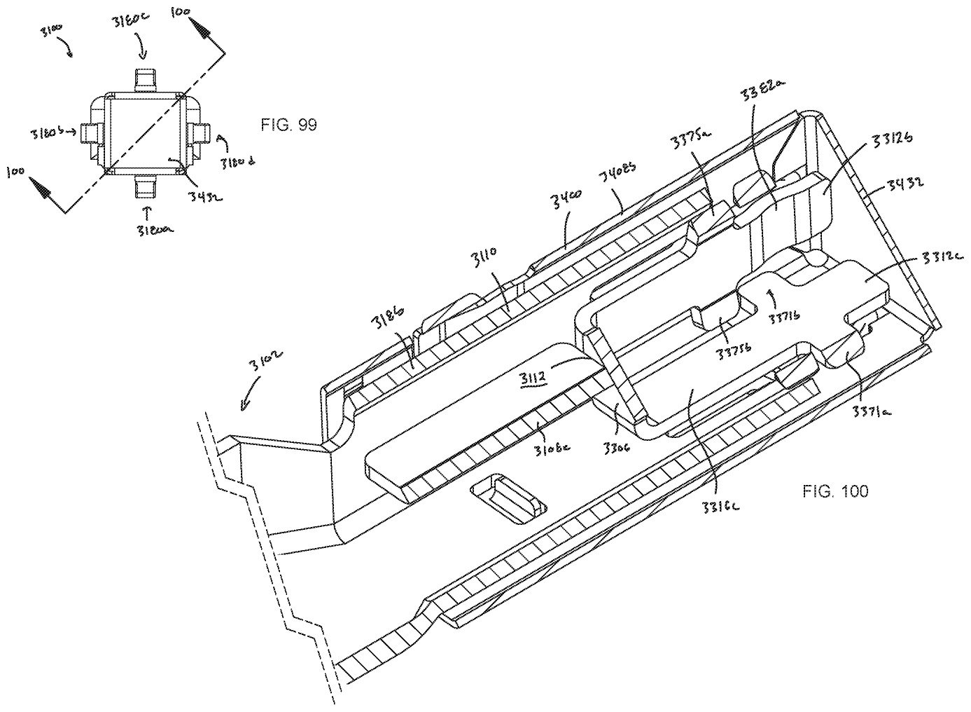

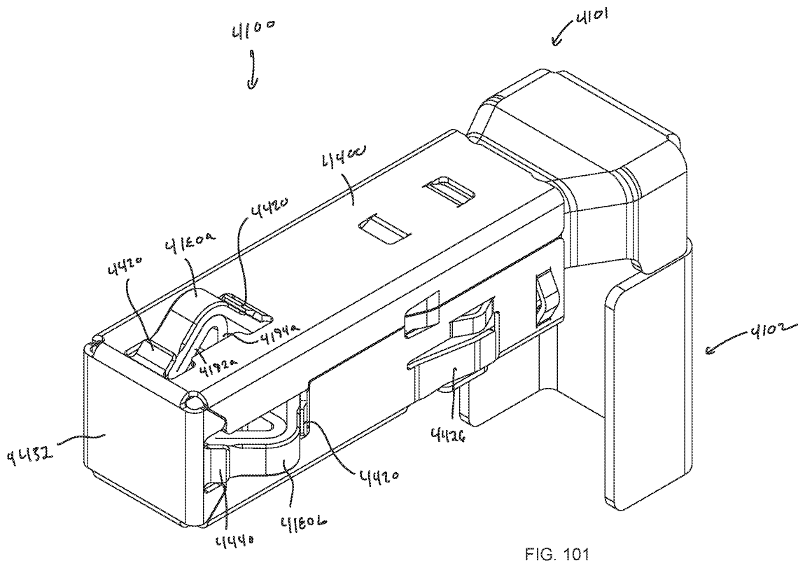

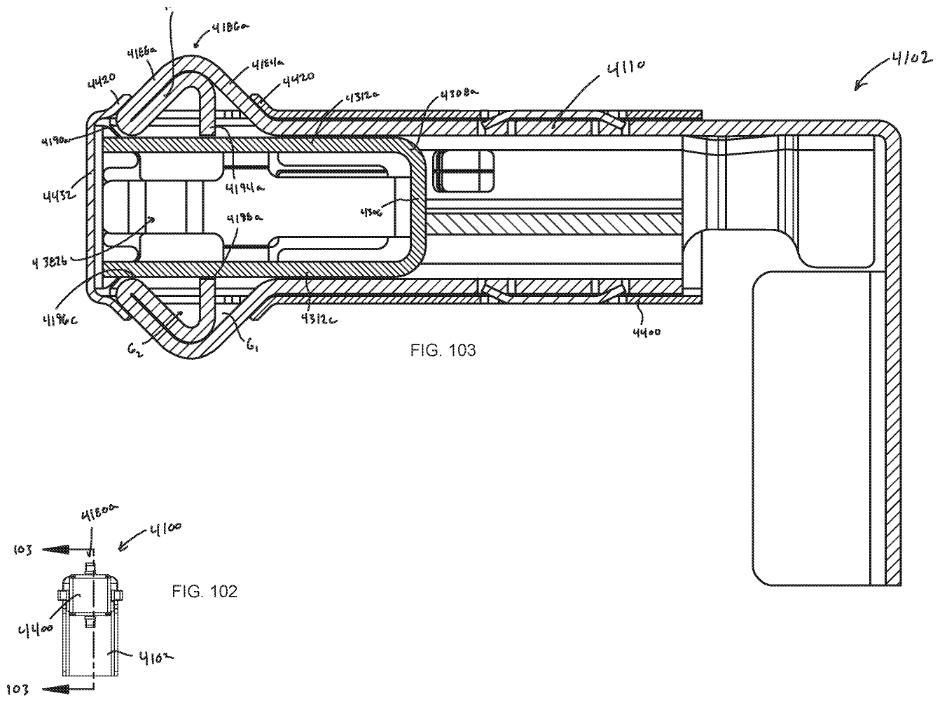

Various aspects of a fourth embodiment of the connector system 3010 are disclosed herein and shown in FIGS. 75-100. Specifically, the connector system 3010 comprises: (i) a male connector assembly 3050, and (ii) a female connector assembly 3650. FIGS. 75A-100 show various views and components of the male connector assembly 3050. The fourth embodiment of the male connector assembly 3050 is primarily comprised of: (i) a male housing assembly 3070 with structures and components that are substantially similar to that disclosed above in connection with the first embodiment, and (ii) a male terminal assembly 3100 having a male terminal 3101, a spring member 3300, and a jacket 3400. This fourth embodiment of the male connector assembly 3050 is configured to interact with the female connector assembly 650 disclosed in connection with the first embodiment of the system 10. This fourth embodiment of the connector system 3010 provides numerous improvements over conventional connectors. Some of these improvements include: (i) a male terminal body 3104 that includes a base portion 3110 and at least one contact arm 3180a-3180d with a portion 3182a-3182d that is substantially co-planar with said base portion 3110, (ii) said contact arms 3180a-3180d have a unique bent or creased configuration that creates two contact points 3196a-3196d, 3198a-3198d with the spring member 3300, (iii) a male terminal body 3104 with an anti-rotation projection 3114, which is configured to help prevent the spring member 3300 from rotating within the receptacle 3105, (iv) a separate spring member 3300 with a corrugation formed in at least one of the spring arms 3312a-3312d, (v) a spring member 3300 with means for limiting compression 3314, (vi) a jacket 3400 including deflecting projections 3418. While the foregoing list includes some of the numerous improvements that are included in the fourth embodiment of the connector system 3010, it should be understood that other improvements are disclosed herein and that each and every improvement disclosed herein is not necessary or essential to the configuration, operation, or functionality of the disclosed connector system 3010. Other similar embodiments of the connector system 3010 are disclosed in FIGS. 101-104, wherein said other embodiments show alternative male terminal connection members 4102, 5102.

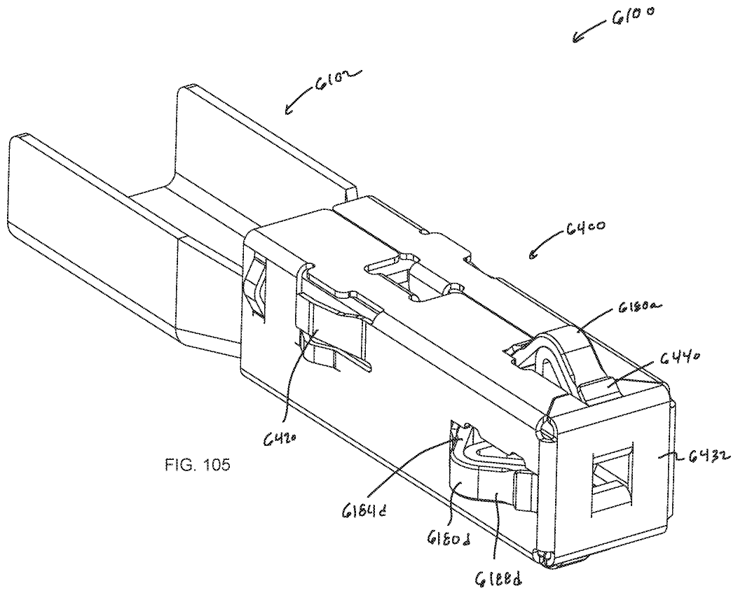

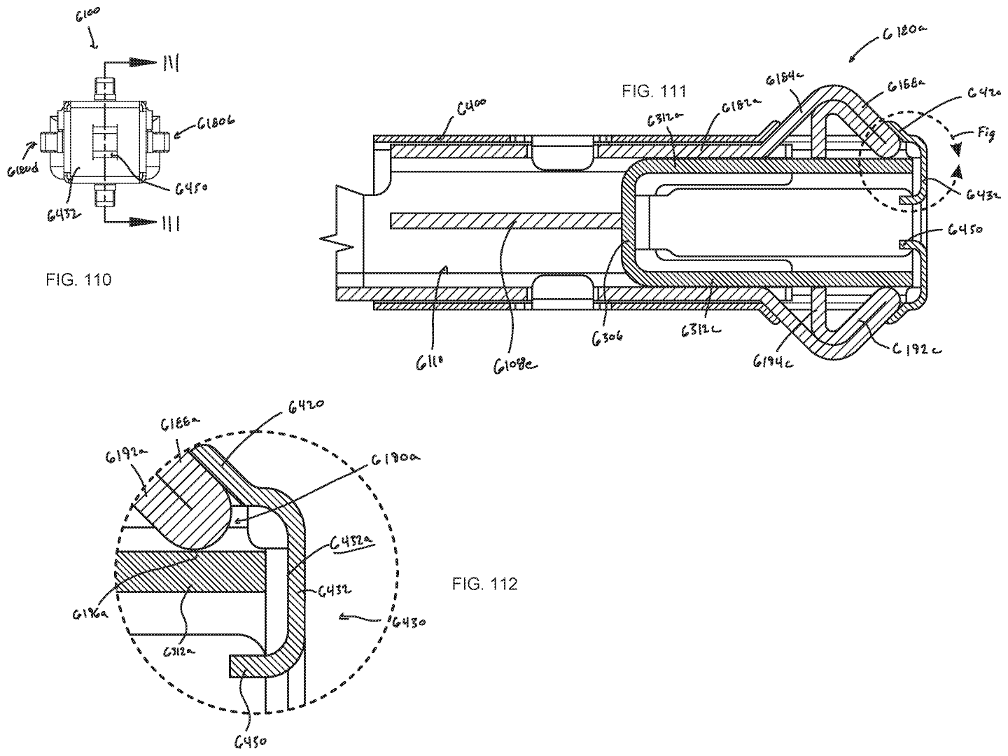

Various aspects of a seventh embodiment of the connector system 6010 are disclosed herein and shown in FIGS. 105-112. Specifically, the connector system 6010 comprises: (i) a male connector assembly 6050, and (ii) a female connector assembly 6650. FIGS. 105-112 show various views and components of the male connector assembly 6050. The seventh embodiment of the male connector assembly 6050 is primarily comprised of: (i) a male housing assembly 6070 with structures and components that are substantially similar to that disclosed above in connection with the first embodiment, and (ii) a male terminal assembly 6100 having a male terminal 6101, a spring member 6300, and a jacket 6400. This seventh embodiment of the male connector assembly 6050 is configured to interact with the female connector assembly 650 disclosed in connection with the first embodiment of the system 10. This seventh embodiment of the connector system 6010 provides numerous improvements over conventional connectors. Some of these improvements include: (i) a male terminal body 6104 that includes a base portion 6110 and at least one contact arm 6180a-6180d with a portion 6182a-6182d that is substantially co-planar with said base portion 6110, (ii) said contact arms 6180a-6180d have a unique bent or creased configuration that creates two contact points 6196a-6196d, 6198a-6198d with the spring member 6300, (iii) a male terminal body 6104 with an anti-rotation projection 6114, which is configured to help prevent the spring member 6300 from rotating within the receptacle 105, (iv) a jacket 6400 including deflecting projections 6418. While the foregoing list includes some of the numerous improvements that are included in the seventh embodiment of the connector system 6010, it should be understood that other improvements are disclosed herein and that each and every improvement disclosed herein is not necessary or essential to the configuration, operation, or functionality of the disclosed connector system 6010.

### First Embodiment

### 1) Male Connector Assembly

The male connector assembly 50 includes multiple components designed to be coupled to a separate device or component (e.g., charge coupler 2, radiator fan, heated seat, power distribution component, or another current drawing component). The male connector assembly 50 is primarily composed of: (i) the male housing assembly 70, and (ii) the male terminal assembly 100 with the male terminal 101, spring member 300, and jacket 400, wherein during operation of the connector system 10 at least a substantial extent of the male terminal assembly 100 resides within the male housing assembly 70.

a. Male Housing Assembly

Referring to FIGS. 1A-2, 36-48, and 60-63, the male housing assembly 70 includes: (i) an internal arrangement of side walls 72, (ii) an external arrangement of side walls 76, (iii) a projection with a retaining wall surface 90, and (iv) a male terminal retaining means 94. The internal arrangement of side walls 72 includes: (i) a plurality of side walls 73a-73d with contact arm openings 76a-76d, and (ii) a front wall 74. Said plurality of side walls 73a-73d and the front wall 74 are integrally formed with one another and are arranged to define a terminal receiver 75. The terminal receiver 75 is configured to receive the male terminal assembly 100 in the fully coupled state, S_{FC}. In this fully coupled state, S_{FC}: (i) the contact arm openings 76a-76d receive an extent of the contact arms 180a-180d to enable a mechanical and electrical connection between said contact arms and the female terminal body 710, and (ii) the frontal segment 430 of the jacket 400 is positioned adjacent to an inner surface of the front wall 74 of the housing 70. In other words, when the connector assembly 50 is in the fully coupled state, S_{FC}, an extent of the contact arms 180a-180d extend through the contact arm openings 76a-76d.

The external arrangement of side walls 76 includes: (i) two opposed side walls 78a, 78b with a plurality of projections 80 and recesses 82, (ii) a curvilinear bottom wall 78c that extends between the opposed side walls 78a, 78b, and (iii) a deformable top wall 78d with a female receiver opening 84 formed therethrough. Each of the walls 78a-78d are spaced a housing distance D_{H} away (shown in FIG. 46) from the external surfaces of the internal arrangement of side walls 72. When the system 10 is in the connected state S_{C} (shown in FIG. 61): (i) said housing distance D_{H} is occupied by an extent of the female connector assembly 650 and more specifically an extent of the female housing assembly 670, (ii) the recesses 82 receive projections 697 formed in the side walls 672 of the female housing assembly 670, (iii) the projections 80 are positioned within recesses 698 formed in the side walls 672 of the female housing assembly 670, and (iv) the female receiver opening 84 receives the coupling projection 699.

Rearward of wall plane P_{W} (shown in FIG. 43), the internal arrangement of side walls 72 and the external arrangement of side walls 80 merger into a single structure, namely-a connector arrangement of side walls 86. Said connector arrangement of side walls 86 is designed to surround a rearward extent of the male terminal assembly 100 and the wire coupled to the male terminal assembly 100. The male terminal retaining means 94 and the retaining wall surfaces 90 are positioned rearward of the wall plane P_{W} and configured to secure the male terminal assembly 100 within the housing 70. The retaining wall surfaces 90 are formed from projections that extent inward from an inner surface of the connector arrangement of side walls 86. Additionally, the male terminal retaining means 94 includes: (i) a retaining body 96, and (ii) a retaining opening 95 formed in the first extent of the connector arrangement of side walls 86. The retaining body 96 is a U-shaped structure designed to be positioned adjacent to the first extent of the connector arrangement of side walls 86 and includes securing projections 97a, 97b, and retaining projections 98a, 98b. The securing projections 97a, 97b are positioned near the ends of the legs that form the U-shaped structure, while the retaining projections 98a, 98b extend from the upper crossing member that extends between the legs of the U-shaped structure.

When the connector assembly 50 is in the fully coupled state, S_{FC}: (i) the locking tabs 426 of the jacket 400 are positioned forward of the retaining wall surfaces 90, (ii) the retaining body 96 is positioned adjacent a first extent of the connector arrangement of side walls 86, and the securing projections 97a, 97b are positioned below an opposed second extent of the connector arrangement of side walls 86, and (iii) the retaining projections 98a, 98b extend into the retaining opening 95, and are positioned rearward of the male terminal body 104. This configuration of structures helps prevent rearward movement of the male terminal assembly 100, while securing the male terminal assembly in the housing 70. In fact, this combination ensures a force that is less than 200 Newtons will not dislodge the male terminal assembly 100 from the housing 70. The combination of the recesses 698, 82, projections 80, 697 forms a system 10 with keyed configuration, wherein the male connector assembly 50 can only mate with the female connector assembly 650 when the male connector assembly 50 is in a specific orientation relative to the female connector assembly 650.

The male housing assembly 70 is formed from a non-conductive plastic and is designed to protect and isolate the conductive male terminal assembly 100 from accidental contact with foreign objects. In other embodiments, the male terminal retaining means 94 may be replaced with any structure that would perform a similar function and is disclosed in any application incorporated herein by reference. Some of these structures may include other types of mechanical/structural members or bodies that generate a biasing force on the male terminal assembly 100, magnets, springs, or other types of retaining means. In further embodiments, the housing 70 may include: (i) a connector position assurance (CPA) assembly that includes a readable or scannable indicia, which meets USCAR Specifications, including USCAR-12, USCAR-25, and USCAR-2, (ii) an EMI shield, (iii) additional layers of non-conductive and/or conductive materials, and/or (iv) a larger footprint (e.g., charge coupler 2) to accept multiple male terminal assemblies 50. Other similar male housing assemblies are disclosed in applications incorporated herein by reference, and features of these housing assemblies may be incorporated into the male housing assembly 70 of the male connector assembly 50 disclosed herein.

b. Male Terminal Assembly

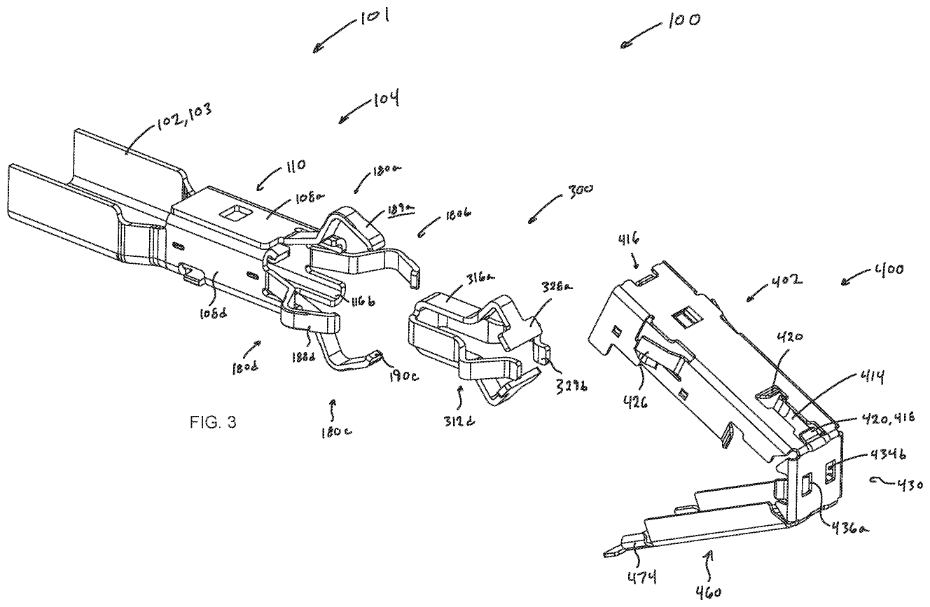

FIGS. 3-51 and 58-63 provide various views of the male terminal assembly 100. Referring to the first embodiment, the male terminal assembly 100 includes the male terminal 101, spring member 300, and jacket 400. In addition to these major structural components 101, 300, 400, the male terminal assembly 100 also includes means for limiting compression 314. As discussed below, said means for limiting compression 314 may be formed from interactions between the major structural components 101, 300, 400 or may be contained within a single component 101, 300, 400.

i. Means for Limiting Compression

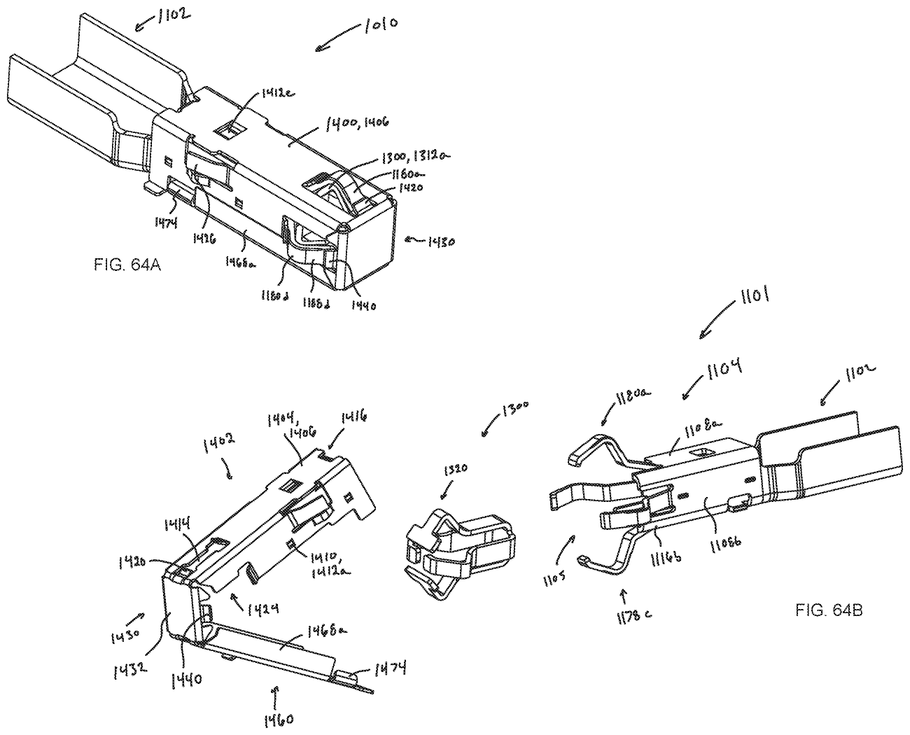

Unlike conventional male terminal assemblies, the male terminal assembly 100 disclosed herein includes the means for limiting compression 314. Said means for limiting compression 314 is designed to prevent an external force F_{E} from excessively deforming or overly depressing the contact arms 180a-180d and the spring arm 316a-316d toward the center of the connector 50. Prevention of excessive deformation or depression of the contact arm 180a-180d and the spring arm 312-312d is desirable because said deformation or depression can damage the contact arm 180a-180d, the spring member 312a-312d, or a combination of the contact arm 180a-180d and the spring member 312a-312d to a point that the terminal assembly 100 becomes damaged, inoperable and/or unusable. Thus, said means for limiting compression 314 reduces this potential failure mode of the terminal assembly 100. While reducing this potential failure mode is beneficial, it should be understood that means for limiting compression 314 should not interfere with normal or operational deformation D_{NC} (see FIG. 63) of the contact arm 180a-180d and the spring member 312a-312d. In this embodiment, the means for limiting compression 314 includes two separate combinations of limiting structures 315a, 315b, wherein the first combination of limiting structures 315a protects spring arms 312a, 312c and contact arms 180a, 180c and the second combination of limiting structures 315b protect spring arms 312b, 312d and contact arms 180b, 180d. Each of these limiting structures 315a, 315b will be discussed in great detail below.

ii. Male Terminal

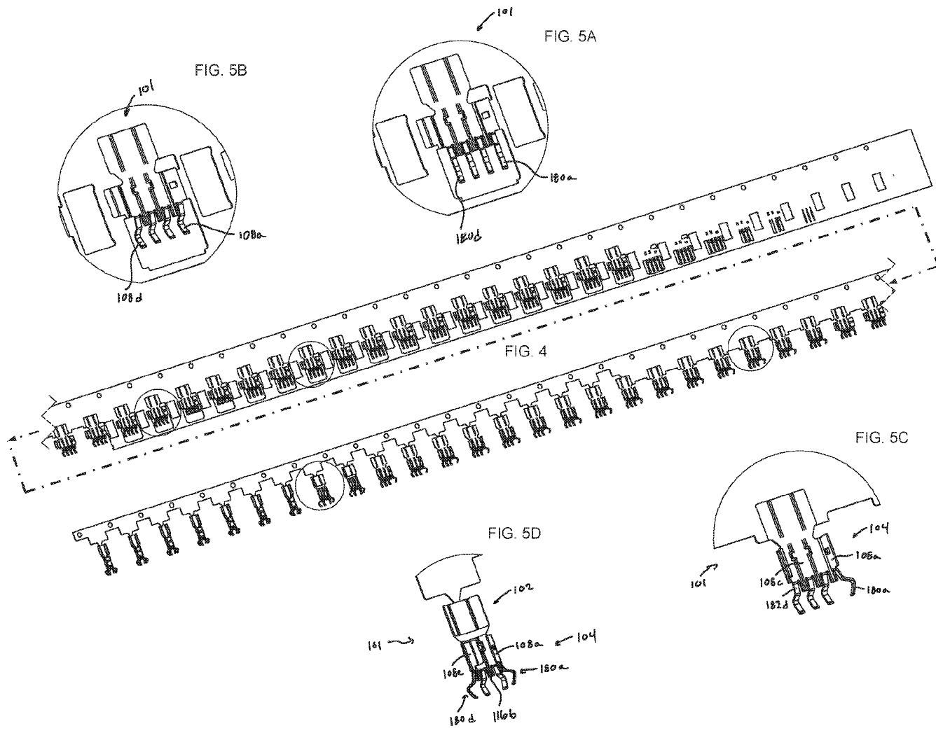

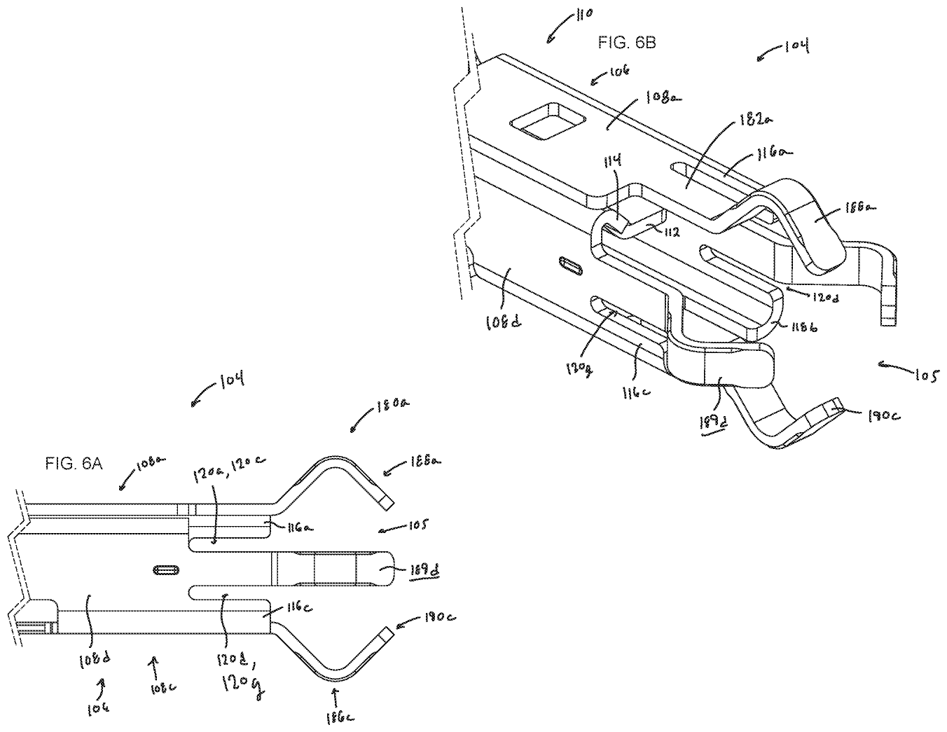

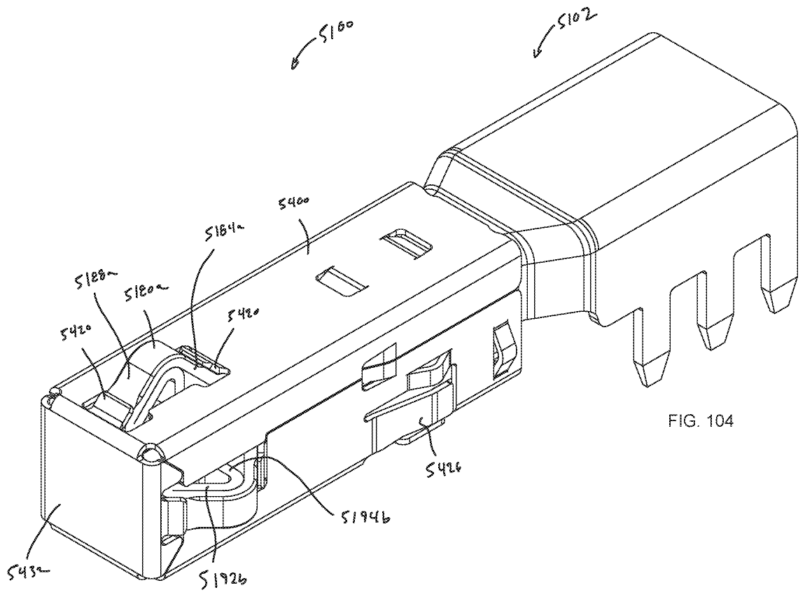

In particular, FIGS. 6A-10, 25-51, and 58-63 show the male terminal 101 in a ready to use position P_{U}, while FIGS. 3 and 16-17 show the male terminal in the ready to receive position P_{R}. FIGS. 4 and 5A-5D illustrate the steps that may be undertaken to form the male terminal 101 from a blank piece of metal (e.g., copper). In particular, this process may include a plurality (e.g., 53) steps of cutting and/or bending the metal blank. Once these steps have been performed, the male terminal 101 will be formed to include the below-described structures. These structures include a male terminal connection member 102 and a male terminal body 104. Specifically, the male terminal connection member 102 is coupled to the male terminal body 104. In this embodiment, the male terminal connection member 102 is a wire receiver 103, wherein said wire receiver 103 has a U-shaped receptacle that is configured to receive an extent of an external structure (e.g., lead or wire) that connects the male terminal assembly 100 to a device (e.g., an alternator) external to the connector system 10. A wire is typically welded to the wire receiver 103; however, other methods (e.g., forming the wire as a part of the wire receiver 103) of connecting the wire to the wire receiver 103 are contemplated by this disclosure. In other embodiments, the male terminal connection member 102 may be a blade, a crimp, a circuit board connector (see FIG. 104), or any other type of connection member 102 that mechanically and electrically couples the male terminal body 104 to an external device, part, or extent.

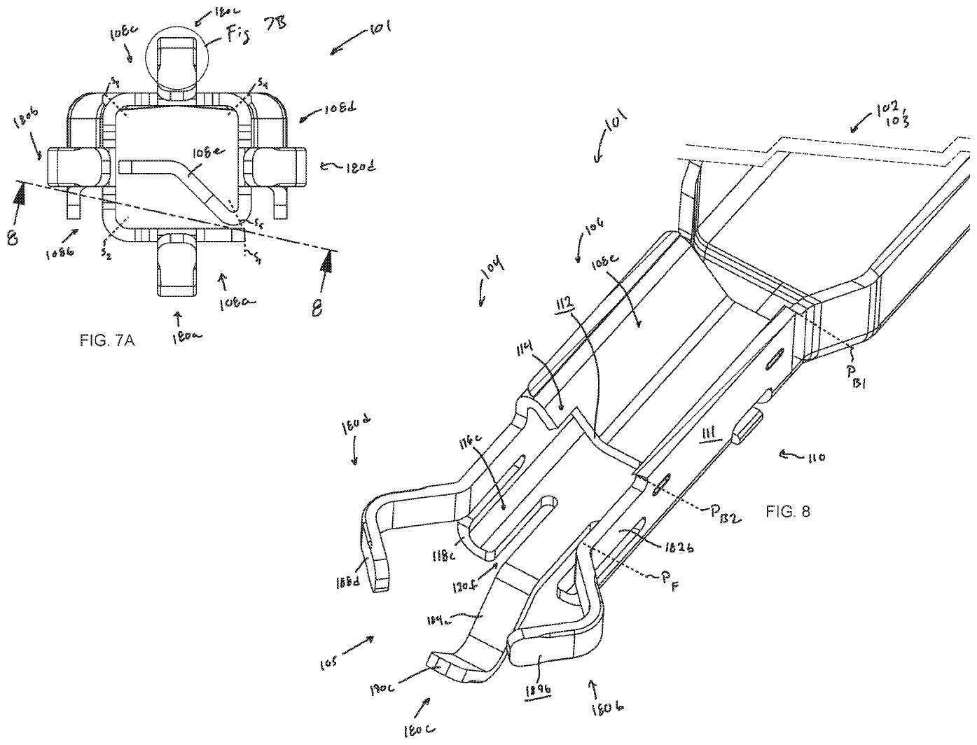

FIGS. 3-10 show that the male terminal body 104 includes a wall arrangement 106. Said side wall arrangement 106 is comprised of the following integrally formed walls that include: (i) a top wall 108a that extends between S₁ and S₂, (ii) a first side wall 108b that extends between S₂ and S₃, (iii) a bottom wall 108c that extends between S₃ and S₄, (iii) a second side wall 108d that extends between S₄ and S₅ and (iv) an interior spring wall 108e that extends between S₅ and S₆ (see FIG. 7A). The combination of the side walls 108b, 108d, top wall 108a, and bottom wall 108c form a cuboidal shaped base or intermediate portion 110 that extends between a first base plane P_{B1} and a second base plane P_{B2}, which is preferably has a rectanguloid configuration. As best shown in FIG. 7A, base or intermediate portion 110 does not have a continuous perimeter. In other words, the top wall 108a is not directly connected to either the second side wall 108d or the interior spring wall 108e. Additionally, the interior spring wall 108e is not directly connected to another wall 108a-108c. But for the inclusion of the jacket 400, the male terminal 101 configuration could allow the male terminal 101 to expand during operation or use of the system 10. Nevertheless, said possible expansion of the male terminal 101 may be mitigated in other embodiments by forming the base or intermediate portion 101 with a continuous perimeter, by directly connecting the top wall 108a to either the second side wall 108d or the interior spring wall 108e, or directly connecting the interior spring wall 108e to another wall 108a-108c.

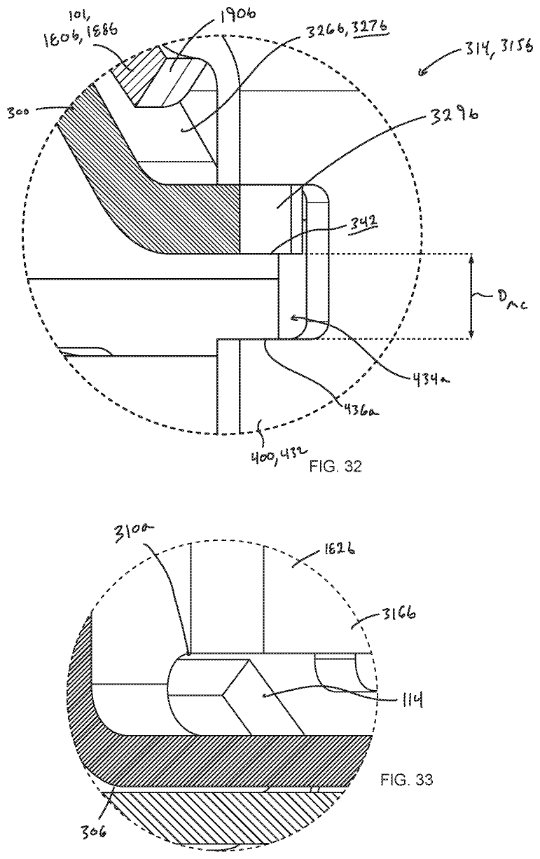

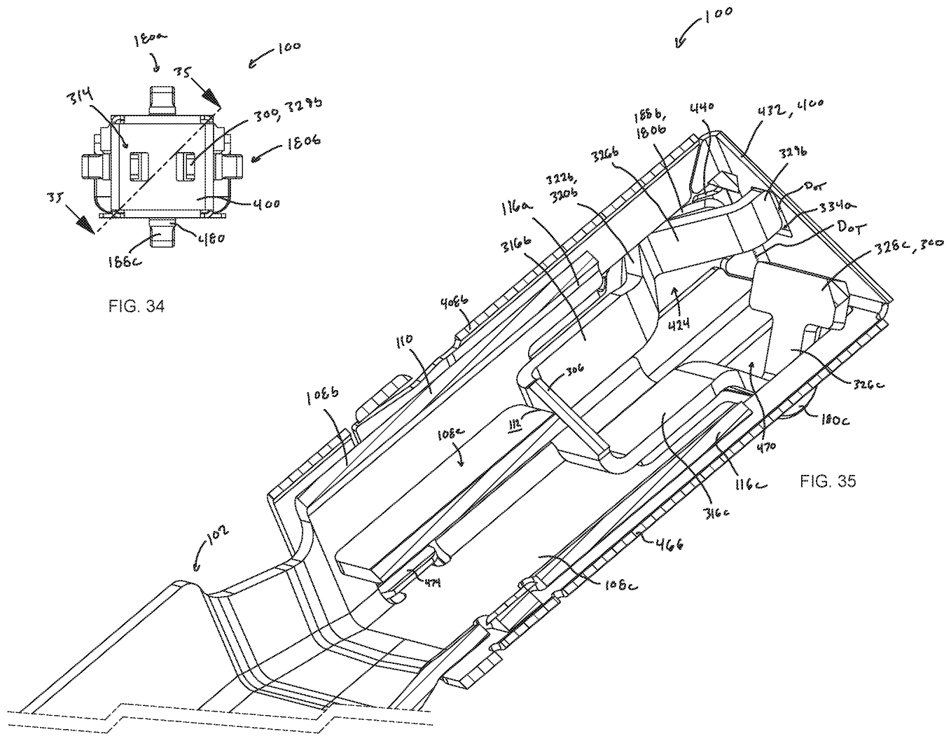

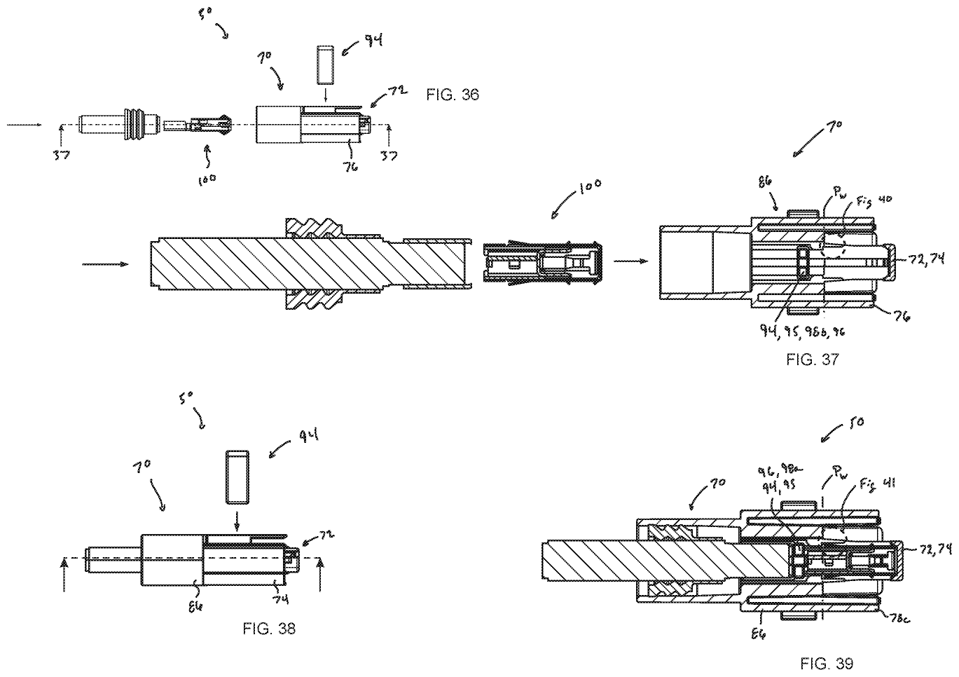

The above described interior spring wall 108e is positioned within said base or intermediate portion 110 and includes a frontal surface 112 configured to be positioned adjacent to a rear surface of the spring member 300 (when the spring member is positioned within the male terminal body 104). The frontal surface 112 of the interior spring wall 108e is not co-planar but has a staggered configuration. In other words, the interior spring wall 108e includes a recess that forms an anti-rotation projection 114. As best shown in FIGS. 31, 33, said anti-rotation projection 114 is configured to be positioned within an anti-rotation recess or spring arm gap 310a formed in the spring member 300, when the spring member 300 is positioned in the male terminal body 104 (which occurs when the spring member 300 is positioned in the male terminal 101 are in at least the first partially assembled state, S_{1PA}). It should be understood that the combination of the anti-rotation projection 114 and the anti-rotation recess 310a may be replaced with a different structure or combination of structures designed to prevent the spring member 300 from rotating within the male terminal 101 or these structures may be omitted in their entirety. It should also be understood that the interior spring wall 108e may be replaced with a different structure or combination of structures that are designed to ensure that the spring member 300 is properly placed (e.g., not forced rearward) within the male terminal 101 or this structure may be omitted in its entirety.

The side walls 108b, 108d, top wall 108a, and bottom wall 108c each include the following structure/anti-structures that extend forward from the second base plane P_{B2}: (i) at least one contact arm 180a-180d with two primary portions 182a-182d and 178a-178d, and preferably a plurality of contact arms 180a-180d, (ii) supporting ribs 116a-116c, and (iii) contact arm gaps or voids 120a-120g that are positioned between either the contact arms 180a-180d and the adjacent supporting rib 116a-116c or adjacent contact arms 180a, 180d, wherein the supporting ribs 116a-c have an overall length that is less than an overall length of the contact arms 180a-d. This configuration creates multiple structure/anti-structures within the side walls 108b, 108d, top wall 108a, and bottom wall 108c, wherein said structure/anti-structures may include seven distinct structure/anti-structures integrally formed (i.e., not separate) with one another. For example, the bottom wall 108c includes: (i) a geometric bent or creased portion 178c, (ii) a first, rear, or linear extent 182c of a contact arm 180c, (iii) a portion of a second supporting rib 116b, (iv) a portion of a third supporting rib 116c, (v) a fourth contact arm gap or void 120d, (vi) a fifth contact arm gap or void 120e, and (vii) an extent of the base or intermediate portion 110.

The contact arm voids 120a-120g are formed in the walls 108a-108d and delineate the contact arms 180a-180d and the supporting ribs 116a-116c. For example, the second contact arm void 120b is positioned between the first supporting rib 116a and the second contact arm 180b, while the third contact arm void 120c is positioned between the second contact arm 180b and the second supporting rib 116b. The male terminal body 104 only includes three supporting ribs 116-116c. In other words, the male terminal body 104 lacks a supporting rib positioned adjacent to the top wall 108a and the second side wall 108d. Said body 104 lacks this supporting rib due to the configuration/formation of the interior spring wall 108e. The supporting ribs 116a-116c include three segments, which include a first linear segment, a curvilinear segment, and a second linear segment. The first and second linear segments are substantially co-planar with the associated wall 108a-108d. This configuration allows the supporting ribs 116a-116c to be extend around the corners of the male terminal body 104.

Said supporting ribs 116a-116c extend from base portion 100 (second base plane P_{B2}), along the first or rear extent 182a-182d of a contact arm 180a-180d, but do not extend along the geometric bent or creased portion 178c of the contact arms 180a-180d. In other words, the distal ends 118a-118c of the supporting ribs 116a-116c are not positioned forward of a bend plane P_{B} corresponding to the bend portion 178c. As shown in the Figures, the distal ends 118a-118c of the supporting ribs 116a-116c are not connected to one another or any other structures. Accordingly, the length of said supporting ribs 116a-116c has been determined by balancing: (i) too long they will not provide adequate support to the contact arms 180a-180d and/or jacket 400 at or near the distal ends 118a-118c of the supporting ribs 116a-116c, and (ii) too short they will not provide adequate support to the contact arms 180a-180d and/or jacket 400. Nevertheless, in other embodiment, the supporting ribs 116a-116c may be lengthened to extend along the entire contact arm 180a-180d, shortened to only extend along a portion of the first or rear extent 182a-182d of a contact arm 180a-180d, an additional supporting rib may be added between contact arms 180c and 180d, or omitted in their entirety.

As best shown in FIGS. 6A-10, the contact arms 180a-180d are formed in the peripheral walls 108a-108d and extend from the base or intermediate portion 110 of the male terminal body 104. As shown in the figures, multiple contact arms 180a-180d are not formed in a single wall 108a-108d. In other words, there is a one-to-one relationship between the number of peripheral walls 108a-108d and the number of contact arms 180a-180d. This one-to-one spacing allows the contact arms 180a-180d to be spaced apart from one another along the perimeter of said base portion 110 to help ensure that other structures of the male terminal assembly 100 do not interfere with one another during the use or operation of the system 10. Nevertheless, in other embodiments, each of the walls 108a-108d may include multiple (e.g., 2 to 50) contact arms 180a-180d. As discussed above, supporting ribs 116a-116c are positioned in the spaces between a majority of the contact arms 180a-180c. The combination of the supporting ribs 116a-116c and the contact arms 180a-180c form a spring receiver 105, which is configured to receive the spring member 300 in at least the first partially assembled state, S_{1PA}.

Referring specifically FIGS. 6A, 8 and 10, the contact arms 180a-180d have an initial or rear extent 182a-182d that extends from the base or intermediate portion 110 (line C₁) and a geometric bent or creased portion 178a-178d. Said geometric bent or creased portion 178a-178d includes: (i) a second or upwardly sloping extent 184a-184d that extends between the initial extent 182a-182d (line C₂) and an external contact arm apex 186a-186d of the contact arm 180a-180d (line C₃), and (ii) a third or downwardly sloping extent 188a-188d that extends downward from the external apex 186a-186d (line C₃) to a forward-most extent that provides a free end 190a-190d. The geometric bent or creased portion 178a-178d of the contact arms 180a-180d is beneficial over contact arm designs shown in FIGS. 69-96 of PCT/US2019/036010 because its design helps reduce: (i) insertion forces due to the ramped contact arm design (in contrast to the circular contact arm design), and (ii) potential bending or stubbing of contact arms 180a-180d, when the insertion of the male terminal assembly 100 is not directly in line with the female terminal assembly 700.

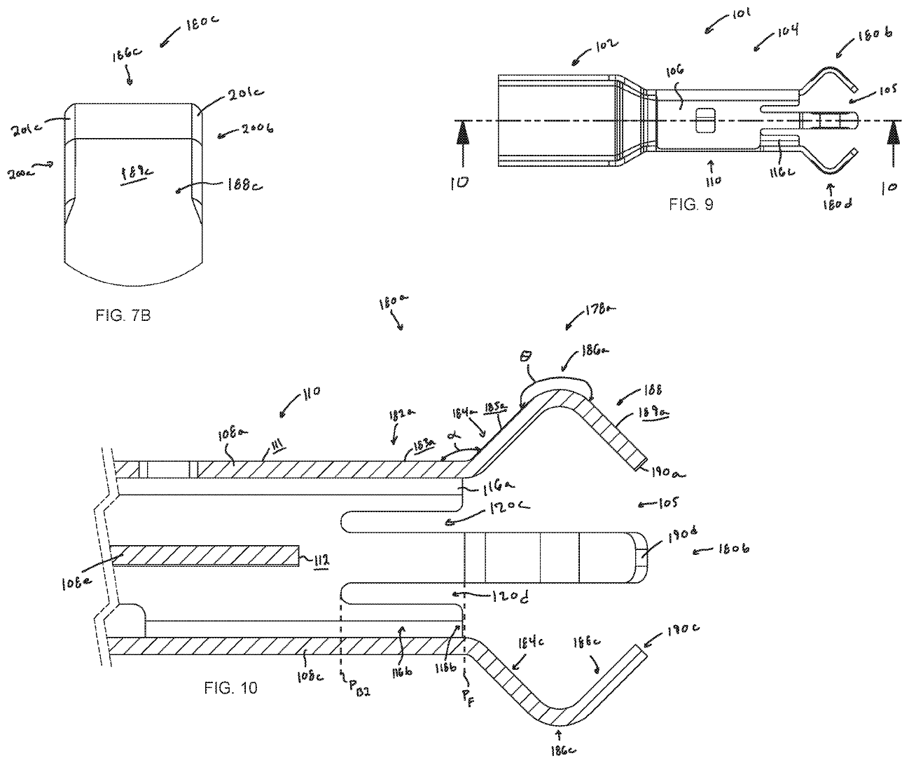

Unlike conventional connectors, the disclosed contact arms 180a-180d have an elongated first or rear extent 182a-182d that does not extend away from the base portion 110 at a uniform outward sloping angle or substantially uniform outward sloping angle. In other words and as best shown in FIGS. 6A and 10, an outer surface 183a-183d of the first or rear extent 182a-182d of each contact arm 180a-180d are: (i) substantially parallel with one another, and (ii) substantially aligned with the outer surface 111 of the corresponding extent of the base portion 110. Compared to conventional connectors that lack this elongated first or rear extent 182a-182d, less force is required to deform or displace the contact arm 180a-180d inward or toward the center of the male terminal 101. This reduced force allows for an increase in the force required to inwardly displace an extent of the spring member 300. Shifting the structure that resists the inward displacement from the contact arm 180a-180d to the spring arm 312a-312d is beneficial because changes to the insertion force F₁ can be easily made by changing the design and/or material composition of the spring member 300 and not redesigning the terminal body 104. For example, the designer can insert a stiffer spring member 300 to maintain/maximize the current carrying capacity of the system 10. Or if there are specific customer requirements setting forth a target insertion force F₁, the designer can select a spring member 300 that meets these requirements without having to undertake a costly and time-consuming redesign of the male terminal body 104. This modularity and flexibility of the connector system 10 is a substantial improvement over the prior art, as reduces the number of product SKUs, increases the ability to meet customer requirements without retooling or redesigning the connector, and/or limits testing and other steps that would be required to utilize new/different connectors. It should be understood that the length of the first or rear extent 182a-182d will substantially alter the insertion force F₁ required to insert the male terminal assembly 100 into the female terminal assembly 700. Also, in other embodiments, the contact arms 180a-180d may extend away from the base 110 at a uniform inwardly angle or substantially uniform inwardly sloping angle. Said inwardly sloping angle allows the male terminal assembly 100 to have an inwardly tapered design or configuration. In this alternative embodiment, the inwardly tapered design or configuration may be configured such that the outer diameter at line C₂ may be between 0.01% and 5% less than the outer diameter at line C₁.

As shown in FIG. 10, the second or upwardly sloping extent 184a-184d is positioned at an outward angle alpha a from the lateral first or rear extent 182a-182d, wherein said angle alpha a extends between an outer surface 183a-183d of the first or rear extent 182a-182d of the contact arm 180a-180d and an outer surface 185a-185d of the second or upwardly sloping extent 184a-184d of the contact arm 180a-180d. The outward angle alpha a is between 115 and 170 degrees, and preferably between 125 and 145 degrees. Forward of the second or upwardly sloping extent 184a-184d, the contact arm 180a-180d has a third or downwardly sloping extent 188a-188d that extends downward from the exterior apex 186a-186d to the free end 190a-190d. An exterior angle theta θ is defined between the outer surface 185a-185d of the second or upwardly sloping extent 184a-184d and the outer or contact surface 189a-189d of the third or downwardly sloping extent 188a-188d. The exterior angle theta θ is between 240 and 300 degrees, and preferably between 255 and 285 degrees. Similar to the prior discussion, the other terminals, whose disclosure is incorporated herein, lack this configuration of the sharp upwardly angled segment and the sharp downwardly angled segment.

As discussed in greater detail below, the third or downwardly sloping extent 188a-188d, and specifically the contact surface 189a-189d, is configured to contact an extent of the female connector assembly 650 when the male terminal assembly 100 is inserted into the female terminal assembly 700. This interaction between these components causes the contact arms 180a-180d to be deflected or displaced inward and towards the center of the male terminal assembly 100 and the spring member 700. This inward deflection of the contact arms 180a-180d causes the spring member 700 to act as a wedge to help ensure that a proper mechanical and electrical connection is created between the contact arms 180a-180d and the female receptacle 702.

As shown in FIGS. 7B, at least a portion of the outer edges or shoulder regions 200a, 200b of the contact arms 180a-180d are coined, beveled, or rounded 201a, 201b. The coined, beveled or rounded section 201a, 201b of the outer edges 200a-200b may: (i) extend along the entire length of the contact arm 180a-180d, (ii) extend along the entire length of the second and third extends 184a-184d, 188a-188d of the contact arms 180a-180d, (iii) extend along a portion (e.g., half of the length) of the second extent 184a-184d of the contact arms 180a-180d and a portion (e.g., half of the length) of the third extent 188a-188d of the contact arms 180a-180d. Without forming the coining, beveling, or rounding section 201a, 201b, the edges 200a, 200b of the contact arms 180a-180d may make contact with the inner surface 704 of the female terminal assembly 700 and could prevent the center of the contact arm 180a-180d from making sufficient contact with said female terminal assembly 700 due to the linear vs. curvilinear configurations of the contact arms 180a-180d and female terminal assembly 700. Preventing the center of the contact arm 180a-180d from making proper contact with said female terminal assembly 700 will likely reduce the current carrying capacity of the system 10. Additionally, omission of the coining, beveling, or rounding section 201a, 201b could leave sharp edges on the contact arms 180a-180d, which may cause the contact arms 180a-180d to score or mark the inner surface 704 of the female terminal assembly 700. Said scoring can reduce the number of mating cycles the system 10 can achieve without failure because the scoring can scrape off or damage the internal plating and/or surface 704 of the female terminal assembly 700. In other embodiments, the outer edges or shoulder regions 200a, 200b of the contact arms 180a-180d may not be coined, beveled, or rounded; instead, the contact arms 180a-180d may be bent or material may be deposited on said contact arms 180a-180d to allow the outer surface of said contact arms 180a-180d to substantially match the curvature of the inner surface 704 of the female terminal assembly 700.

As shown in FIGS. 6A-10, the contact arms 180a-180d are only connected to the base portion 110 of the male terminal body 104. This free-end configuration of the contact arms 180a-180d allows for omnidirectional expansion of said contact arms 180a-180d. Because there is a contact arm opening or void 120a-120g interspersed between each pair of contact arms 180a-180d, no supporting wall surrounds the entirety of the contact arms 180a-180d. This configuration of the male terminal assembly 100 is substantially different than the configuration disclosed in connection with the male terminal assembly of PCT/US2019/36010. As discussed in PCT/US2019/36010, the removal of the side wall arrangement that surrounds the contact arms 180a-180d could increase the failure rate of the male terminal assembly 100 because the side wall arrangement protects said contact arms 180a-180d. However, this increased failure rate is mitigated by the inclusion of the jacket 400.

The male terminal 101 is typically formed from a single piece of material (e.g., metal); thus, the male terminal 101 is a one-piece male terminal 101 and has integrally formed features. To integrally form these features, the male terminal 101 is typically formed using a die-cutting process. However, it should be understood that other types of forming the male terminal 101 may be utilized, such as casting or using an additive manufacturing process (e.g., 3D printing). In other embodiments, the features of the male terminal 101 may not be formed from a one-piece or be integrally formed, but instead formed from separate pieces that are welded together. In forming the male terminal 101, it should be understood that any number (e.g., between 1 and 100) of contact arms 180a-180d may be formed within the male terminal 101. The male terminal 101, male terminal body 104, the contact arms 180a-180d, or an extent of the contact arms 180a-180d may be plated or coated with a secondary material (e.g., nickel) to help reduce corrosion, reduce insertion forces, or improve conductivity. Additionally, the contact arms 180a-180d or a portion of the contact arms 180a-180d may have rounded or beveled edges.

iii. Spring Member

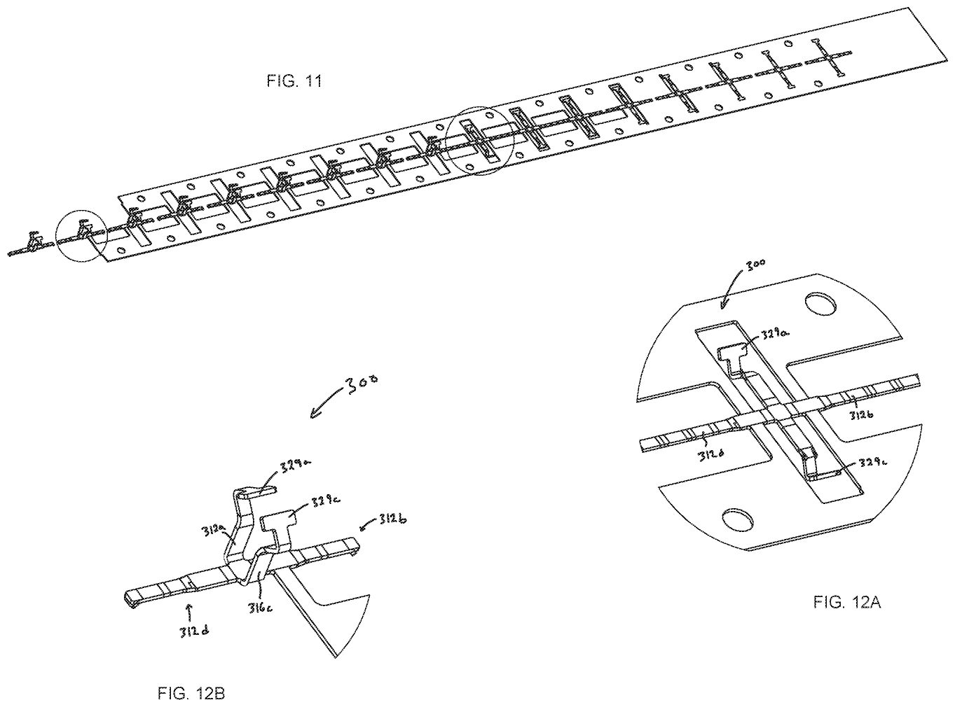

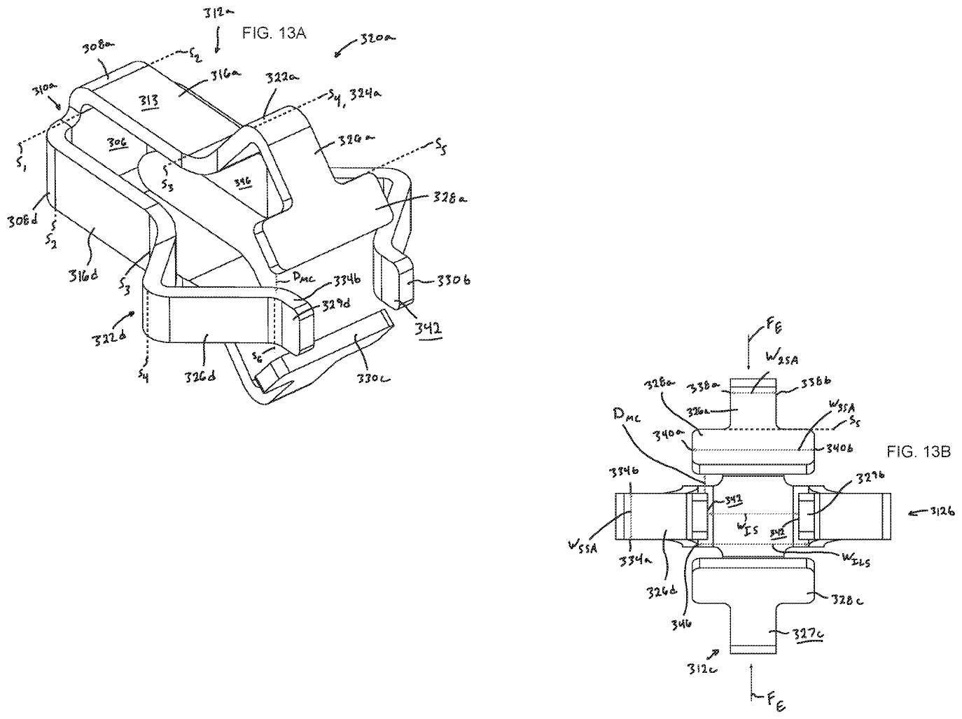

FIGS. 11 and 12A-12B illustrate the steps that may be undertaken to form the spring member 300 from a blank piece of metal (e.g., spring steel, stainless steel). In particular, this process may include a plurality of (e.g., 17) steps of cutting and/or bending of the metal blank. Once these steps have been performed, the spring member 300 will be formed to include an arrangement of spring member side walls 304a-304d and a rear spring wall 306. Each spring member side wall 304a-304d is comprised of: (i) a first or curvilinear spring section 308a-308d that extends from the rear wall 306 (line S₁) to an initial or linear base extent 316a-316d (line S₂), and (ii) a spring arm 312a-312d that extends forward from the first or curvilinear spring section 308a-308d (line S₂) to free ends 330a-330d. The spring arms 312a-312d extend from the first or curvilinear spring section 308a-308d of the spring member 300, away from the rear spring wall 306, and terminate at a frontal end or free-end 330a-330d. The spring arms 312a-312d are not connected to one another and are separated by spring arm gaps 310a-310d. As such, the spring arm gaps 310a-310d are interspersed between the spring arms 312a-312d. The spring arm gaps 310a-310d aid in omnidirectional expansion or contraction of the spring arms 312a-312d, which facilitates the mechanical coupling between the male terminal 101 and the female terminal assembly 700.

Unlike conventional spring members, the spring member 300 disclosed herein includes a spring arm 312a-312d with a geometry that substantially matches the geometry of the associated contact arm 180a-180d. In other words, the spring arms 312a-312d include a geometric bent or creased portions 320a-320d that substantially matches the geometric bent or creased portions 178a-178d of the contact arms 180a-180d. In addition to the geometric bent or creased portions 320a-320d, the spring member 300 is unique due to its inclusion of: (i) a first pair or primary pair of spring arms, which include the top, primary, or first spring arm 312a and the bottom or third spring arm 312c, (ii) a second pair or secondary pair of spring arms, which include the first side spring arm, secondary spring arm, or second spring arm 312b and a second side spring arm or fourth spring arm 312d. The geometry of the top and bottom spring arms 312a, 312c substantially mirror one another, and the geometry of the first side and second side spring arms 312b, 312d substantially mirror one another. Additionally, the geometry of the spring arms contained in the first pair of spring arms (top and bottom spring arms 312a, 312c) does not match the geometry of the spring arms contained in the second pair of spring arms (side spring arms 312b, 312d).

The top and bottom spring arms 312a, 312c include: (i) the initial or linear base extent 316a, 316c that extends from the first or curvilinear spring section 308a, 308c (line S₂) to a second or upwardly sloping extent 322a, 322c (line S₃), and (ii) a geometric bent or creased portion 320a, 320c extends forward from the initial or linear extent 316a, 316c (line S₃). Said geometric bent or creased portion 320a, 320c includes: (i) the second or upwardly sloping extent 322a, 322c that extends between the initial extent 316a, 316c (line S₃) and an exterior apex 324a, 324c (line S₄) of the spring arm 312a, 312c, (ii) a third or downwardly sloping extent 326a, 326c that extends downward from an external apex 324a, 324c (line S₄) to an over-compression extent 328a, 328c (line S₅), and (iii) the over-compression extent 328a, 328c extending between the third or downwardly sloping extent 326a, 326c (line S₅) and a forward-most extent that provides a frontal end 330a, 330c. The geometric bent or creased portion 320a, 320c of the spring arms 312a, 312c is configured to complement the geometric bent or creased portion 178a, 178c of the contact arm 180a, 180c.

As shown in FIGS. 13A-15, the top and bottom spring arms 312a, 312c have: (i) a first spring arm width W_{1SA} that extends between linear extent edges 336a, 336b, (ii) a transition spring arm width, (iii) a second spring arm width W_{2SA} that extends between contact surface edges 338a, 338b, and (iv) an over-compression or third spring arm width W_{3SA} that extends between over-compression edges 340a, 340b. The curvilinear spring sections 308a, 308c and linear extents 316a, 316c of the spring member 300 have the first spring arm width W_{1SA}, the downwardly sloping extents 326a, 326c of the spring member 300 have the second spring arm width W_{2SA}, and the over-compression extents 328a, 328c have the third spring arm width W_{3SA}. The upwardly sloping extents 322a, 322c of the spring member 300 have a transition width, which changes from the first spring arm width W_{1SA} to the second spring arm width W_{2SA} when moving from line S₃ to line S₄.

This configuration allows a majority of creased portion 320a, 320c to have a width that substantially match the width of the creased portion 178a, 178c. Matching the widths of the spring arm 312a, 312c and contact arms 180a, 180c at the point the male terminal assembly 100 is configured to contact the female terminal assembly 700 is beneficial because it limits the width required for contact arm openings 414, 470 that are formed in the jacket 400 and male terminal housing 70. Additionally, including additional material to the spring member 300 in a location that is substantially rearward of the creased portion 178a, 178c of the contact arms 180a, 180c allows the designer to increase the force required to deform the spring arms 312a, 312c in comparison to a spring member that lacked this additional material. Nevertheless, it should be understood that in other embodiments, the width of the spring arms 312a, 312c may be constant along the entire length of the arm 312a, 312c, have only two different widths, or may have more than the disclosed number of widths.

The side spring arms 312b, 312d include: (i) the initial or linear extent 316b 316d that extends from the first or curvilinear spring section 308b, 308d (line S₂) to a second or upwardly sloping extent 322b, 322d (line S₃), and (ii) a geometric bent or creased portion 320b, 320d extends forward from the initial or linear extent 316b, 316d (line S₃). Said geometric bent or creased portion 320b, 320d includes: (i) the second or upwardly sloping extent 322b, 322d that extends between the initial extent 316b, 316d (line S₃) and an exterior apex 324b, 324d (line S₄) of the spring arm 312b, 312d, (ii) a third or downwardly sloping extent 326b, 326d that extends downward from an external apex 324b, 324d (line S₄) to a fourth extent, jacket extent, or jacket projection extent 329b, 329d (line S₆), and (iii) the jacket extent 329b, 329d extending forward from the third or downwardly sloping extent 326b, 326d (line S₆) to a free-end 330b, 330d. The geometric bent or creased portion 320b, 320d of the spring arms 312b, 312d is configured to complement the geometric bent or creased portion 178b, 178d of the contact arm 180b, 180d.

As shown in FIGS. 13A-15, the side spring arms 312b, 312d have: (i) a fourth spring arm width W_{4SA} that extends between linear extent edges 332a, 322b, (ii) a transition spring arm width, and (iii) a fifth spring arm width W_{5SA} that extends between forward spring arm edges 334a, 324b. The curvilinear spring sections 308b, 308d and linear extents 316b, 316d of the spring member 300 have the fourth spring arm width W_{4SA}, while the downwardly sloping extents 326b, 326d and jacket extents 329b, 329d of the spring member 300 have the fifth spring arm width W_{5SA}. The upwardly sloping extents 322b, 322d of the spring member 300 have a transition width, which changes from the fourth spring arm width W_{4SA} to the fifth spring arm width W_{5SA} when moving from line S₃ to line S₄. This configuration is beneficial for the same reasons discussed above in connection with the top and bottom spring arms 312a, 312c.

Unlike conventional spring, the disclosed spring member includes spring arms 312a-312d with three unique or different widths. In this embodiment, the spring member 300 includes two spring arms 312a, 312b, wherein the width of one spring arm 312a increases, between two points (e.g., 336a-336b, 340a-340b), along its length and the width of the second spring arm 312b decreases, between two points (e.g., 332a-332b, 334a-334b), along its length. Additionally, the spring member 300 has: (i) the first and fourth spring arm widths W_{1SA}. W_{4SA} are equal, (ii) second and fifth spring arm widths W_{2SA}, W_{5SA} are equal, (iii) the first and fourth spring arm widths W_{1SA}, W_{4SA} are larger than the second and fifth spring arm widths W_{2SA}, W_{5SA}, and (iii) the third spring arm width W_{3SA} is larger than the first, second, fourth, and fifth spring arm widths W_{1SA}, W_{2SA}, W_{4SA}, W_{5SA}. In other words, the widths of the curvilinear spring sections 308a-308d and linear extents 316a-316d of the spring member 300 are substantially equal, the widths of the downwardly sloping extents 326a-326d are substantially equal, and the widths of the over-compression extents 328a, 328c is not equal (i.e., greater than) to the jacket extents 329b, 329d.

Unlike conventional spring members, the spring member 300 includes a first portion of the means for limiting compression 314. Said first portion of the means for limiting compression 314 is the first combination of limiting structures 315a, which include: (i) the over-compression extent 328a, 328c, and (ii) edges of the adjacent side spring arms 312b, 312d. The over-compression extent 328a, 328c has opposed flanges that extend outwardly and transversely from the downwardly sloping extent 326a, 326c and that define an over-compression spring arm width W_{3SA} that is larger than other spring arms widths (e.g., first, second, fourth, and fifth). In fact, the over-compression width W_{3SA} is larger than the inner surface width W_{1S} that extends between inner surfaces 342a of the jacket extends 329b, 329d of the side spring arms 312b, 312d. As such, the outer edge 340a, 340b the over-compression extent 328a, 328c are positioned outside or beyond the inner surfaces 342a of the side spring arms 312b, 312d. Additionally, the outer edge 340a, 340b of the over-compression extents 328a, 328c are positioned outside or beyond the inner surfaces 346 of the linear extent 316b, 316d of the side spring arms 312b, 312d. The application of an external force F_{E} on the contact arms 180a, 180c can only deform the contact arms 180a, 180c, to the max compression distance D_{MC} because the frontal end 330a, 330c contacts the forward spring arm edges 334a, 334b of the side spring arms 312b, 312d. In this embodiment the max compression distance D_{MC} is less than 1.25 mm, preferably less than 1.0 mm, and most preferably 0.5 mm. Limiting the extent the contact arms 180a, 180c can be deformed or depressed to the max compression distance D_{MC} prevents the contact arms 180a, 180c, spring arms 312a, 312c, and a combination thereof helps prevent said arms 180a, 180c from being overly deformed or depressed (e.g., a distance that is greater than the max compression distance D_{MC}) toward the center of the connector 50. While said first combination of limiting structures 315a provides this beneficial features, it should be understood that structures 315a are configured in a manner to ensure they do not interfere with normal or operational deformation (see FIG. 63) of the contact arm 312a, 312c and the spring member 312a, 312c. Specifically, the normal or operational deformation distance D_{NC} (see FIG. 63) is at least 5% and preferably 20% less than the max compression distance D_{MC}. As such, said normal or operational deformation distance D_{NC} is less than 1.20 mm, preferably less than 0.95 mm, and most preferably 0.4 mm. In other words, the compression distance that the system 10 fails at a larger distance than the max compression distance D_{MC}, which is larger than the normal or operational deformation distance D_{NC} the system 10 experiences when the system 10 is in the connected state S_{CN}.

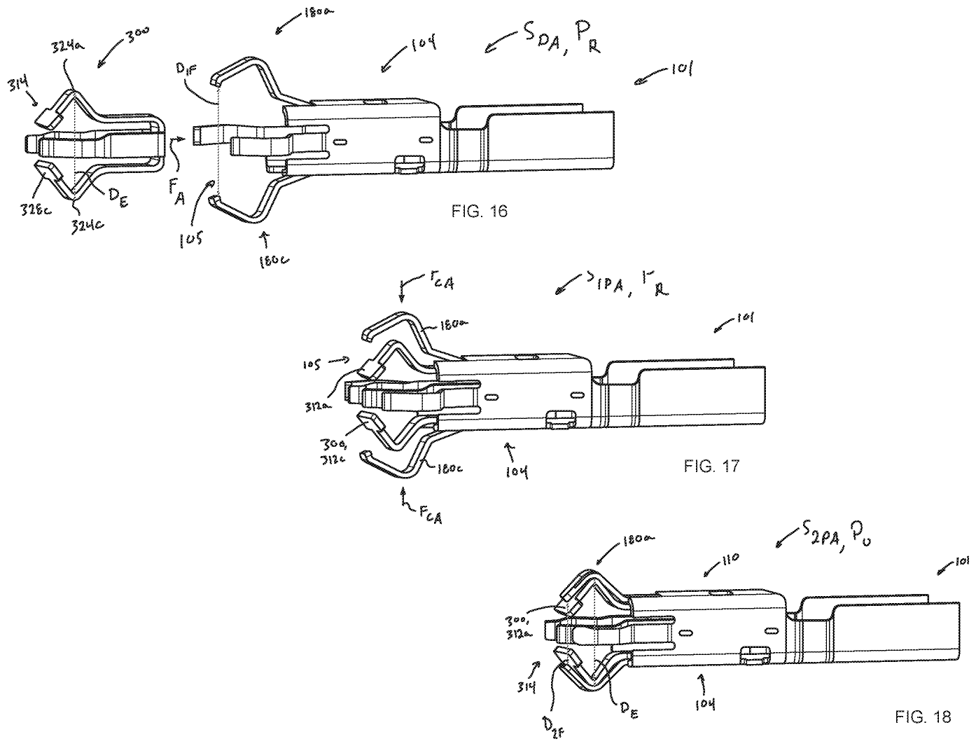

As shown in FIG. 15, the bent spring arm portion 320a includes the second or upwardly sloping extent 322a-322d that extends at an outward angle gamma γ from the lateral first or rear extent 316a-316d, wherein said angle gamma γ specifically extends between an outer surface 313a-313d of the first or rear extent 316a-316d of the spring arm 312a-312d and an outer surface 323a-323d of the second or upwardly sloping extent 322a-322d of the spring arm 312a-312d. The outward angle gamma γ is an obtuse angle, which is between 115 and 170 degrees, and preferably between 125 and 145 degrees. An exterior angle delta δ is defined between the outer surface 323a-323d of the second or upwardly sloping extent 322a-322d of the spring arm 312a-312d and the outer surface 327a-327d of the third or downwardly sloping extent 326a-326d of the spring arm 312a-312d. The exterior angle delta δ is a reflex angle, which is between 240 and 300 degrees, and preferably between 255 and 285 degrees. The interior angle omega ω, which complements the exterior angle delta δ, is defined between the inner surface of the second or upwardly sloping extent 322a-322d of the spring arm 312a-312d and the inner surface of the third or downwardly sloping extent 326a-326d of the spring arm 312a-312d. The interior angle omega ω is between between 60 and 120 degrees, preferably between 75 and 105 degrees, and most preferably 80 degrees. In other words, the interior angle omega w is a “significant acute angle,” which means that the angle is greater than 70 degrees, but less than 90 degrees. Similar to the prior discussions of conventional connectors, including those with conventional terminals and/or conventional spring members, whose disclosure is incorporated herein, lack this configuration of the sharp upwardly angled segment and the sharp downwardly angled segment and the resulting apex that corresponds to both the exterior angle delta δ and the interior angle omega ω. Additionally, unlike conventional spring members, the side spring arms 312b, 312d include the protruding jacket extents 329b, 329d of the spring member 300 that have an inner surface 342b that is positioned: (i) outward of the outer perimeter of the rear wall 306, and (ii) inward of the inner surface 346 of the linear extents 316b, 316d of the spring arms 312b, 312d. As shown in the figures, the inner surface of the upwardly sloping extent 322b, 322d and downwardly sloping extent 326b, 326d, are positioned outside of the inner surface 346 of the linear extents 316b, 316d and, as such, the inner surface 342b of the protruding jacket extents 329b, 329d is positioned in positioned inward of these inner surfaces.

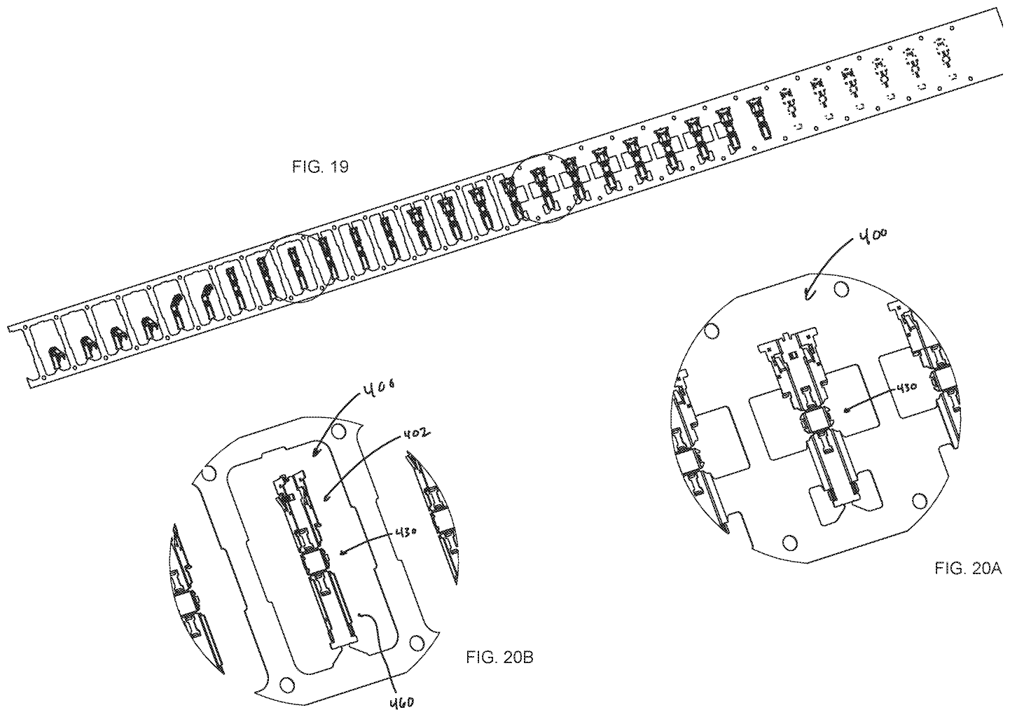

The spring member 300 is typically formed from a single piece of material (e.g., metal); thus, the spring member 300 has a one-piece construction with integrally formed components. In particular, the following features are integrally formed: (i) the curvilinear spring section 308a-308d, and (ii) the spring arm 312a-312d. To integrally form these features, the spring member 300 is typically fabricated using a die forming process. that mechanically forces the spring member 300 into shape. As discussed in greater detail below and in PCT/US2019/036010, when the spring member 300 is formed from a flat sheet of metal (as shown in FIGS. 11-12B), installed within the male terminal 101 (as shown in FIGS. 16-18), and subjected to elevated temperatures, the spring member 300 applies an outwardly directed spring thermal force F_{ST} on the contact arms 180a-180d of the male terminal 101 due in part to the fact that the spring member 300 attempts to return to a flat sheet. However, it should be understood that other methods of forming the spring member 300 may be utilized, such as casting or using an additive manufacturing process (e.g., 3D printing). In other embodiments, the features of the spring member 300 may not be formed from a one-piece or be integrally formed, but instead formed from separate pieces that are welded together.

### 1. Disassembled State to a Partially Assembled State

Positioning the spring member 300 within the male terminal 101 occurs across multiple steps or stages (see FIGS. 16-18). FIG. 16 shows the spring member 300 separated from the male terminal 101, where the spring member 300 and male terminal 101 are in the disassembled state, S_{DA}. In this disassembled state, S_{DA}, the contact arms 180a-180d are in a ready to receive position P_{R}. In this receive position P_{R}, the receiver 105 has a first frontal dimension D_{1F} that extends between opposed free ends 190a, 190c of the contact arms 180a, 180c, and the outer angle formed between the outer surface 111 of the male terminal body 104 and the linear extents 182a-182d of the contact arms 180a-180d is between 90 degrees and 181 degrees (preferably, between 150 degrees and 170 degrees). An assembler applies a rearwardly assembling force F_{A} on the spring member 300 to position said member 300 within the receptacle 105 of the male terminal body 104. When positioning the spring member 300 in the receptacle 105, the assembler must align the spring 300 with the body 104 such that the anti-rotation projection 114 can be inserted into a spring arm gap 310a, as shown in FIG. 33. Once the assembler has applied enough force F_{A} on the spring 300 to positioned the rear wall 306 of the spring 300 adjacent to the interior spring wall 108e, the spring member 300 and male terminal 101 have moved from the disassembled state, S_{DA} to the first partially assembled state, S_{1PA}.

The first partially assembled state, S_{1PA} is shown in FIG. 17, where the spring member 300 is positioned in receptacle 105 of the male terminal 101, but the contact arms 180a-180d are not positioned adjacent to the spring arms 312a-312d. To move to the next assembly stage, the assembler applied a downwardly directed contact arm force F_{CA} on all of the contact arms 180a-180d in order to position said arms 180a-180d adjacent to the spring arms 312a-312d. The application of this contact arm force F_{CA} causes the contact arms 180a-180d to move from the ready to receive position P_{R} to the ready to use position P_{U}. In this ready to use position P_{U}, the receiver 105 has a second frontal dimension D_{2F} that extends between opposed free ends 190a, 190c of the contact arms 180a, 180c, and said second frontal dimension D_{2F} is less than the first frontal dimension D_{1F}. In addition, in the ready to use position P_{U} the outer angle formed between the outer surface 111 of the male terminal body 104 and the linear extents 182a-182d of the contact arms 180a-180d is approximately 170-190 degrees, and preferably 180 degrees. The position of the spring member 300 and the movement of the contact arms 180a-180d to this ready to use position P_{U} allows the spring member 300 and male terminal 101 to move from the first partially assembled state, S_{1PA} to second partially assembled state, S_{2PA}. In this second partially assembled state, S_{2PA}, the spring member 300 is positioned and retained in the receptacle 105 and is ready for the next stage of assembly. It should be understood that when the spring member 300 should not be inserted into the receptacle 105 when the contact arms 180a-180d are in the ready to use position P_{U} because said geometric bent or creased portion 320a-320d of the spring member 300 would contact and engage the free ends 190a-190d of the contact arms 180a-180d. In other words, the spring member 300 has an exterior dimension D_{E} that extends between opposed spring arm exterior apex 324a-324d, and wherein the exterior dimension D_{E} of the spring member 300 is greater than the second frontal dimension D_{2F}, whereby preventing the insertion of the spring member 300 within the receptacle 105 without causing outwardly deformation of the contact arms 180a-180d. As such, the assembler should only attempt to insert the spring member 300 into the receptacle 105 of the male terminal body 104 when the contact arms 180a-180d are in the ready to receive position P_{R}.

Other unique features of this system 10 can be seen once the male terminal 101 and the spring member 300 are in the second partially assembled state, S_{2PA}. For example, the free ends 190a-190d of the contact arms 180a-180d do not abut a planar outer surface 313a-313d of the spring arms 312a-312d. Instead, the entirety of the contact arms 180a-180d are supported by the spring arms 312a-312d, such that the system 10 lacks a substantial gap formed between the outer surface 313a-313d of the spring arms 312a-312d and the inner surface of the contact arms 180a-180d. Omitting the gap between these structures and positioning the spring arm 312a-312d in this manner allows a majority of the outer surface 2313a-2313d of the spring arm 312a-312d to underlie and abut an inner surface of the contact arm 180a-180d. It should be understood that a minor/insubstantial gap may be formed between the outer surface 313a-313d of the spring arms 312a-312d and the inner surface of the contact arms 180a-180d due to manufacturing capabilities and restraints due to the movement of the male terminal body 104 from the ready to receive position P_{R} and ready to use position P_{U}. This positional arrangement causes the disclosed system 10 to apply the spring biasing force F_{SB} in a different manner than how the spring biasing force F_{SB} is applied in fourth, fifth, sixth, and seventh embodiments of the systems 3010, 4010, 5010, and 6010 disclosed here. Specifically, the spring members 3300, 4300, 5300, 6300 in these other embodiments of the systems 3010, 4010, 5010, and 6010 apply the spring biasing force F_{SB} on one (or possible two) locations and in a direction that is substantially perpendicular to a majority of an outer surface of the spring member 300. In contrast, the disclosed spring member 300 does not: (i) apply the spring biasing force F_{SB} one (or possible two) locations, nor (ii) apply the spring biasing force F_{SB} in a direction that is substantially perpendicular to a majority of an outer surface of the spring member 300.

iv. Jacket

FIGS. 19 and 20A-20B illustrate the steps that may be undertaken to form the jacket 400 from a blank piece of metal (e.g., spring steel, stainless steel). In particular, this process may include a plurality (e.g., 30) steps of cutting and/or bending of said metal blank. Once these steps have been performed, the jacket 400 will be formed to have a clamshell configuration, which is designed to: (i) retain the spring member 300 in the receiver 105, and (ii) increase the durability of the terminal assembly 100. The clamshell configuration of the jacket 400 is provided by a frontal segment 430 connected, via hinges, to an upper segment 402 and a lower segment 460. Said hinges allow for the jacket 400 to be formed in a ready to receive position P_{R} and then later deformed into the ready to use position P_{U}, as discussed below.

The jacket 400 is configured to surround a majority of the male terminal body 104 and provide an arrangement of contact arm deflecting projections 418. The upper and lower segments 402, 460 of the jacket 400, each include a wall arrangement 404, 462 having a U-shaped configuration. In particular, the wall arrangement 404 of the upper segment 402 includes: (i) a top wall 406, and (ii) opposed side walls 408a, 408b. The opposed side walls 408a, 408b include: (i) a number of securement features 410 that are designed to secure the jacket 400 to the male terminal body 102, (ii) at least one contact arm deflecting projection 420 that is configured to protect front and/or rear extents of the contact arms 180a, 180b, 180d, (iii) contact arm recess 424, and (iv) opposed locking tabs 426. In this embodiment, said securement features 410 include a plurality of depressions 412a-412d with internal apexes 413a-413d that are configured to make contact with the side walls of the male terminal body 104. Said contact between the upper segment 402 and the side walls of the male terminal body 104 ensure the formation of a proper electrical connection between the jacket 400 and the male terminal body 104, whereby preventing possible arcing due to intermediate connections. In other embodiments, the plurality of depressions 412a-412d may be replaced with another means designed to secure the jacket 400 to the body 104 and prevent possible arcing. Said means may include welding or forming the jacket as a part of the male terminal body 102. The locking tabs 426 are formed from an extent of the side walls 408a, 408b and are a part of the male terminal retaining means 94. As discussed above, the locking tabs 426 are configured to be positioned in front of the retaining wall surfaces 90 of the male housing assembly 70, when the male connector assembly 50 is in the coupled state S_{C}. The contact arm recess 424 extends upward from a lower edge of the opposed side walls 408a, 408b and is designed to ensure that the jacket 400 does not interfere with the operation or assembly of the male terminal 100. Adjacent to the contact arm recess 424 is a deflecting projection 420, wherein said projection 420 is positioned between recess 424 and a rear extent of the male terminal 101.

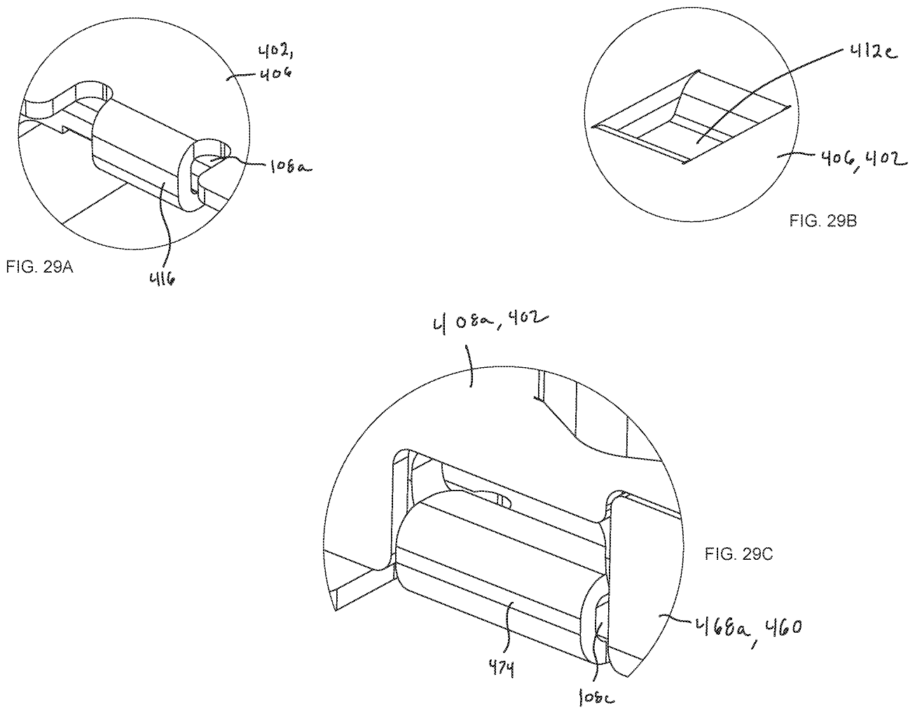

The top wall 406 extends between the opposed side walls 408a, 408b and includes: (i) securement features 410, (ii) a contact arm opening 414, and (iii) a plurality of deflecting projections 420. The contact arm opening 414 is configured to receive an extent of the contact arm 180a-180d, when the male terminal assembly is in the assembled state S_{A}. The front and back of the contact arm opening 414 are flanked by deflecting projections 420. Said deflecting projections 420 extend at an outward angle from the jacket 400 (more particularity, the top wall 406) and have an upper edge that is positioned below the apex 186a-186d of the associated contact arm 180a-180d. The deflecting projections 420 are designed to: (i) help protect the contact arm 180a-180d from external impact forces FIE that may damage said contact arm 180a, 180b, 180d, and (ii) ensure that they do not interfere with the movement of the contact arms 180a-180d during operation of the connector system 10. This embodiment includes: (i) a first deflecting projection 420 positioned: (a) adjacent to the contact arm opening 414, and (b) between a frontal edge of the contact arm opening 414 and the frontal segment 430 of the jacket 400, and (ii) a second deflecting projections 420 positioned: (i) adjacent to the contact arm opening 414, and (ii) between a rear edge of the contact arm opening 414 and the rear extent of the jacket 400. The angle between the outer surface of the top wall 406 of the jacket 400 and the outer surface of the first deflecting projections 420 is approximately equal to the angle formed between a plane that is parallel with the top wall 108a of the male terminal body 104 and the third or downwardly sloping extent 188a-188d of the contact arms 180a-180d. The angle between the outer surface of the top wall 406 of the jacket 400 and the outer surface of the second deflecting projections 420 is approximately equal to the angle formed between a plane that is parallel with the top wall 108a of the male terminal body 104 and the second or upwardly sloping extent 184a-184d of the contact arms 180a-180d. It should be understood that in other embodiments, the deflecting projections 420 may be formed in the male terminal housing 70, may be omitted, there length may be increased or decreased, or may include peripheral supports designed to support the outer edges of the deflecting projections 420. In addition to these features, the securement features 410 formed in the top wall 106 include: (i) an additional or top wall depression 412e, and (ii) a rear retaining tab 416 designed to wrap around an extent of the male terminal body 104 to secure said jacket 400 to said body 104 (see FIG. 28, 29A).

The jacket's 400 frontal segment 430 includes: (i) a frontal wall 432 with spring arm openings 434a, 434b formed there through, and (ii) contact arm deflecting projections 440 configured to protect a front extent of the contact arms 180b, 180d. As will be described in greater detail below, the spring arm openings 434a, 434b are configured to receive an extent of the spring member 400 (i.e., jacket extent 329b, 329d) in order to help prevent over-compression of the contact arms 180b, 180d. Like the upper and lower segments 402 and 462, said deflecting projections 440 extend at an outward angle from the jacket 400 (more particularity, an extent of the frontal wall 432) and are designed to help protect the contact arm 180a-180d from the external impact forces FIE that may damage said contact arm 180a-180d.

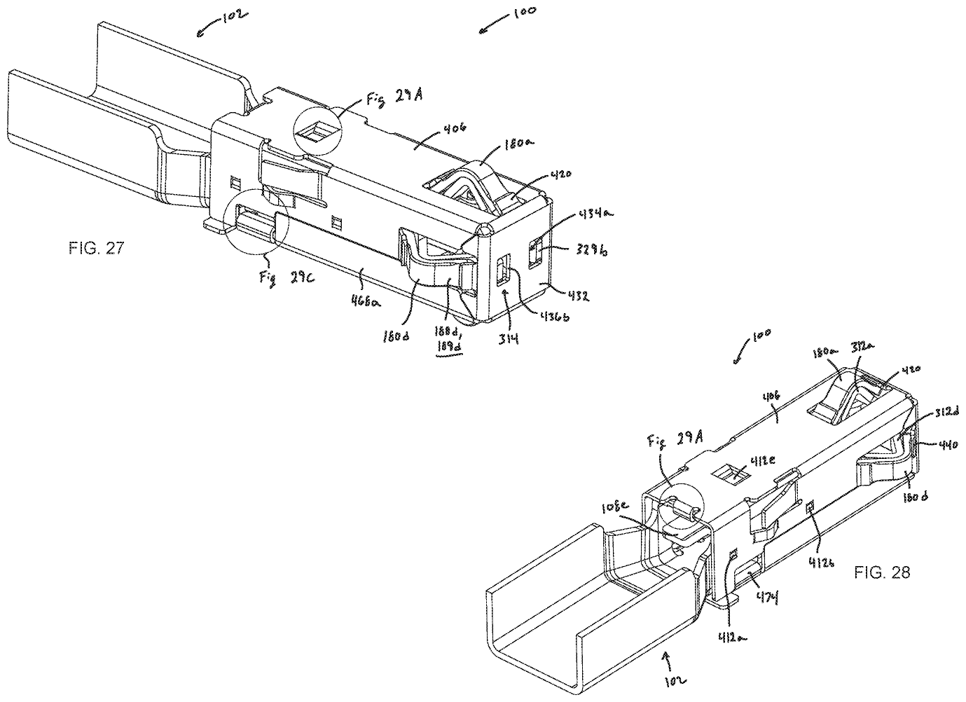

The jacket's 400 wall arrangement 462 of the lower segment 460 includes: (i) a bottom wall 466, and (ii) opposed side walls 468a, 468b. The bottom wall 466 extends between the opposed side walls 468a, 468b and includes: (i) contact arm opening 470, (ii) contact arm deflecting projections 480 that are configured to protect front and rear extents of the contact arms 180c, and (iii) securement features 410. The contact arm opening 470 is configured to receive an extent of the contact arm 180a-180d, when the male terminal assembly is in the assembled state S_{A}. The front and back of the contact arm opening 470 are flanked by deflecting projections 480. Said deflecting projections 480 extend at an outward angle from the jacket 400 (more particularity, the bottom wall 466) and are designed to help protect the contact arm 180a-180d from the external impact forces FIE that may damage said contact arm 180a-180d. In this embodiment: (i) a first deflecting projections 480 is positioned: (a) adjacent to the contact arm opening 470, and (b) between a frontal edge of the contact arm opening 470 and the frontal segment 430 of the jacket 400, and (ii) a second deflecting projections 480 is positioned: (i) adjacent to the contact arm opening 470, and (ii) between a rear edge of the contact arm opening 470 and the rear extent of the jacket 400. The angle between the outer surface of the bottom wall 466 of the jacket 400 and the outer surface of the first deflecting projections 480 is approximately equal to the angle formed between a plane that is parallel with the top wall 108c of the male terminal body 104 and the third or downwardly sloping extent 188a-188d of the contact arms 180a-180d. The angle between the outer surface of the bottom wall 466 of the jacket 400 and the outer surface of the second deflecting projections 480 is approximately equal to the angle formed between a plane that is parallel with the bottom wall 108c of the male terminal body 104 and the second or upwardly sloping extent 184a-184d of the contact arms 180a-180d. In addition to these deflecting projections 480, the securement features 410 formed in the bottom wall 106 include a plurality of peripheral retaining tabs 474, which are designed to wrap around an extent of the male terminal body 104 to secure said jacket 400 to said body 104 (see FIGS. 27 and 29C).

### 1. Partially Assembled State to Fully Coupled State

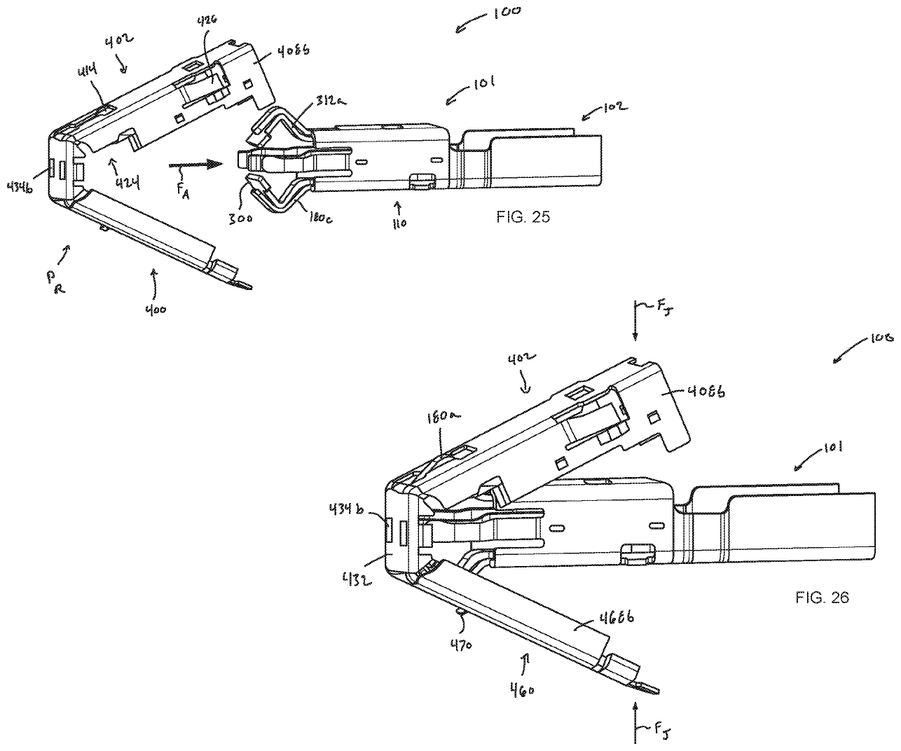

Moving the male terminal assembly from the third partially assembled state, S_{3PA} to the fully coupled state, S_{FC} occurs across multiple steps or stages. First, the male terminal assembly must move from the third partially assembled state, S_{3PA} to an assembled state before the assembler can move the connector to the coupled state S_{C}. FIG. 25 shows the jacket 400 separated from the male terminal 101, where the male terminal assembly 100 is in the third partially assembled state, S_{3PA}. In this third partially assembled state, S_{3PA}, the jacket 400 is in a ready to receive position P_{R}. An assembler applies a rearwardly assembling force F_{A} on the jacket 400 to position said jacket 400 over the male terminal body 104 and the spring member 300. When positioning the jacket 400 over the male terminal body 104 and the spring member 300, the assembler must align the spring arm openings 434a, 434b formed in the jacket 400 with the jacket extent 329b, 329d of the spring member 300. Once the assembler has applied enough force F_{A} on the jacket 400 to position: (i) jacket extent 329b, 329d of the spring member 300 is positioned in the spring arm openings 434a, 434b, and (ii) deflecting projections 440 are positioned adjacent to third or downwardly sloping extent 188b, 188d of the contact arms 180b, 180d, the male terminal assembly 100 has moved from the third partially assembled state, S_{3PA} to the fourth partially assembled state, S_{4PA}.

Next, as shown in FIG. 26, the assembler applies a downwardly directed joining force Fj on the upper and lower segments 402, 460 of the jacket 400 to position the top and bottom walls 406, 466 adjacent to the top and bottom walls 108a, 108c of the male terminal body 104. After said walls 108a, 108c, 406, 466 are positioned adjacent to one another, the assembler must bend the retaining tabs 416, 474 around extents of the male terminal body 104. Once this has been accomplished, the male terminal assembly 100 is in the assembled state S_{A} (see FIGS. 27-35). In this assembled state S_{A}, the formation of the second combination of limiting structures 315b is complete.

Unlike conventional connector assemblies, the disclosed male terminal assembly 100 includes the means for limiting compression 314. Said means for limiting compression 314 is further comprised of the second combination of limiting structures 315b, which is formed from the interaction between structures contained in two separate components (i.e., spring member 300 and jacket 400). In other words, positing the jacket extent 329b, 329d of the spring member 300 in the spring arm openings 434a, 434b formed in the jacket 400 will provide said second combination of limiting structures 315a (see FIGS. 31-32). Here, the application of an external force F_{E} on the contact arms 180b, 180d can only deform the contact arms 180b, 180d to the max compression distance D_{MC} because the inner surface 342a jacket extent 329b, 329d contacts the inner edges or inner compression edges 436a, 436b of the spring arm openings 434a, 434b. Limiting the extent the contact arms be deforming or depressing to the max compression distance D_{MC} prevents the contact arms 180b, 180d, spring arms 312b, 312d, and a combination thereof from being overly deformed or depressed (e.g., a distance that is greater than the max compression distance D_{MC}) toward the center of the connector 50.

Finally, as shown in FIGS. 36-42, the assembler applies a coupling force Fc on the male terminal assembly 100 in order to position the male terminal assembly 100 in the male housing assembly 70. The assembler will apply said coupling force Fc on the male terminal assembly 100 until the frontal wall 432 of the jacket 400 is positioned adjacent to the front wall 74 of the male housing assembly 70. Once the connector assembly 50 reaches this stage, the contact arms 180a-180d are positioned within the contact arm openings 76a-76d of the male housing assembly 70, and the locking tabs 426 of the jacket 400 are positioned forward of the retaining wall surfaces 90. Once the male terminal assembly 100 is in this position, the assembler aligns the retaining body 96 with the retaining opening 95 and applies a downwardly directed force on the retaining body 96 in order to position: (i) the retaining projections 98a, 98b within the retaining opening 95, and (ii) the securing projections 97a, 97b below an extent of the connector arrangement of side walls 86. In this state, the male connector assembly 50 is in the fully connected state S_{FC} and is ready for engagement with the female connector assembly 650.

### 2) Female Connector Assembly

The female connector assembly 650 is comprised of: (i) the female housing assembly 670 and (ii) the female terminal assembly 700.

a. Female Housing Assembly

The female housing assembly 670 is designed to: (i) receive the female terminal assembly 700, (ii) facilitate the coupling of the male terminal assembly 100 with the female terminal assembly 700, (iii) minimize the chance that a foreign object accidentally makes contact with the female terminal assembly 700, and (iv) meet industry standards, such as USCAR specifications. The female housing assembly 670 includes a sidewall 672 having a configuration that substantially matches the configuration of the female terminal assembly 700. In the embodiment shown in the figures, the female terminal assembly 700 has a cuboidal configuration, and preferably a rectanguloid configuration to match the rectanguloid of the male terminal assembly 100. The sidewall 672 of the female housing assembly 670 also includes a plurality of projections 697 configured to be received by the recesses 82, and the projections 80 are configured to be received by the recesses 698. Finally, the female housing assembly 670 includes coupling projection 699, which is design to interact with the female receiver opening 84 of the male housing assembly 70. The female housing assembly 670 also includes a female terminal retaining means 690 that includes: (i) a retaining body 692, (ii) retaining openings 694 formed in the sidewall 672 of the female housing assembly 670, and (iii) terminal body projection receiver 961. The retaining body 692 is a U-shaped structure that includes retaining projections 696 that extend downward from the upper crossing member that extends between the legs of the U-shaped structure. When the assembly 650 is in the fully coupled state, S_{FC}: (i) the retaining body 692 is positioned adjacent an extent of the sidewall 672, (ii) the retaining projection 696 extend into the retaining opening 694, and are positioned rearward of the male terminal body 104, and (iii) the terminal body projection 713 is positioned in the terminal body projection receiver 691.

The sidewall 672 of the female housing assembly 670 extends past the upper most surface of the female terminal assembly 700 to allow for the formation of a male compression means 674 in an extent of the sidewall 672. As shown in the Figures, the male compression means 674 is a sloped or ramped surface 676 that extends from an outermost edge 673 of the sidewall 672 to the upper most edge 700a of the female terminal assembly 700. In the disclosed embodiment, the sloped or ramped surface 676 extends from each of the outermost edge 673 and has a substantially linear configuration. However, it should be understood that the sloped or ramped surface 676 may only extend from a portion of the outermost edge 673. The male compression means 674, shown as the sloped or ramped surface 676, is designed to compress the contact arms 180a-180d as the male terminal assembly 100 moves from being separated from the female terminal assembly 700 in a disconnected state S_{DC} to being positioned within an extent of the female terminal assembly 700 in a connected state S_{C} (see FIGS. 1 and 58-63). As such, the distance between opposed points on the outermost edge 673 is equal to a sidewall distance D_{S}, wherein the sidewall distance D_{S} is greater than the rearmost edge distance D_{RE} that extends between opposed points on the rearmost edge 678 of the sloped or ramped surface 676. And wherein the rearmost edge distance D_{RE} is greater than or equal to a receiver distance D_{R} that extends between opposed points on the inner surface 704 of the receptacle 702 of the female terminal assembly 700. In particular, the sidewall distance D_{S} is between 0.1% and 15% larger than the receiver distance D_{R}, and where the rearmost edge distance D_{RE} is equal to or greater 0.1% and 3% larger than the receiver distance D_{R}. In other words, the sloped or ramped surface 676 is angled relative to the outer surface of the sidewall 672 and/or the inner surface 704 of the receptacle 702 of the female terminal assembly 700. In particular, the interior angle chi χ that extends between the inner surface of the sloped or ramped surface 676 and the outer surface of the sidewall 672 is between 0.1 degrees and 10 degrees.

This sloped or ramped surface 676 is made from a polymer or plastic material and, as such has a coefficient of friction that is lower than a coefficient of friction associated with a metal surface. In other words, a first friction value is formed when the extent (e.g., a contact arm 180a-180d) of the male terminal assembly 100 engages with a male terminal compression means 674 formed from a non-metallic material (e.g., plastic). In an alternative embodiment, a second friction value would be formed if the extent (e.g., a contact arm 180a-180d) of the male terminal assembly 100 was to engage with a male terminal compression means formed from a metallic material (e.g., copper). Comparing the friction value from the disclosed embodiment to the friction value alternative embodiment, it should be understood that the first or friction value from the disclosed embodiment is less than the second or friction value alternative embodiment.

The lower coefficient of friction reduces the force that is required to insert the male terminal assembly 100 into the female terminal assembly 700. This is beneficial because: (i) industry specifications, including USCAR 25, has requirements that the insertion force F₁ cannot be greater than 45 Newtons for a class 2 connector and 75 Newtons for a class 3 connector and (ii) the use of a greater spring biasing force F_{SB}, which thereby increases the insertion force F₁, is desirable to help ensure that the contact arms of the male terminal assembly remain in contact with the inner surface 704 of the receptacle 702 of the female terminal assembly 700. Further, this lower coefficient of friction is beneficial because the connector system 10 can move from the disconnected state S_{PC} to a connected state S_{C} while meeting class 2/class 3 USCAR specifications without requiring a lever assist. Eliminating the lever assist reduces the size, weight, and cost of manufacturing the connector system 10. It should be understood that to further reduce the coefficient of friction, the sloped or ramped surface 676 may be coated with a substance that reduces this coefficient or the sloped or ramped surface 676 may be made from a material that has an even lower coefficient of friction.

Due to the configuration of the male and female connectors 50, 650, different levels of force are required as the connector system 10 moves from the disconnected state S_{DC} to the connected state S_{C}. For example, a first force F₁₁ is required to move the male terminal assembly 100 when an extent (e.g., a contact arm 180a-180d) of the male terminal assembly 100 is in sliding engagement with the male terminal compression means 674 and a second force F₁₂ is required to move the male terminal assembly 100 when the extent (e.g., a contact arm 180a-180d) male terminal assembly 100 is positioned in the female terminal receiver 702. Comparing the forces, it should be understood that the second force F₁₂ is less than the first force F₁₁. This is beneficial because it provides the user with a tactical feedback to inform the user that the male terminal assembly 100 is properly seated within the female terminal assembly 700. In fact, this tactical feedback fells to the user like the male terminal assembly 100 is being pulled into the female terminal assembly 700.

To minimize the chance that the male connector assembly 50 can be accidently disconnected from the female connector assembly 650, the female connector assembly 650 may include an optional non-deformable female CPA structure that is designed and configured to interact with the male CPA structures, when the connector assemblies 50, 650 are coupled to one another. Said non-deformable female CPA structure is integrally formed with the sidewall 672 of the female housing assembly 670. Additional details about the structure and/or function of the female CPA structure are disclosed in PCTUS2019/036070, PCTUS2020/049870, PCTUS2021/033446, all of which are incorporated herein by reference.

b. Female Terminal

The female terminal assembly 700 of the female connector assembly 650 is comprised of: (i) a female terminal connection member 701, and (ii) the female terminal body 710. Specifically, the female terminal connection member 701 is coupled to the female terminal body 710. In this embodiment, the female terminal connection member 701 is a wire receiver, wherein said wire receiver has a blade shaped structure that is configured to receive an extent of a structure (e.g., lead or wire) that connects the female terminal assembly 700 to a device (e.g., an alternator) outside of the connector system 10. A wire is typically welded to the wire receiver; however, other methods (e.g., forming the wire as a part of the wire receiver) of connecting the wire to the wire receiver are contemplated by this disclosure. In other embodiments, the female terminal connection member 701 may be a crimping connection, a circuit board connector, have a U-shaped configuration, or any other type of connection member 102 that mechanically and electrically couples the female terminal body 710 to an external device, part, or extent.

The female terminal body 710 of the female connector assembly 650 includes a sidewall 712 having an inner surface 704 that forms cylindrical terminal receptacle 702 with a receiver distance D_{R} that extends between opposed points on the inner surface 704 of the sidewall 712. As discussed above, the receiver distance D_{R} is: (i) less than the sidewall distance D_{S} and (ii) equal to or greater than the rearmost edge distance D_{RE}. Additionally, the receiver distance is between 0.1% and 15% smaller than a male terminal assembly distance that extends between the outermost extents of opposed contact arms 180a-180d. Forming a terminal receptacle 702 with a receiver distance that is less than the male terminal assembly distance ensures that the contact arms 180a-180d are compressed when the male terminal assembly 100 is inserted into the female terminal assembly 700. This compression of the male terminal assembly 100 compresses the spring member 300. As such, the spring member 300 exerts an outwardly directed biasing force F_{SB} on the contact arms 180a-180d to help ensure that they remain in contact with the inner surface 704 of the terminal receptacle 702 to facilitate the electrical and mechanical coupling of the male terminal assembly 100 with the female terminal assembly 700.

The female terminal assembly 700 is typically formed from metal and preferably a highly conductive metal, such as copper. The female terminal assembly 700 may be plated or clad with Ni—Ag. In other embodiments, the sidewall 712 may be made from a different material, and/or the female terminal assembly 700 may not be plated or clad with Ni—Ag. Once the female terminal assembly 700 is fabricated, it can be coupled to the wire, part, component, or device via the female terminal connection member 701.

### 3) Connecting the Connector System

The connector system 10 can move from a disconnected state S_{DC} to a partially connected state S_{PC}, where the contact arms 180a-180d of the male connector assembly 50 in contact with the ramped or sloped surface 676 of the female connector assembly 650. This ramped or sloped surface 676 gently and smoothly compresses the contact arms 180a-180d until they can easily slide into and make contact with the inner surface 704 of the female receptacle 702. This process is described in greater detail within PCT/US2019/36070 and is incorporated herein. Once the male connector assembly 50 is connected to the female connector assembly 650, the connector system 10 has moved from the partially connected state S_{PC} to the connected state S_{C}. If present, a force is applied to the CPA that causes it to interact with an extent of the external component and the installer can scan an extent of the CPA that is visible through the opening within the housing, as described within PCT/US2020/049870.

### 4) Terminal Properties and Functionality

FIG. 61 depicts a cross-section of the male connector assembly 50 coupled to the female connector assembly 650 in the connected state S_{C}. While the below disclosure is discussed in connection with the first embodiment of the system 10, it should be understood that this disclosure applies in equal force to all embodiments of the system 1010, 2010, 3010, 4010, 5010, 6010. As discussed above, the outermost extent or diameter of the contact arms 180a-180d are slightly larger than the inner diameter of the female terminal body 710. As such, when these components are mated with one another, the spring member 300 is compressed. This compression of the spring member 300 creates a wedging effect or outwardly directed biasing force F_{SB} against the contact arms 180a-180d and away from the interior of the spring member 300.

The male terminal body 104, including the contact arms 180a-180d, may be formed from a first material such as copper, a highly-conductive copper alloy (e.g., C151 or C110), aluminum and/or another suitable electrically conductive material. The first material preferably has an electrical conductivity of more than 80% of IACS (International Annealed Copper Standard, i.e., the empirically derived standard value for the electrical conductivity of commercially available copper). For example, C151 typically has 95% of the conductivity of standard, pure copper compliant with IACS. Likewise, C110 has a conductivity of 101% of IACS. In certain operating environments or technical applications, it may be preferable to select C151 because it has anti-corrosive properties desirable for high-stress and/or harsh weather applications. The first material for the male terminal body 104 is C151 and is reported, per ASTM B747 standard, to have a modulus of elasticity (Young's modulus) of approximately 115-125 gigapascals (GPa) at room temperature and a coefficient of terminal expansion (CTE) of 17.6 ppm/degree Celsius (from 20-300 degrees Celsius) and 17.0 ppm/degree Celsius (from 20-200 degrees Celsius).

The spring member 300 may be formed from a second material such as spring steel, stainless steel (e.g., 301SS, ¼ hard), and/or another suitable material having greater stiffness (e.g., as measured by Young's modulus) and resilience than the first material of the male terminal body 104. The second material preferably has an electrical conductivity that is less than the electrical conductivity of the first material. The second material also has a Young's modulus that may be approximately 193 GPa at room temperature and a coefficient of terminal expansion (CTE) of 17.8 ppm/degree Celsius (from 0-315 degrees Celsius) and 16.9 ppm/degree Celsius (from 0-100 degrees Celsius). In contemplated high-voltage applications, the cross-sectional area of copper alloy forming the first connector is balanced with the conductivity of the selected copper alloy. For example, when a copper alloy having lower conductivity is selected, the contact arms 180a-180d formed therefrom have a greater cross-sectional area so as to adequately conduct electricity. Likewise, selection of a first material having a higher conductivity may allow for contact arms 180a-180d having a relatively smaller cross-sectional area while still meeting conductivity specifications.

In an example embodiment, the CTE of the second material may be greater than the CTE of the first material, i.e., the CTE of the spring member 300 is greater than the CTE of the male terminal body 104. Therefore, when the assembly of the male terminal body 104 and the spring member 300 is subjected to the high-voltage and high-temperature environment typical for use of the electrical connector described in the present disclosure, the spring member 300 expands relatively more than the male terminal body 104. Accordingly, the outward force F_{SB} produced by the spring member 300 on the contact arms 180a-180d of the male terminal body 104 is increased in accordance with the increased temperature, which is reference to below as a thermal spring force F_{ST}.

An example application of the present disclosure, such as for use in a charge coupler, is suitable for deployment in a class 5 automotive environment, such as that found in passenger and commercial vehicles. Class 5 environments are often found under the hood of a vehicle, e.g., alternator, and present 150° Celsius ambient temperatures and routinely reach 200° Celsius. When copper and/or highly conductive copper alloys are subjected to temperatures above approximately 150° Celsius said alloys become malleable and lose mechanical resilience, i.e., the copper material softens. However, the steel forming the spring member 300 retains hardness and mechanical properties when subjected to similar conditions. Therefore, when the male terminal body 104 and spring member 300 are both subjected to high-temperature, the first material of the male terminal body 104 softens and the structural integrity of the spring member 300, formed from the second material, is retained, such that the force applied to the softened contact arms 180a-180d by the spring member 300 more effectively displaces the softened contact arms 180a-180d outward relative the interior of the male terminal body 104, in the fully connected position S_{FC}.

The male terminal body 104, spring member 300, and female terminal body 710, are configured to maintain conductive and mechanical engagement while withstanding elevated temperatures and thermal cycling. Further, the male terminal body 104 and female terminal body 710 may undergo thermal expansion as a result of the elevated temperatures and thermal cycling, which increases the outwardly directed force F_{SB} applied by the male terminal body 104 on the female terminal body 710. The configuration of the male terminal body 104, spring member 300, and the female terminal body 710 increase the outwardly directed connective force therebetween while the connector system 10 withstands thermal expansion resulting from thermal cycling in the connected position P_{C}.

Based on the above exemplary embodiment, the Young's modulus and the CTE of the spring member 300 is greater than the Young's modulus and the CTE of the male terminal body 104. Thus, when the male terminal body 104 is used in a high power application that subjects the connector system 10 to repeated thermal cycling with elevated temperatures (e.g., approximately 150° Celsius) then: (i) the male terminal body 104 become malleable and loses some mechanical resilience, i.e., the copper material in the male terminal body 104 softens and (ii) the spring member 300 does not become as malleable or loses as much mechanical stiffness in comparison to the male terminal body 104.

Thus, when utilizing a spring member 300 that is mechanically cold forced into shape (e.g., utilizing a die forming process) and the spring member 300 is subjected to elevated temperatures, the spring member 300 will attempt to at least return to its uncompressed state, which occurs prior to insertion of the male terminal assembly 100 within the female terminal assembly 700, and preferably to its original flat state, which occurs prior to the formation of the spring member 300. In doing so, the spring member 300 will apply a generally outward directed thermal spring force F_{ST}, (as depicted by the arrows labeled “F_{ST}” in FIG. 61) along the entire length of the contact arm 180a-180d (not just at a discrete point(s)). This thermal spring force F_{ST}, is dependent upon local temperature conditions, including high and/or low temperatures, in the environment where the system 10 is installed. Accordingly, the combination of the spring biasing force F_{SB}, and the thermal spring force F_{ST}, provides a resultant biasing force F_{RSB}, that ensures that the outer or contact surface 189a-189d of the contact arms 180a-180d are forced into contact with the inner surface 704 of the female terminal body 710 when the female terminal assembly 700 is inserted into the female terminal 700 and during operation of the system 10 to ensure an electrical and mechanical connection. Additionally, with repeated thermal cycling events, the male terminal assembly 100 will maintain and/or increase in the outwardly directed resultant spring forces, S_{RBF}, that are applied to the female terminal assembly 700 during repeated operation of the system 10.

Further illustrated in FIG. 61, in the connected state S_{C}, the male terminal assembly 100 provides 360° compliance with the female terminal assembly 700 to ensure that a sufficient amount of outwardly directed biasing force F_{SB} is applied by the male terminal assembly 100 to the female terminal assembly 700 for electrical and mechanical connectivity in all four primarily directions. This attribute allows for omission of a keying feature and/or another feature designed to ensure a desired orientation of the components during connection. The 360° compliance attribute of the system 10 also aids in maintaining mechanical and electrical connection under strenuous mechanical conditions, e.g., vibration. In a traditional blade or fork-shaped connector with 180° compliance, i.e., connection on only two opposing sides, vibration may develop a harmonic resonance that causes the 180° compliant connector to oscillate with greater amplitude at specific frequencies. For example, subjecting a fork-shaped connector to harmonic resonance may cause the fork-shaped connector to open. Opening of the fork-shaped connector during electrical conduction is undesirable because momentary mechanical separation of the fork-shaped connector from an associated terminal may result in electrical arcing. Arcing may have significant negative effects on the 180° compliant terminal as well as the entire electrical system of which the 180° compliant terminal is a component. However, the 360° compliance feature of the present disclosure may prevent the possible catastrophic failures caused by strong vibration and electrical arcing.

### 5) Alternate Embodiments of the Male Connector Assembly

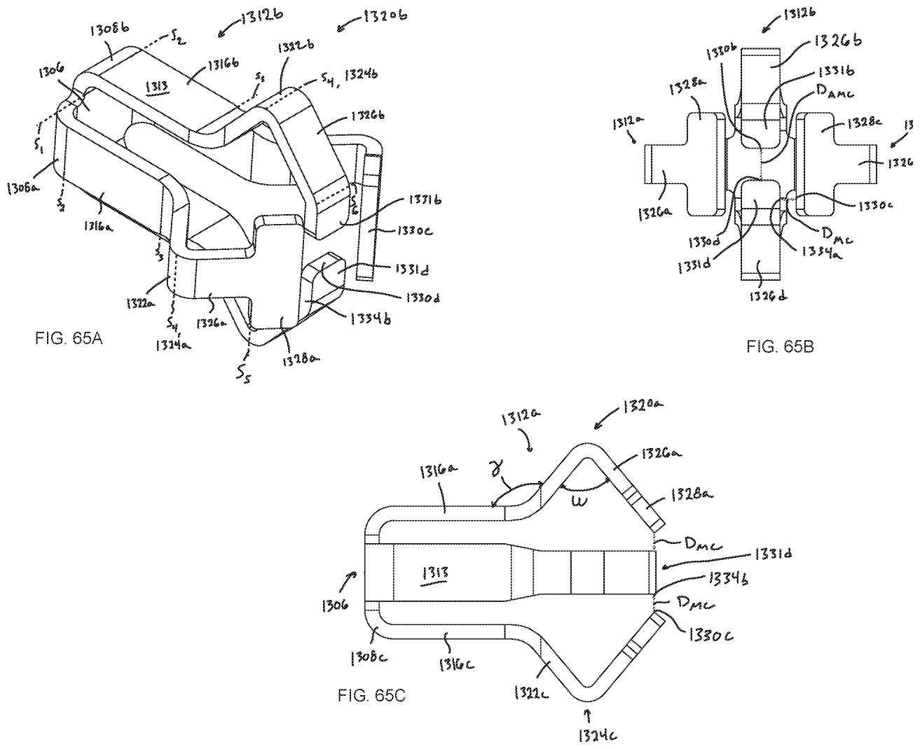

FIGS. 64A-65C show a second embodiment of the spring member 1300 that may be used instead of the spring assembly 300 shown and described above. Because a substantial majority of the structures contacted in this embodiment of the system 1010 are similar to the structures contacted the first embodiment of the system 10, it should be understood that reference numbers that are shown in the figures may be omitted from the specification for sake of brevity as like structures have like numbers. For example, the disclosure in connection with male terminal 101 is not repeated herein, but it applies to male terminal 1101, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference.

In this second embodiment of the system 1010, an extent of the means for limiting compression 314 from the first embodiment of the system 10 was replaced with an alternative extent of the means for limiting compression 1314. In particular, the second combination of limiting structures 315b (i.e., jacket extents 329b, 329d of the spring member 300 and the spring arm openings 434a, 434b formed in the jacket 400) was replaced with an alternative combination of structures 1315b (i.e., contact extensions 1331b, 1331d). Here, the contact extensions 1331b, 1331d disclosed in this embodiment 1010 replace the jacket extents 329b, 329d from the first embodiment of the system 10. In this embodiment, the application of an external force F_{E} on the contact arms 1180b, 1180d can only deform the contact arms 1180b, 1180d, the alternative max compression distance D_{AMC} because the frontal end 1330b, 1330d contact one another. Limiting the extent the contact arms 1180b, 1180d be deforming or depressing to the alternative max compression distance D_{AMC} prevents the contact arms 1180b, 1180d, spring arms 1312b, 1312d, and a combination thereof from being overly deformed or depressed (e.g., a distance that is greater than the alternative max compression distance D_{AMC}) toward the center of the connector 1050. The alternative max compression distance D_{AMC} in this embodiment is twice as large as the max compression distance D_{MC}, but is still small enough to reduce system 1010 failures due to over compression by the external force F_{E}. In other words, the compression distance that the system 1010 fails at larger than the alternative max compression distance D_{AMC}, which is larger than the max compression distance D_{MC}, which is larger than the normal or operational deformation distance the system 1010 experiences when the system 1010 is in the connected state S_{CN}. The design of this terminal assembly 1100 may be more desirable over the first embodiment of the terminal assembly 100 because the means for limiting compression 1314 is completely contained in a single structure (i.e., the spring member 1300), which in turn may increase the durability and longevity of the system 1010.

FIGS. 66-74 show a third embodiment of the spring member 2300 that may be used instead of the spring assembly 300 shown and described above. Because a substantial majority of the structures contacted in this embodiment of the system 2010 are similar to the structures contacted the first embodiment of the system 10, it should be understood that reference numbers that are shown in the figures may be omitted from the specification for sake of brevity as like structures have like numbers. For example, the disclosure in connection with male terminal 101 is not repeated herein, but it applies to male terminal 2101, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference. In this embodiment, the geometric bent or creased portions 320a-320d and the means for limiting compression 314 from the first embodiment of the system 10 has been replaced by contact arm supports 2350 and compression tabs 2370. In particular, the contact arm supports 2350 include: (i) a forward curvilinear extent 2351a-2351d that extends between the linear extents 2316b, 2316d (line S₃) of the spring member 300 and a vertical extent 2353a-2353d (line S₄), and (ii) the vertical extent 2353a-2353d extends forward from the forward curvilinear extent 2351a-2351d (line S₄) and terminates at the free end 2330a-2330d.

Unlike the first two embodiments of the male terminal assembly 100, 1100 disclosed herein, the spring arm 2312a-2312d does not have a geometry that substantially matches the geometry of the associated contact arm 2180a-2180d. As such, the spring arm 2312a-2312d does not have an outer surface 2313a-2313d that underlie and abuts a majority of an inner surface of the associated contact arm 2180a-2180d. Instead, the free end 2330a-2330d of the spring arms 2312a-2312d are positioned under the apex 2186a-2186d of the bent or creased portion 178a-178d of the contact arms 180a-180d. This configuration forms a gap G (which has a right triangular shape) between the upwardly sloping extent 233a, the vertical extent 2353a-2353d of the spring arms 2312a-2312d, and the linear extent 2316a-2316d of the spring arms 2312a-2312d. Like the first two embodiments of the system 10, 1100, the free ends 2190a-2190d of the contact arms 2180a-2180d do not abut a planar outer surface 2313a-2313d of the spring arms 2312a2-312d. Other structures, functions, or positional relationships may be obvious to one of skill in the art based on FIGS. 66-74.

The spring member 2300 disclosed in this embodiment replaces prior versions of the means for limiting compression 314, 1314 with structures that are fully integrated into the spring member 2300. Here, said means for limiting compression 2314 is formed from a combination of the compression tabs 2370 and edges 2332a-2332b, 2334a-2334b of adjacent spring arms 2312a-2312d. Said compression tabs 2370 include: (i) lateral projections 2371a-2371b that extend outward from forward curvilinear extent 2351a, 2351c (line S₅, S₆) and terminate at external surfaces 2373a-2373b, and (ii) substantially vertical wings 2375a-2375b that extend outward from linear extents 2316b, 2316d (line S₇, S₈) and terminate at external surfaces 2376a-2376b. In other words, the means for limiting compression 2314 in this embodiment includes: (i) a first combination of limiting structures 2315a, namely-lateral projections 2371a-2371b and edges 2334a-2334b of the adjacent side spring arms 2312b, 2312d, and (ii) a second combination of limiting structures 2315b, namely-substantially vertical wings 2375a-2375b and edges 2332a-2332b of the adjacent side spring arms 2312a, 2312c.

The external surfaces 2373a-2373b of the lateral projections 2371a-2371b are positioned outside of or beyond the inner surfaces 2346 of opposed linear extents 2316b, 2316d. In other words, the length between the external surfaces 2373a-2373b of the lateral projections 2371a-2371b is greater than the inner linear surface width W_{ILS}, which extends between the inner surfaces 2346 of opposed linear extents 2316b, 2316d. The application of an external force F_{E} on the contact arms 2180a, 2180c can only deform the contact arms 2180a, 2180c, the max compression distance D_{MC} because an inner surface 2372 of the lateral projections 2371a-2371b contacts the forward spring arm edges 2334a, 2334b of the side spring arms 2312b, 2312d (specifically, the edges of the forward curvilinear extent 2351b, 2351d of the side spring arms 2312b, 2312d). In this embodiment the max compression distance D_{MC} is less than 1.25 mm, preferably less than 1.0 mm, and most preferably 0.85 mm. Limiting the extent the contact arms 2180a, 2180c can be deformed or depressed to the max compression distance D_{MC} prevents the contact arms 2180a, 2180c, spring arms 2312a, 2312c, and a combination thereof helps prevent said arms 2180a, 2180c from being overly deformed or depressed (e.g., a distance that is greater than the max compression distance D_{MC}) toward the center of the connector 2050.

The external surfaces 2376a-2376b of the substantially vertical wings 2375a-2375b are positioned outside of or beyond the inner surfaces 2346 of opposed linear extents 2316a, 2316c. In other words, the length between the external surfaces 2376a-2376b of the substantially vertical wings 2375a-2375b is greater than the inner linear surface width W_{ILS}, which extends between the inner surfaces 2346 of opposed linear extents 2316a, 2316c. The application of an external force F_{E} on the contact arms 2180b, 2180d can only deform the contact arms 2180b, 2180d, the max compression distance D_{MC} because an inner surface 2374 of the substantially vertical wings 2375a-2375b contacts the linear extent edges 2332a, 2332b of the top and bottom spring arms 2312a, 2312c (specifically, the edges of the linear extents 2316a, 2316b of the side spring arms 2312b, 2312d). In this embodiment the max compression distance D_{MC} is less than 1.25 mm, preferably less than 1.0 mm, and most preferably 0.85 mm. Limiting the extent the contact arms 2180b, 2180d can be deformed or depressed to the max compression distance D_{MC} prevents the contact arms 2180b, 2180d, spring arms 2312b, 2312d, and a combination thereof helps prevent said arms 2180b, 2180d from being overly deformed or depressed (e.g., a distance that is greater than the max compression distance D_{MC}) toward the center of the connector 2050.

### Fourth Embodiment

### 1) Male Connector Assembly

FIGS. 75A-100 show a fourth embodiment of the male terminal assembly 3100 that includes a male terminal 3101 and a spring member 3300 that may be used instead of the male terminal 101 and a spring member 300 shown and described above. Because a substantial majority of the structures contacted in this embodiment of the system 3010 are similar to the first embodiment of the system 10, it should be understood that reference numbers that are shown in the figures may be omitted from the specification for sake of brevity as like structures have like numbers. For example, the disclosure in connection with jacket 400 is not repeated herein, but it applies to jacket 3400, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference. Like the first embodiment, this fourth embodiment of the male connector assembly 3050 includes multiple components designed to be coupled to a separate device or component (e.g., charge coupler 2, radiator fan, heated seat, power distribution component, or another current drawing component). The male connector assembly 3050 is primarily composed of: (i) a male housing assembly 3070, and (ii) a male terminal assembly 3100 with a male terminal 3101, a spring member 3300, and a jacket 3400, wherein during operation of the connector system 10 at least a substantial extent of the male terminal assembly 3100 resides within the male housing assembly.

a. Male Terminal Assembly

FIGS. 75A-100 provide various views of the male terminal assembly 3100. While a majority of the structures contained in the fourth embodiment of the male terminal body 3104 are similar to the first embodiment of the male terminal body 104, substantial changes have been made to between the configuration of the contact arms 180a-180d, 3180a-3180d. As such, the following disclosure will focus on this alternative configuration of the contact arms 3180a-3180d. Said contact arms 3180a-3180d have an initial or rear extent 3182a-3182d that extends from the base or intermediate portion 3110 (line C₁) and a bent or creased portion 3178a-3178d. Said bent or creased portion 3178a-3178d include a first layer of the contact arm 3180a-d that directly overlaps a second layer of the contact arm 3180a-d where: (i) a second or upwardly sloping extent 3184a-3184d that extends between the initial extent 3182a-3182d (line C₂) and an exterior apex 3186a-3186d (line C₃) of the contact arm 3180a-3180d, (ii) a third or downwardly sloping extent 3188a-3188d that extends downward from an external apex 3186a-3186d (line C₃) to a forward-most extent that provides a frontal end or nose 3190a-3190d (line C₄) with a rounded or curvilinear end configuration, (iii) a fourth or rearwardly extending extent 3192a-3192d that extends rearward and upward from the forward-most extent 3190a-3190d (line C₄) to an interior apex 3193a-3193d (line C₅), and (iv) a fifth or vertical extent 3194a-3194d that extends inwardly from the interior apex 3193a-3193d (line C₅), preferably substantially perpendicular to a midpoint of the interior apex 3193a-d. These extents and apexes provide the contact arms 3180a-3180d with a bent or creased configuration whereby the third extent 3188a-d overlaps the fourth extent 3192a-d and the external apex 3186a overlaps the internal apex 3193a-d. Further, the pleated configuration of the contact arms 3180a-d forms: (i) a frontal spring contact segment 3196a-3196d positioned near the forward-most frontal end or nose 3190a-3190d and within the fourth or rearwardly extending extent 3192a-3192d, and (ii) an intermediate spring contact segment 3198a-3198d being a part of the fifth or vertical extent 3194a-3194d.

The bent or creased configuration of the contact arms 3180a-3180d provides the connector system 3010 with several advantages over previous designs. For example, this design includes a vertical extent 3194a-3194d that supports the external apex 3186a-3186d of said contact arm 3180a-3180d. This added support increases the durability of the contact arm 3180a-3180d over the contact arm 3180a-3180d designs shown in PCT/US2019/036010—namely, the designs shown in FIGS. 69-86—which is beneficial due to the small size of the contact arms 3180a-3180d. Additionally, having the frontal spring contact segment 3196a-3196d and the intermediate spring contact segment 3198a-3198d helps distribute the compressive force F_{COM} applied to the spring arms 3312a-3312d, when the male terminal assembly 3100 is inserted into the female terminal assembly 700. Further, the configuration of the third or downward sloping extent 3188a-3188d is beneficial over contact arm designs shown in FIGS. 69-96 of PCT/US2019/036010 because its design helps reduce: (i) insertion forces due to the ramped contact arm design (in contrast to the circular contact arm design), and (ii) potential bending or stubbing of contact arms 3180a-3180d, when the insertion of the male terminal assembly 3100 is not directly in line with the female terminal assembly 700.

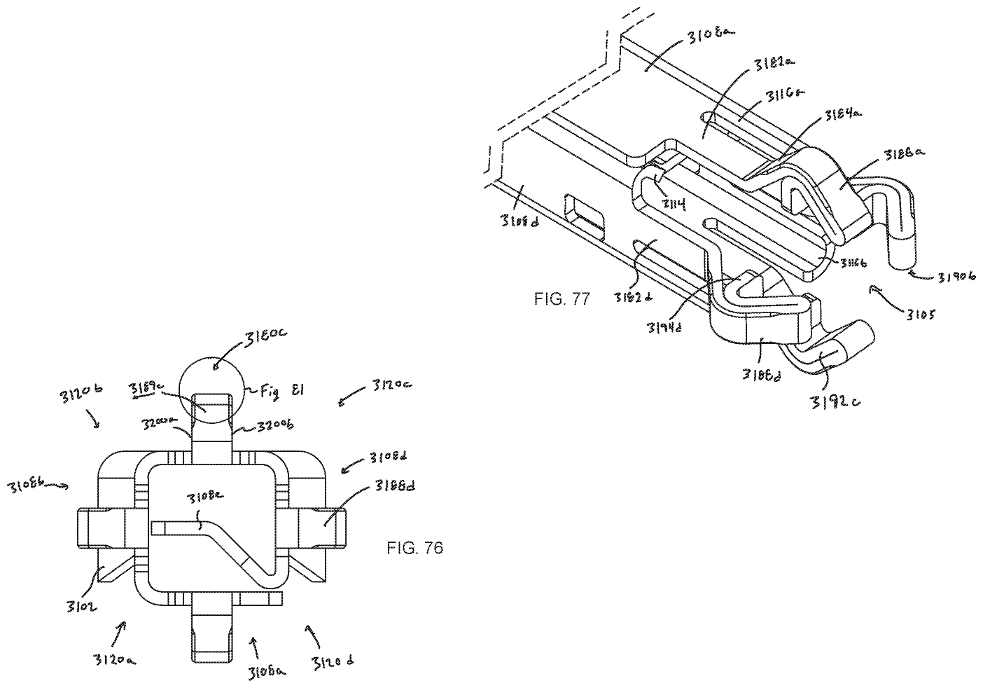

Referring to FIGS. 77-79, unlike conventional connectors, the disclosed contact arms 3180a-3180d have an elongated initial or rear extent 3182a-3182d that does not extend away from the base portion 3110 at a uniform outward sloping angle or substantially uniform outward sloping angle. In other words and as best shown in FIG. 79, an outer surface 3183a-3183d of the initial or rear extent 3182a-3182d of each contact arm 3180a-3180d are: (i) substantially parallel with one another, and (ii) substantially aligned with the outer surface 3111 of the corresponding extent of the base portion 3110. Compared to conventional connectors that lack this elongated initial or rear extent 3182a-3182d, less force is required to deform or displace the contact arm 3180a-3180d inward or toward the center of the male terminal 3101. This reduced force allows for an increase in the force required to inwardly displace an extent of the spring member 3300. Shifting the structure that resists the inward displacement from the contact arm 3180a-3180d to the spring arm 3312a-3312d is beneficial because changes to the insertion force F₁ can be easily made by changing the design and/or material composition of the spring member 3300 and not redesigning the terminal body 3104. For example, the designer can insert a stiffer spring member 3300 in order to maintain/maximize the current carrying capacity of the system 3010. Or if there are specific customer requirements setting forth a target insertion force F₁, the designer can select a spring member 3300 that meets these requirements without having to undertake a costly and time-consuming redesign of the male terminal body 3104. This modularity and flexibility of the connector system 3010 is a substantial improvement over the prior art, as reduce the number of product SKUs, increases the ability to meet customer requirements without retooling or redesigning the connector, and/or limits testing and other steps that would be required to utilize new/different connectors. It should be understood that the length of the initial or rear extent 3182a-3182d will substantially alter the insertion force F₁ required to insert the male terminal assembly 3100 into the female terminal assembly 3700. Also, in other embodiments, the contact arms 3180a-3180d may extend away from the base 3110 at a uniform inwardly angle or substantially uniform inwardly sloping angle. Said inwardly sloping angle allows the male terminal assembly 3100 to have an inwardly tapered design or configuration. In this alternative embodiment, the inwardly tapered design or configuration may be configured such that the outer diameter at line C₂ may be between 0.01% and 5% less than the outer diameter at line C₁.

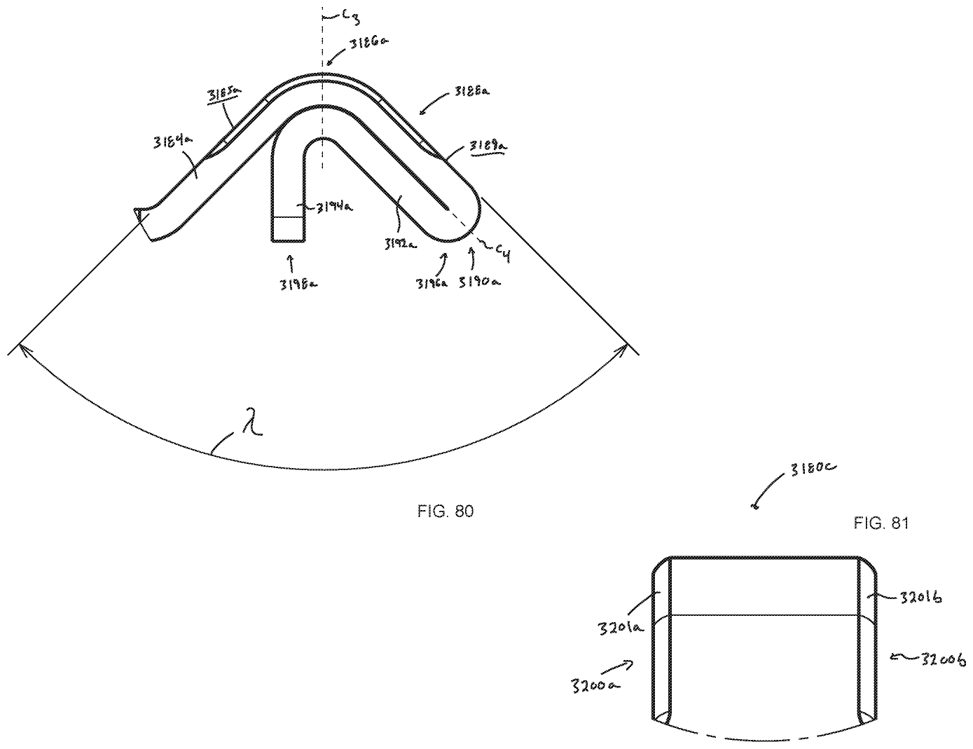

As shown in FIGS. 80, forward of the lateral initial or rear extent 3182a-3182d, the second or upwardly sloping extent 3184a-3184d is positioned at an outward angle sigma σ that is defined between an outer surface 3183a-3183d of the initial or rear extent 3182a-3182d of the contact arm 3180a-3180d and an outer surface 3185a-3185d of the second or upwardly sloping extent 3184a-3184d of the contact arm. The outward angle sigma σ is between 115 and 170 degrees, and preferably between 125 and 145 degrees. Forward of the second or upwardly sloping extent 3184a-3184d, the contact arm 3180a-3180d has a third or downwardly sloping extent 3188a-3188d that extends downward from the exterior apex 3186a-3186d to the forward-most frontal end or nose 3190a-3190d. An exterior angle lamda % is defined between the outer surface 3185a-3185d of the second or upwardly sloping extent 3184a-3184d and the outer or contact surface 3189a-3189d of the third or downwardly sloping extent 3188a-3188d. The exterior angle lamda λ is between 240 and 300 degrees, and preferably between 255 and 285 degrees. Similar to the prior discussion, the other terminals, whose disclosure is incorporated herein, lack this configuration of the sharp upwardly angled segment and the sharp downwardly angled segment and the numerous resulting apexes.

As discussed in greater detail below, the third or downwardly sloping extent 3188a-3188d, and specifically the contact surface 3189a-3189d, is configured to contact an extent of the female connector assembly 650 when the male terminal assembly 3100 is inserted into the female terminal assembly 700. This interaction between these components causes the contact arms 3180a-3180d to be deflected or displaced inward and towards the center of the male terminal assembly 3100 and the spring member 700. This inward deflection of the contact arms 3180a-3180d causes the spring member 700 to act as a wedge to help ensure that a proper mechanical and electrical connection is created between the contact arms 3180a-3180d and the female receptacle 702.

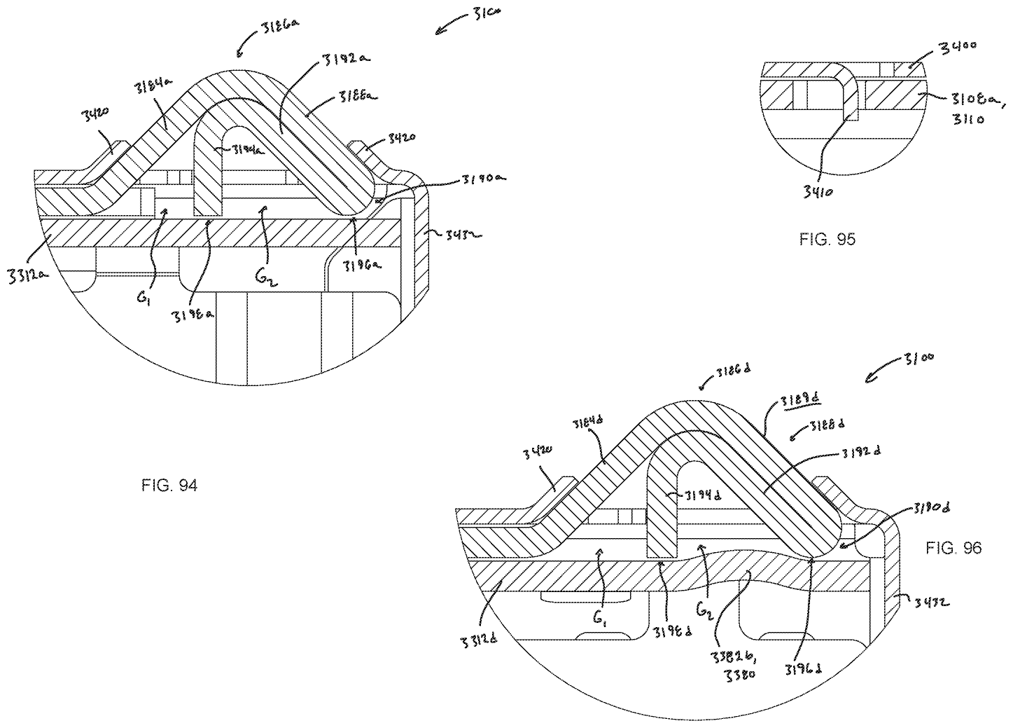

As shown in FIGS. 91 and 94, the frontal spring contact segment 3196a-3196d and the intermediate spring contact segment 3198a-3198d of the contact arms 3180a-3180d are positioned nearly parallel with an inner surface 3181a-3181d of the initial or rear extent 3182a-3182d of the contact arm 3180a-3180d. Referring to FIGS. 94, this configuration provides for (i) a first gap G1 (that is substantially triangular when viewed from the side) to be formed between both the inner surface of the contact arms 3180a-3180d and the spring member 3300 and between the vertical extent 3194a and the rear extent 3182a of the contact arm 180a, and (ii) a second gap G2 (that is substantially triangular when viewed from the side) to be formed between both the inner surface of the contact arms 3180a-3180d and the spring member 3300 and between the vertical extent 3194a and the fourth extent 3192a of the contact arm 3180a or the frontal spring contact segment 3196a-3196d. In this manner, the vertical extent 3194a engages the outer spring arm surface 3313a at a substantially perpendicular angle, preferably at a perpendicular angle. This configuration is beneficial over the configuration shown in FIGS. 3-8 in PCT/US2018/019787 because the assembler of the male terminal assembly 3100 does not have to apply a significant force in order to deform a majority of the contact arms 3180a-3180d outward to accept the spring member 3300. This required deformation can best be shown in FIG. 6 of PCT/US2018/019787 based on the configuration of the spring arm 31 and the contact arm 11. The configuration disclosed herein is beneficial because the connector systems 3010 performance does not change over time due to material creep. Or stated another way, the connector system 3010 does not have a limited shelf life because the spring member 3300 is not under constant tension before usage of the system 3010.

As shown in FIG. 81, at least a portion of the outer edges or shoulder regions 3200a, 3200b of the contact arms 3180a-3180d are coined, beveled, or rounded. Rounding off the outer edges 3200a, 3200b causes the outer surface of the contact arms 3180a-3180d, at least the apex 3186a-3186d, to match the curvature of the inner surface 704 of the female terminal assembly 700. The coined, beveled or rounded outer edges 3200a-3200b may: (i) extend along the entire length of the contact arm 3180a-3180d, (ii) extend along the entire length of the second and third extends 3184a-3184d, 3188a-3188d of the contact arms 3180a-3180d, (iii) extend along a portion (e.g., half of the length) of the second extent 3184a-3184d of the contact arms 3180a-3180d and a portion (e.g., half of the length) of the third extent 3188a-3188d of the contact arms 3180a-3180d. Without coining, beveling, or rounding the portion of the outer edges 3200a, 3200b of the contact arms 3180a-3180d, the edges 3200a, 3200b of the contact arms 3180a-3180d will make contact with the inner surface 704 of the female terminal assembly 700 and will prevent the center of the contact arm 3180a-3180d from making sufficient contact with said female terminal assembly 700 due to the linear vs. curvilinear configurations of the contact arms 3180a-3180d and female terminal assembly 700. Preventing the center of the contact arm 3180a-3180d from making proper contact with said female terminal assembly 700 will undesirably reduce the current carrying capacity of the system 3010. Additionally, omission of the coining, beveling, or rounding will likely leave sharp edges on the contact arms 3180a-3180d, which may cause the contact arms 3180a-3180d to score or mark the inner surface 704 of the female terminal assembly 700. Said scoring can lead to a reduction of the number of mating cycles the system 10 can achieve without failure because the scoring can scrape off or damage the internal plating and/or surface 704 of the female terminal assembly 700, which may lead to arcing or significant electrical degradation of the system 3010. In other embodiments, the outer edges or shoulder regions 3200a, 3200b of the contact arms 3180a-3180d may not be coined, beveled, or rounded; instead, the contact arms 3180a-3180d may be bent or material may be deposited on said contact arms 3180a-3180d to allow the outer surface of said contact arms 3180a-3180d to substantially match the curvature of the inner surface 704 of the female terminal assembly 700.

As shown in FIGS. 76-79 and 88, the contact arms 3180a-3180d are not connected to any structure other than extending from the base portion 3110. This free-end configuration of the contact arms 3180a-3180d allows for omnidirectional expansion of said contact arms 3180a-3180d. Because there is a contact arm opening or void 3280a-3280d interspersed between each pair of contact arms 3180a-3180d, there is no supporting wall that surrounds the contact arms 3180a-3180d. This configuration of the male terminal assembly 3100 is substantially different than the configuration disclosed in connection with the male terminal assembly of PCT/US2019/36010. As discussed in PCT/US2019/36010, the removal of the side wall arrangement that surrounds the contact arms 3180a-3180d could increase the failure rate of the male terminal assembly 3100 because the side wall arrangement protects said contact arms 3180a-3180d. However, this increased failure rate is mitigated because the jacket 3400 has been configured to replace the functionality of the supporting wall. The configuration disclosed herein is beneficial because it replaces expensive copper structures with less expensive and more robust structures.

The male terminal 3101 is typically formed from a single piece of material (e.g., metal); thus, the male terminal 3101 is a one-piece male terminal 3101 and has integrally formed features. To integrally form these features, the male terminal 3101 is typically formed using a die-cutting process. However, it should be understood that other types of forming the male terminal 3101 may be utilized, such as casting or using an additive manufacturing process (e.g., 3D printing). In other embodiments, the features of the male terminal 3101 may not be formed from a one-piece or be integrally formed, but instead formed from separate pieces that are welded together. In forming the male terminal 3101, it should be understood that any number (e.g., between 1 and 100) of contact arms 3180a-3180d may be formed within the male terminal 3101. The male terminal 3101, male terminal body 104, the contact arms 3180a-3180d, or an extent of the contact arms 3180a-3180d may be plated or coated with a secondary material (e.g., nickel) to help reduce corrosion, reduce insertion forces, or improve conductivity. Additionally, the contact arms 3180a-3180d or a portion of the contact arms 3180a-3180d may have rounded or beveled edges.

b. Spring Member

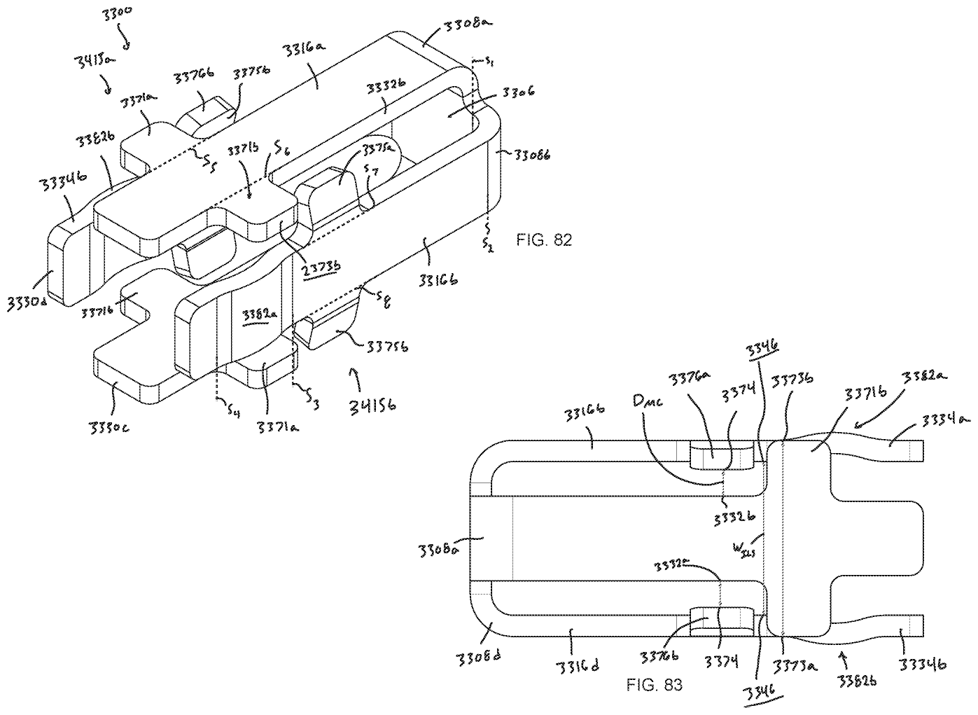

As best shown in FIGS. 82-86, 88, 93, 98, the spring member 3300 includes an arrangement of spring member side walls 3304a-3304d and a rear spring wall 3306. Each spring member side wall 3304a-3304d is comprised of: (i) a first or curvilinear spring section 3308a-3308d, and (iii) a second section or spring arm 3312a-3312d. The curvilinear spring section 3308a-3308d extend between the rear spring wall 3306 and the spring arm 3312a-3312d and position the spring arm 3312a-3312d substantially perpendicular to the rear spring wall 3306. In other words, a substantial extent, if not the entity, of the outer surface of the spring arm 3312a-3312d is substantially perpendicular to the outer surface of the rear spring wall 3306. As shown in FIGS. 12-15, the spring arms 3312a-3312d extend from the first or curvilinear spring section 3308a-3308d of the spring member 3300, away from the rear spring wall 3306, and terminate at a free end 3330a-d. The spring arms 3312a-3312d are not connected and thus spring arm slits 3310a-3310d are formed between the spring arms 3312a-3312d of the spring member 3300. The spring arm slits 3310a-3310d aid in omnidirectional expansion of the spring arms 3312a-3312d, facilitating the mechanical coupling between the male terminal assembly 3100 and the female terminal assembly 4100.

The spring member 3300 disclosed in this embodiment includes a centering means 3380. Said disclosed centering means 3380 does not rely on outwardly extending lateral projection, but; instead, relies on corrugations 3382a-3382b formed in at least one and preferable two opposed spring arms 3312b, 3312d. As best shown in FIG. 36, the corrugations 3382a-3382b are positioned near the free end 3330b, 3330d and extends between line S₃ and line S₄. Said corrugations 3382a-3382b are designed to fit between the frontal spring contact segment 3196b, 3196d and the intermediate spring contact segment 3198a-3198d of the contact arms 3180b, 3180d. By positioning the corrugations 3382a-3382b between the contact end segments 3196a-3196d, 3198a-3198d, movement of the spring member 3300 is reduced. Reducing said movement of the spring member 3300 is desired because it helps ensure consistent and reliable performance of the system 3010.

The spring member 3300 disclosed in this embodiment replaces prior versions of the means for limiting compression 314, 1314, 2134 with structures that are fully integrated into the spring member 3300. Said means for limiting compression 3314 can best be seen in FIGS. 82-86, Here, said means for limiting compression 3314 is formed from a combination of the compression tabs 3370 and edges 3332a-2332b, 3334a-3334b of adjacent spring arms 3312a-3312d. Said compression tabs 3370 include: (i) lateral projections 3371a-3371b that extend outward from the linear extents 3316b, 3316d (line S₅, S₆) and terminate at external surfaces 3373a-3373b, and (ii) substantially vertical wings 3375a-3375b that extend outward from the linear extents 3316b, 3316d (line S₇, S₈) and terminate at external surfaces 3376a-3376b. Here, the lateral projections 3371a-3371b are: (i) positioned forward of the substantially vertical wings 3375a-3375b, and (ii) positioned above/below an extent of the centering means 3380 (e.g., corrugations 3382a-3382b). In other words, the means for limiting compression 3314 in this embodiment includes: (i) a first combination of limiting structures 3315a, namely—lateral projections 3371a-3371b and edges 3334a-3334b of the adjacent side spring arms 3312b, 3312d, and (ii) a second combination of limiting structures 3315b, namely—substantially vertical wings 3375a-3375b and edges 3332a-3332b of the adjacent side spring arms 3312a, 3312c.

The external surfaces 3373a-3373b of the lateral projections 3371a-3371b are positioned outside of or beyond the inner surfaces 3346 of opposed corrugations 3382a-3382b. In other words, the length between the external surfaces 3373a-3373b of the lateral projections 3371a-3371b is greater than the inner linear surface width W_{ILS}, which extends between the inner surfaces 3346 of opposed corrugations 3382a-3382b. The application of an external force F_{E} on the contact arms 3180a, 3180c can only deform the contact arms 3180a, 3180c, the max compression distance D_{MC} because an inner surface 3372 of the lateral projections 3371a-3371b contacts the forward spring arm edges 3334a, 3334b of the side spring arms 3312b, 3312d. In this embodiment the max compression distance D_{MC} is less than 1.25 mm, preferably less than 1.0 mm, and most preferably 0.85 mm. Limiting the extent the contact arms 3180a, 3180c can be deformed or depressed to the max compression distance D_{MC} prevents the contact arms 3180a, 3180c, spring arms 3312a, 3312c, and a combination thereof helps prevent said arms 3180a, 3180c from being overly deformed or depressed (e.g., a distance that is greater than the max compression distance D_{MC}) toward the center of the connector 3050.

The external surfaces 3376a-3376b of the substantially vertical wings 3375a-3375b are positioned outside of or beyond the inner surfaces 3346 of opposed linear extents 3316a, 3316c. In other words, the length between the external surfaces 3376a-3376b of the substantially vertical wings 3375a-3375b is greater than the inner linear surface width W_{ILS}, which extends between the inner surfaces 3346 of opposed linear extents 3316a, 3316c. The application of an external force F_{E} on the contact arms 3180b, 3180d can only deform the contact arms 3180b, 3180d, the max compression distance D_{MC} because an inner surface 3374 of the substantially vertical wings 3375a-3375b contacts the linear extent edges 3332a, 3332b of the top and bottom spring arms 3312a, 3312c (specifically, the edges of the linear extents 3316a, 3316b of the side spring arms 3312b, 3312d). In this embodiment the max compression distance D_{MC} is less than 1.25 mm, preferably less than 1.0 mm, and most preferably 0.85 mm. Limiting the extent the contact arms 3180b, 3180d can be deformed or depressed to the max compression distance D_{MC} prevents the contact arms 3180b, 3180d, spring arms 3312b, 3312d, and a combination thereof helps prevent said arms 3180b, 3180d from being overly deformed or depressed (e.g., a distance that is greater than the max compression distance D_{MC}) toward the center of the connector 3050.

The spring arms 3312a-3312d are generally planar and are positioned substantially perpendicular to the outer surface of the rear wall 3306. This configuration is beneficial over the previously disclosed spring arms that extend outward at an angle because insertion force calculations are simplified, size of the terminal assembly 3100 is reduced, centering of the spring member is more reliable, and other benefits that may be obvious to one of skill in the art based on this disclosure. Unlike the spring arm 31 that is disclosed within FIGS. 4-8 of PCT/US2018/019787, the free end 3330a-3330d of the spring arms 3312a-3312d do not have a curvilinear end component. But for the small corrugations 3382a-3382b, the spring arms 3312a-3312d have a substantially planar outer surface. This configuration is beneficial because it ensures that the forces associated with the spring 3300 are applied substantially perpendicular to the ends of the male terminal body 3104. In contrast, the curvilinear components of the spring arm 31 disclosed within FIGS. 4-8 of PCT/US2018/019787 do not apply a force in this manner.

In an alternative embodiment that is not shown, the spring member 3300 may include recesses and associated strengthening ribs. As discussed in PCT/US2019/036010, these changes to the configuration of the spring member 3300 alter the forces that are associated with the spring 3300. In particular, the spring biasing force SBF is the amount of force applied by the spring member 3300 to resist the inward deflection of the free end of the spring member 3300 when the male terminal assembly 3100 is inserted within the female terminal assembly 700. Specifically, this inward deflection occurs during the insertion of the male terminal assembly 3100 because an extent of the outer surface of the male terminal body 3104 is slightly larger than the interior of the female receptacle 704. Thus, when the male terminal assembly 3100 is inserted into the female terminal assembly 2430, the extent of the outer surface is forced towards the center of the male terminal 3101. This inward force on the outer surface displaces the free end 3330a-3330d of the spring member 3300 inward (i.e., towards the center). The spring member 3300 resists this inward displacement by providing a wedging effect or spring biasing force SF. In other embodiments, the spring arms 3312a-3312d may be coupled to other structures to restrict their omnidirectional expansion or compression. The number and width of individual spring arms 3312a-3312d and openings may vary. In addition, the width of the individual spring arms 3312a-3312d is typically equal to one another; however, in other embodiments, one of the spring arms 3312a-3312d may be wider than other spring arms.

### 2) Alternate Embodiments of the Male Connector Assembly

FIGS. 101-104 show third and fourth embodiments of the male terminal connection member 4102, 5102 that may be used instead of the male terminal connection members 102, 1102, 2102, 3102, or 6102 shown and described herein. Because a substantial majority of the structures contacted in these embodiments of the system 4010, 5010 are similar to the structures contacted the fourth embodiment of the system 3010, it should be understood that reference numbers that are shown in the figures may be omitted from the specification for sake of brevity as like structures have like numbers. For example, the disclosure in connection with male terminal 3101 is not repeated herein, but it applies to male terminal 4101, 5101, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference. In this embodiment, the male terminal connection member 3102 was replaced with the male terminal connection members 4102, 5102.

### Seventh Embodiment

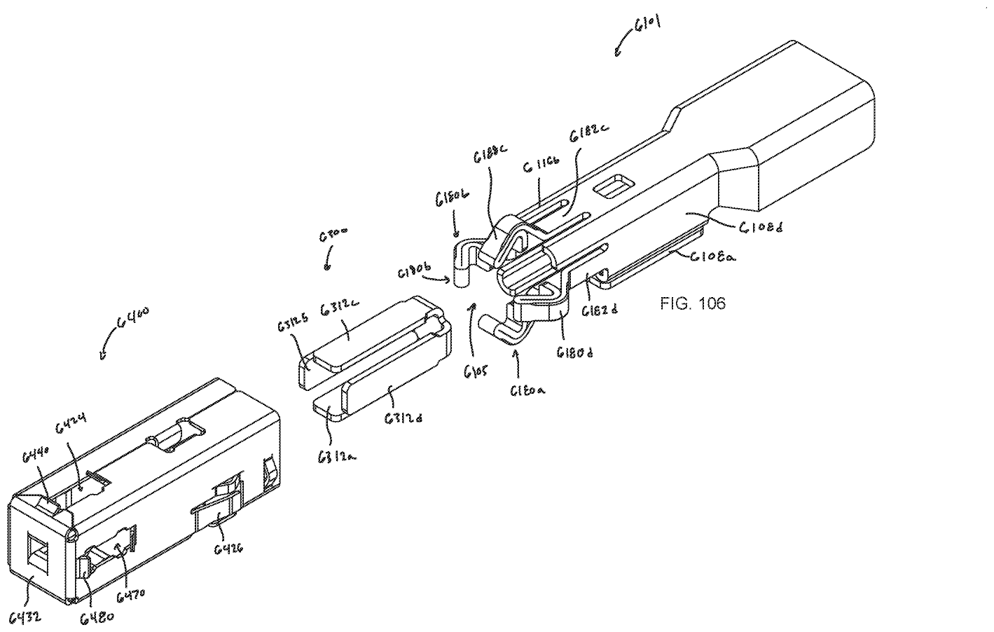

FIGS. 106-112 show a seventh embodiment of the male terminal assembly 6100 that includes a racket 6400 and a spring member 6300 that may be used instead of the jacket 3101 and a spring member 3300 shown and described above. Because a substantial majority of the structures contacted in this embodiment of the system 6010 are similar to the fourth embodiment of the system 3010, it should be understood that reference numbers that are shown in the figures may be omitted from the specification for sake of brevity as like structures have like numbers. For example, the disclosure in connection with male terminal 101 is not repeated herein, but it applies to male terminal 6101, as if it were repeated herein. In other words, omitting reference numbers from the specification or specific disclosure of the functionality of that structure should not limit the disclosure of this application. Instead, one shall refer to the disclosure of similar structures that may be discussed within another section of this application or other applications incorporated herein by reference. Like the fourth embodiment, this seventh embodiment of the male connector assembly 6050 includes multiple components designed to be coupled to a separate device or component (e.g., charge coupler 2, radiator fan, heated seat, power distribution component, or another current drawing component). The male connector assembly 6050 is primarily composed of: (i) a male housing assembly 6070, and (ii) a male terminal assembly 6100 with a male terminal 6101, a spring member 6300, and a jacket 6400, wherein during operation of the connector system 6010 at least a substantial extent of the male terminal assembly 6100 resides within the male housing assembly.

### 1) Spring Member

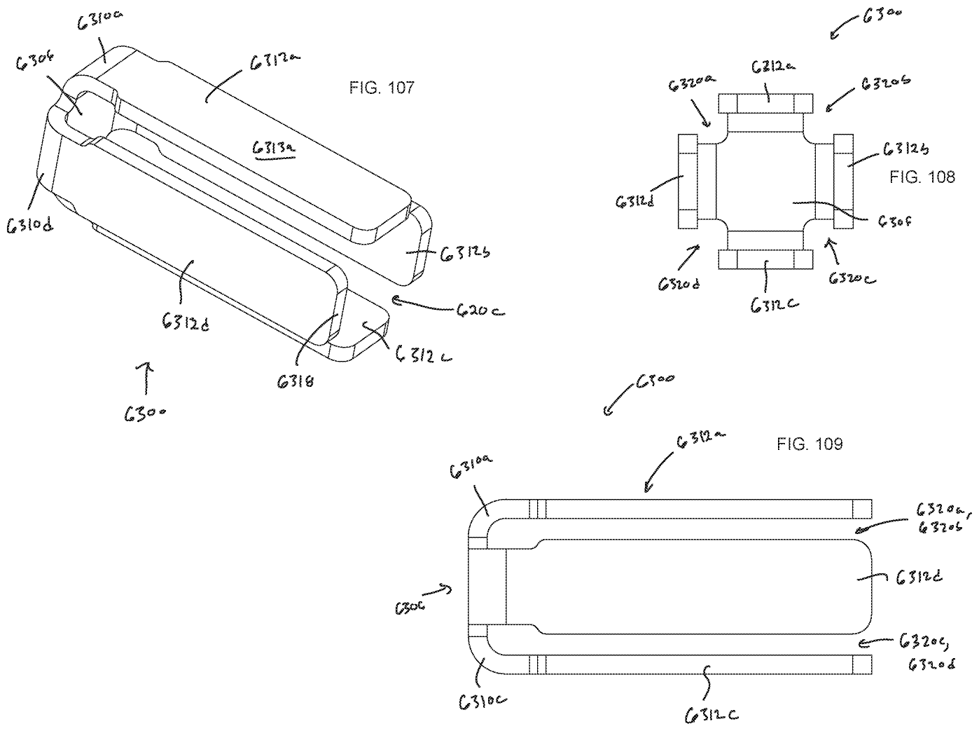

Referring to FIGS. 107-109, the spring member 6300 includes an arrangement of spring member side walls 6304a-6304d and a rear spring wall 6306. Each spring member side wall 6304a-6304d is comprised of: (i) a first or curvilinear spring section 6310a-6310d, and (iii) a second section or spring arm 6312a-6312d. The curvilinear spring section 6310a-6310d extends between the rear spring wall 6306 and the spring arm 6312a-6312d and positions the spring arm 6312a-6312d substantially perpendicular to the rear spring wall 306. In other words, the outer surface 6313a-6313d of the spring arm 6312a-6312d is substantially perpendicular to the outer surface of the rear spring wall 6306. As shown in FIGS. 107 and 109, the spring arms 6312a-6312d extend from the first or curvilinear spring section 6310a-6310d of the spring member 6300, away from the rear spring wall 6306, and terminate at a free end 6318. The spring arms 6312a-6312d are not connected to one another and thus spring arm gaps 6320a-6320d are formed between the spring arms 6312a-6312d of the spring member 6300. The spring arm gaps 6320a-6320d aid in omnidirectional expansion of the spring arms 6312a-6312d, which facilitates the mechanical coupling between the male terminal 6101 and the female terminal assembly 700.

The spring arms 6312a-6312d are generally planar and are positioned such that the outer surface 6313a-6313d of the spring arms 6312a-6312d is substantially perpendicular to the outer surface of the rear wall 6306. Unlike the spring arm 31 that is disclosed within FIGS. 4-8 of PCT/US2018/019787, the free end 6318 of the spring arms 6312a-6312d do not have a curvilinear component. Instead, the spring arms 6312a-6312d have a substantially planar outer surface 6313a-6313d. This configuration is beneficial because it ensures that the forces associated with the spring member 6300 are applied to the frontal spring contact segment 6196a-6196d and the intermediate spring contact segment 6198a-6198d of the contact arms 6180a-6180d. In contrast, the curvilinear components of the spring arm 31 that are disclosed within FIGS. 4-8 of PCT/US2018/019787 do not apply a force in this manner.

In an alternative embodiment that is not shown, the spring member 6300 may include recesses and associated strengthening ribs. As discussed in PCT/US2019/036010, these changes to the configuration of the spring member 6300 alter the forces that are generated by or applied by the spring member 6300. In particular, the spring biasing force F_{SB} is the amount of force that is applied by the spring member 6300 to resist the inward deflection of the free end 6318 of the spring member 6300 when the male terminal assembly 6100 is inserted within the female terminal assembly 700. Specifically, this inward deflection occurs during the insertion of the male terminal assembly 6100 due to the fact that an extent of an outer surface of the male terminal body 6104 is slightly larger than the interior of the female receptacle 702. Thus, when the male terminal assembly 6100 is inserted into the female terminal assembly 700, the extent of the outer surface is forced towards the center of the male terminal 6101. This compression force F_{COM} on the outer surface of the male terminal body 6104 displaces the free end 6318 of the spring member 6300 inward (i.e., towards the center). The spring member 6300 resists this inward displacement by providing an outwardly directed spring biasing force F_{SB}. In other embodiments, the spring arms 6312a-6312d may be coupled to other structures to restrict their omnidirectional expansion. The number and width of individual spring arms 6312a-6312d and openings may vary. In addition, the width of the individual spring arms 6312a-6312d is typically equal to one another; however, in other embodiments one of the spring arms 6312a-6312d may be wider than other spring arms.

### 2) Jacket

FIGS. 111-112 the jacket includes: (i) an upper segment 6402, frontal segment 6430, and a lower segment 6460. Unlike other embodiments of the jacket 400, 3400 disclosed herein, the jacket's 6400 frontal segment 6430 includes a frontal wall 6432 with spring arm limiter 6450. The spring arm limiter 6450 extends inward from an inner surface of the frontal wall 6432a and is designed to interact with the spring arms 6312a, 6312c. The application of an external force F_{E} on the contact arms 6180a, 6180c can only deform the contact arms 6180a, 6180c, the max compression distance D_{MC} because an inner surface of a frontal extent of the spring arms 6312a, 6312c contacts the outer surfaces 6451a, 6451b of the spring arm limiter 6450. In this embodiment the max compression distance D_{MC} is less than 1.25 mm, preferably less than 1.0 mm, and most preferably 0.5 mm. Limiting the extent the contact arms 6180a, 6180c can be deformed or depressed to the max compression distance D_{MC} prevents the contact arms 6180a, 6180c, spring arms 6312a, 6312c, and a combination thereof helps prevent said arms 6180a, 6180c from being overly deformed or depressed (e.g., a distance that is greater than the max compression distance D_{MC}) toward the center of the connector 6050.

### Related Information for the Systems

The system 10, 1010, 2010, 3010, 4010, 5010, and 6010 is compliant to T4/V4/D2/M2, wherein the system 10, 1010, 2010, 3010, 4010, 5010, and 6010 meets and exceeds: (i) T4 is exposure of the system 10 to 150° C., (ii) V4 is severe vibration, (iii) D2 is 200k mile durability, and (iv) M2 is less than 45 Newtons of force is required to connect the male terminal assembly 100, 1100, 2100, 3100, 4100, 5100, 6100 to the female terminal assembly 700, 1700, 2700, 3700, 4700, 5700, 6700. In addition to being T4/V4/D2/M2 compliant, the system 10, 1010, 2010, 3010, 4010, 5010, and 6010 is push, click, tug, scan (PCTS) compliant, wherein additional information about this standard is disclosed within PCT/US2020/049870.

It should be understood that the male terminal assemblies 100, 1100, 2100, 3100, 4100, 5100, 6100 and the female terminal assemblies 700, 1700, 2700, 3700, 4700, 5700, 6700 disclosed within this application having the following specifications regarding carrying at 55° C. rise over ambient (RoA) or 80° C. with a derating of 80%: (i) wherein the outside perimeter of the male terminal assembly 100, 1100, 2100, 3100, 4100, 5100, 6100 is 8 mm and its rated to carry 210 amps with a 16 mm² wire. Additionally, the system 10 meets the mile durability of USCAR-20, has a contact mating force that is between 10 Newtons and 30 Newtons, preferably 15 Newtons, has a unmating force that may be larger than the mating force and is between 10 Newtons and 30 Newtons, preferably 18 Newtons, meet vibration standards of 31 Gs, and is ISL/TPA compatible. These substantial increases in current carrying capacity, while meeting the USCAR specifications provides considerable advantages of the prior art connectors. The connector systems 10, 1010, 2010, 3010, 4010, 5010, and 6010 also meet applicable USCAR-38 specifications.

It should be understood that alternative configurations for means for limiting compression 314, 1314, 3314, 4314, 5314, 6314 are contemplated by this disclosure. For example, in other embodiments the means for limiting compression 3314 may be: (i) projections that extend outward from the spring arms and are received by openings in the jacket, (ii) structures that extend from one side wall of the jacket to an opposing side wall of the jacket, wherein said structure is configured to interact with the inner surface of the spring member, (iii) contact arm noses, wherein said contact arm noses are configured to interact with one another, (iv) structure that extends across the contact opening formed in the jacket and is positioned in the gap formed between the spring member and contact arm, (v) interactions between opposed spring arms or contact arms, (vi) interactions between jacket and either the spring arms or contact arms, (vii) interactions between the housing assembly and either the contact arms or spring arms, or (viii) any combination of these structures. It should also be understood that these compression tabs are not designed herein as a centering means 3380; however, said compression tabs could be extended to provide a centering means. Additionally, alternative male terminal housings are contemplated by this disclosure. For example, the housings may include any number of male terminal assemblies 100, 1100, 2100, 3100, 4100, 5100, 6100 (e.g., between 2-30, preferably between 2-8, and most preferably between 2-4) may be positioned within a housing. Additionally, alternative configurations for female terminal assemblies. For example, the housings may include any number of female terminal assemblies (e.g., between 2-30, preferably between 2-8, and most preferably between 2-4) may be positioned within a housing. Further, the female connector assembly may be reconfigured to accept these multiple male terminal assemblies into a single female terminal assembly. It should also be understood that the male terminal assemblies 100, 1100, 2100, 3100, 4100, 5100, 6100 may have any number of contact arms (e.g., between 2-100, preferably between 2-50, and most preferably between 2-8) and any number of spring arms (e.g., between 2-100, preferably between 2-50, and most preferably between 2-8). As discussed above, the number of contact arms may not equal the number of spring arms. For example, there may be more contact arms then spring arms. Alternatively, there may be less contact arms then spring arms.

Materials and Disclosure that are Incorporated by Reference

PCT Application Nos. PCT/US2022/037508, PCT/IB2022/057772, PCT/US2021/057959, PCT/US2021/047180, PCT/US2021/043788, PCT/US2021/043686, PCT/US2021/033446, PCT/US2020/050018, PCT/US2020/049870, PCT/US2020/014484, PCT/US2020/013757, PCT/US2019/036127, PCT/US2019/036070, PCT/US2019/036010, and PCT/US2018/019787, U.S. patent application Ser. No. 16/194,891 and U.S. Provisional Applications 63/286,072, and 63/286,080, each of which is fully incorporated herein by reference and made a part hereof.

SAE Specifications, including: J1742_201003 entitled, “Connections for High Voltage On-Board Vehicle Electrical Wiring Harnesses-Test Methods and General Performance Requirements,” last revised in March 2010, each of which is fully incorporated herein by reference and made a part hereof.

ASTM Specifications, including: (i) D4935-18, entitled “Standard Test Method for Measuring the Electromagnetic Shielding Effectiveness of Planar Materials,” and (ii) ASTM D257, entitled “Standard Test Methods for DC Resistance or Conductance of Insulating Materials,” each of which are fully incorporated herein by reference and made a part hereof.

American National Standards Institute and/or EOS/ESD Association, Inc Specifications, including: ANSI/ESD STM11.11 Surface Resistance Measurements of Static Dissipative Planar Materials, each of which is fully incorporated herein by reference and made a part hereof.

DIN Specification, including Connectors for electronic equipment-Tests and measurements-Part 5-2: Current-carrying capacity tests; Test 5b: Current-temperature derating (IEC 60512 May 2:2002), each of which are fully incorporated herein by reference and made a part hereof.

USCAR Specifications, including: (i) SAE/USCAR-2, Revision 6, which was last revised in February 2013 and has ISBN: 978-0-7680-7998-2, (ii) SAE/USCAR-12, Revision 5, which was last revised in August 2017 and has ISBN: 978-0-7680-8446-7, (iii) SAE/USCAR-21, Revision 3, which was last revised in December 2014, (iv) SAE/USCAR-25, Revision 3, which was revised on March 2016 and has ISBN: 978-0-7680-8319-4, (v) SAE/USCAR-37, which was revised on August 2008 and has ISBN: 978-0-7680-2098-4, (vi) SAE/USCAR-38, Revision 1, which was revised on May 2016 and has ISBN: 978-0-7680-8350-7, each of which are fully incorporated herein by reference and made a part hereof.

Other standards, including Federal Test Standard 101C and 4046, each of which is fully incorporated herein by reference and made a part hereof. While some implementations have been illustrated and described, numerous modifications come to mind without significantly departing from the spirit of the disclosure; and the scope of protection is only limited by the scope of the accompanying claims. For example, the overall shape of the of the components described above may be changed to: a triangular prism, a pentagonal prism, a hexagonal prism, octagonal prism, sphere, a cone, a tetrahedron, a cuboid, a dodecahedron, an icosahedron, an octahedron, a ellipsoid, or any other similar shape.

It should be understood that the following terms used herein shall generally mean the following:
a. “High power” shall mean (i) voltage between 20 volts to 600 volts regardless of current or (ii) at any current greater than or equal to 80 amps regardless of voltage.
b. “High current” shall mean current greater than or equal to 80 amps regardless of voltage.
c. “High voltage” shall mean a voltage between 20 volts to 600 volts regardless of current.

Headings and subheadings, if any, are used for convenience only and are not limiting. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

1.-63. (canceled)

64. An electrical connector assembly for use in a power distribution assembly, the connector assembly comprising:
a male connector assembly including a male housing assembly and a male terminal assembly, wherein said male terminal assembly comprises:
a male terminal body with a receptacle, a base portion and at least one contact arm extending from the base portion;
a spring member with at least one spring arm configured to underlie the contact arm, and wherein the at least one spring arm includes a frontal portion with a jacket projection extent;
an openable jacket with a spring arm opening; and
wherein in a fully assembled state S_{FA}, (i) the spring member is positioned in the receptacle of the male terminal body and a primary spring arm of the at least one spring arm underlies the contact arm, (ii) a majority of the male terminal body and the spring member reside within the jacket, (iii) when an external force F_{E} is applied to the contact arm, both the contact arm and the primary spring arm are inwardly displaced, and (iv) when additional external force F_{E} is applied to the contact arm, further inward displacement of the primary spring arm is constrained by direct contact between an inner surface of the jacket projection extent of the at least one spring arm and an inner compression edge of the spring arm opening, thereby preventing over-displacement of the male terminal assembly.

65. (canceled)

66. The electrical connector assembly of claim 64, wherein the inner surface of the jacket projection extent makes direct contact with the inner compression edge of the spring arm opening to prevent the male terminal assembly from being damaged, wherein the jacket projection extent defines a forwardmost portion of the spring member.

67. The electrical connector assembly of claim 64, wherein the at least one spring arm includes a bent portion formed by an upwardly sloping extent of the primary spring arm and a downwardly sloping extent of the primary spring arm.

68. The electrical connector assembly of claim 67, wherein an interior angle of the bent portion of the primary spring arm is defined between an inner surface of the upwardly sloping extent and an inner surface of the downwardly sloping extent, and wherein said interior angle is between 60 and 120 degrees.

69. (canceled)

70. (canceled)

71. (canceled)

72. The electrical connector assembly of claim 64, wherein the primary spring arm has both a linear extent having a first width, and a creased portion having a second width, and wherein the first width is greater than the second width.

73. The electrical connector assembly of claim 64, wherein the male terminal body includes a wall arrangement with an interior spring wall with an anti-rotation projection, and wherein the anti-rotation projection is configured to be positioned in an anti-rotation recess formed in the spring member.

74. The electrical connector assembly of claim 73, wherein the anti-rotation recess is formed between a pair of spring arms of the spring member.

75. The electrical connector assembly of claim 64, wherein the receptacle of the male terminal body has a first frontal dimension when the male terminal body is in a ready to receive position P_{R}, and the receptacle has a second frontal dimension when the male terminal body is in a ready to use position P_{U}, and wherein the second frontal dimension is less than the first frontal dimension.

76. The electrical connector assembly of claim 75, wherein the at least one spring arm of the spring member includes a pair of primary spring arms each having a bent portion that defines a spring arm apex, wherein a primary exterior spring member dimension is defined between said spring arm apexes, and wherein the primary exterior spring member dimension is greater than the second frontal dimension of the receptacle of the male terminal body.

77. The electrical connector assembly of claim 75, wherein the at least one spring arm of the spring member further includes a pair of secondary spring arms each have a bent portion that defines a spring arm apex, wherein a secondary exterior spring member dimension is defined between said spring arm apexes, and wherein the secondary exterior spring member dimension is greater than the second frontal dimension of the receptacle of the male terminal body.

78. The electrical connector assembly of claim 75, wherein the at least one spring arm of the spring member further includes a pair of secondary spring arms each have a bent portion that defines a spring arm apex, wherein a secondary exterior spring member dimension is defined between said spring arm apexes, and wherein the secondary exterior spring member dimension is substantially equal to the secondary exterior spring member dimension.

79. The electrical connector assembly of claim 64, wherein the base portion of the male terminal body has an outer surface, and wherein the contact arm of the male terminal body includes a linear extent with an outer surface that is co-planar with the outer surface of the base portion.

80. The electrical connector assembly of claim 64, wherein the male terminal body includes a support rib extending from the base portion, the support rib having a length that is less than a length of the contact arm of the male terminal body.

81. The electrical connector assembly of claim 64, wherein the at least one spring arm comprises a first spring arm with said jacket projection extent and a second spring arm having a frontal portion with an over-compression extent, and wherein the first spring arm resides to the side of the second spring arm and has an upper edge that is positioned a distance from said over-compression extent.

82. The electrical connector assembly of claim 81, wherein the over-compression extent comprises opposed flanges that extend outwardly from a free end portion of the second spring arm.

83. The electrical connector assembly of claim 81, wherein said jacket projection extent of the first spring arm is located forward and beyond the over-compression extent of the second spring arm.

84. The electrical connector assembly of claim 64, wherein the male terminal body comprises a plurality of contact arms and the spring member comprises a plurality of spring arms, wherein the number of contact arms equals the number of spring arms, and wherein a single spring arm underlies a single contact arm in the fully assembled state S_{FA}.

85. The electrical connector assembly of claim 64, further comprising a female connector assembly including a female housing assembly and a female terminal assembly.

86. The electrical connector assembly of claim 85, wherein the male connector assembly and the female connector assembly are operably coupled together in a connected state S_{C}, wherein a frontal extent of each of the male terminal body, the spring member and the jacket are received in the female terminal assembly.

87. The electrical connector assembly of claim 64, wherein the at least one spring arm of the spring member comprises (i) a first pair of spring arms having the frontal portion with a jacket projection extent, wherein the first pair of spring arms are in an opposed positional relationship, and (ii) a second first pair of spring arms having a a frontal portion with an over-compression extent, wherein the second pair of spring arms are in an opposed positional relationship; and,
wherein the first pair of spring arms are angularly oriented 90 degrees from the second pair of spring arms.
